(19) United States
(12) Patent Application Publication
(10) Pub. No.: US 2016/0243827 A1
(43) Pub. Date: Aug. 25, 2016

(54) CONTROLLING AIR AND LIQUID FLOWS IN A TWO-DIMENSIONAL PRINTHEAD ARRAY

(71) Applicant: Eastman Kodak Company, Rochester, NY (US)

(72) Inventors: Gilbert A. Hawkins, Mendon, NY (US); Dennis R. Perchak, Irvine, CA (US)

(21) Appl. No.: 14/629,984

(22) Filed: Feb. 24, 2015

(51) Int. Cl. B41J 2/145

(52) U.S. Cl. CPC B41J 2/145

(57) ABSTRACT

A printhead includes a substrate having an enclosure that includes an aperture through which liquid drops and gas flow are emitted. An array of liquid drop ejectors is included in the enclosure, which eject the liquid drops emitted through the aperture in response to image data. An array of gas flow ejectors is included in the enclosure, which emit the gas flow through the aperture.

### CROSS REFERENCE TO RELATED APPLICATIONS

Reference is made to commonly-assigned, U.S. patent application Ser. No. ______ (Docket K001519), entitled “CONTROLLING AIR AND LIQUID FLOWS IN A TWO-DIMENSIONAL PRINTHEAD ARRAY”, filed concurrently herewith.

### FIELD OF THE INVENTION

This invention relates to the field of digitally controlled inkjet printing of fluids onto a receiver. Specifically, apparatus and method are provided to improve image quality by the control of the coupled flow velocities of gases and liquids between the printhead and the receiver, the sources of gases and liquids being provided at the surface of a two-dimensional inkjet printhead array. Airflows interact with the flow of liquid jets and liquid drops so as to improve the placement accuracy of the drops as they subsequently land on a moving receiver, remote from the array of liquid drop ejectors. Airflows produced at the liquid ejector array and tailored in three spatial dimensions between the printhead array surface and the receiver have flow symmetries broken in the direction of receiver motion.

### BACKGROUND OF THE INVENTION

Ink jet printing has become recognized as a prominent contender in the digitally controlled, electronic printing arena because, e.g., of its non-impact, low-noise characteristics, its use of plain paper and its avoidance of toner transfer and fixing Ink jet printing mechanisms can be categorized by technology as either drop on demand ink jet (DOD) or continuous ink jet (CIJ). The first technology, “drop-on-demand” (DOD) ink jet printing, provides ink drops that impact upon a recording surface using a pressurization actuator, for example, a thermal, piezoelectric, or electrostatic actuator. One commonly practiced drop-on-demand technology uses thermal actuation to eject ink drops from a drop ejector. A heater, located at or near the drop ejector, heats the ink sufficiently to boil, forming a vapor bubble that creates enough internal pressure to eject an ink drop. This form of inkjet is commonly termed “thermal ink jet (TIJ).” The second technology commonly referred to as “continuous” ink jet (CIJ) printing, uses a pressurized ink source to produce a continuous liquid jet stream of ink by forcing ink, under pressure, through a drop ejector. The stream of ink is perturbed using a drop forming mechanism such that the liquid jet breaks up into drops of ink in a predictable manner. One continuous printing technology uses thermal stimulation of the liquid jet with a heater to form drops that eventually become print drops and non-print drops. Printing occurs by selectively deflecting one of the print drops and the non-print drops and catching the non-print drops. Various approaches for selectively deflecting drops have been developed including electrostatic deflection, air deflection, thermal deflection, and mechanical deflection.

Drop formation by thermal stimulation is known and has been described in, for example, U.S. Pat. No. 6,457,807 B1, issued to Hawkins et al., on Oct. 1, 2002; U.S. Pat. No. 6,491,362 B1, issued to Jeanmaire, on Dec. 10, 2002; U.S. Pat. No. 6,505,921 B2, issued to Chwalek et al., on Jan. 14, 2003; U.S. Pat. No. 6,554,410 B2, issued to Jeanmaire et al., on Apr. 29, 2003; U.S. Pat. No. 6,575,566 B1, issued to Jeanmaire et al., on Jun. 10, 2003; U.S. Pat. No. 6,588,888 B2, issued to Jeanmaire et al., on Jul. 8, 2003; U.S. Pat. No. 6,793,328 B2, issued to Jeanmaire, on Sep. 21, 2004; U.S. Pat. No. 6,827,429 B2, issued to Jeanmaire et al., on Dec. 7, 2004; and U.S. Pat. No. 6,851,796 B2, issued to Jeanmaire et al., on Feb. 8, 2005.

In both drop on demand and continuous ink jet technologies print drops land at various positions on the receiver. The potential landing locations of the printed drops can be described by a hypothetical ‘pixel grid’ on the receiver. The representation of the potential landing locations of printed drops as a hypothetical pixel grid is used extensively in technical analyses and in product specifications including printer resolution. For example, as is well known in the art of ink jet printing, in binary printing, each pixel grid on the receiver receives either one or no ink drop. Also by way of example, many products are known in the art of commercial printing having pixel grids of from 600×600 per inch to 2400×2400 or more per inch. The concept of a pixel grid allows classification of system architectures and is particularly useful in analyzing the effects of drop placement on printer performance.

As is well known in the art of inkjet printing, accurate placement of drops on the pixel grid is important to maintaining high image quality. On the one hand, accurate placement is improved in systems by making the spacing between the printhead and the receiver very small, for example about 1 mm, since the consequences of angular inaccuracies in drop ejection and interaction of the drops with air or with random air currents are minimized. For these reasons most current DOD inkjet products have such close spacings between the printhead and the receiver. On the other hand, larger spacings can optimize system performance, because, as is also well know in the art of inkjet printing, there are system reasons to make the spacing between the printhead and the receiver larger than 1 mm, for example as large as about 1 cm. This stems from the fact that printer system reliability can be reduced (or the printhead broken) if the receiver accidentally impacts the printhead or if any of the mechanical members of the receiver transport system contact the printhead. Impact can more easily happen at close spacings, for example due to mechanical fluctuations in the receiver transport system, particularly at high printing speeds. Generally larger spacings are desired for system cost and reliability.

Several business and technology trends in inkjet printing have exacerbated the problems cited. On the business side, desirable system requirements, such as very high image quality and very high printing speeds, are increasingly expected to be achieved at little or no additional cost and with improved reliability. This opens the opportunity for inkjet printing to address new market applications. On the technology side, an increasing ability to fabricate very high density arrays of drop ejectors in two dimensions using silicon micro-manufacturing technology has resulted in increasingly high drop ejector densities and very small drop sizes. These technology developments force compromises in order to cost effectively achieve high reliability and high image quality. For example, the desire to extend high quality, high speed inkjet printing into print-on-demand markets traditionally served by contact printing technology, such as electrophotography, has highlighted the desirability of larger receiver-printhead spacings to enable highly reliable, low-cost page transport, as larger spacings enable wider flexibility in configuring cut sheet hold-down mechanisms, despite the fact that larger receiver-printhead spacings decrease drop placement accuracy and hence decrease image quality. Current ink jet printers require design compromises between large and small spacings between the printhead and the receiver for the reasons cited above. The design problem will become more acute with increasing print quality and speed requirements, which will necessitate very large, two-dimensional arrays of drop ejectors producing very small drops. Large numbers of very small drops are exceeding difficult to control, especially for large spacings between the printhead and receiver, and image defects due to poor drop placement are easily visible in high image quality printing systems.

Technologies have been proposed to maintain a large spacing between the printhead and the receiver and yet provide good drop placement accuracy. Some technologies employ hardware located at each drop ejector (but not above the drop ejector) which can correctively steer the launching angle of each drop, as disclosed, for example, in U.S. Pat. No. 6,572,222 issued to Hawkins et al. This is effective for drops consistently misdirected, for example drops misdirected due to manufacturing defects of a particular drop ejector, but cannot correct for random drop misplacement, for example drop displacement due to interactions of the drops with the air. More sophisticated technologies (discussed below) improve placement accuracy by employing hardware which can correctively steer the drops while in transit, thereby correcting even the random component of drop placement error. Proposed solutions include the use of airflows (U.S. Pat. No. 6,554,389), electric fields (Silverbrook, U.S. Pat. No. 5,815,178), and surface contact elements (U.S. Pat. No. 8,016,395). Of these, airflows have provided the most robust approach. However, current airflow solutions suffer from cost and complexity, particularly for drops moving at very high velocities, which is a technology trend employed to improve drop placement accuracy and printer speed.

Robust and cost effective airflow solutions are not available for substantially two-dimensional arrays of drop ejectors nor are they available for printheads having very high drop ejection velocities. For the present discussion, a substantially 2-dimensional drop ejector array comprises at least ten to one thousand lines of drop ejectors, each of length at least one hundred to one thousand drop ejectors, the spacing between drop ejectors in both directions being microscopically small, for example comparable to the desired pixel grid spacing on the receiver, typically about 10 to 100 microns. Also for the present discussion, a substantially high drop ejection velocity is a velocity greater than 15 m/s. Airflow technologies allowing a large spacing, for example a spacing of about 1 cm, between the printhead and the receiver and yet providing good placement accuracy for substantially two-dimensional drop ejector arrays would be highly desirable to enable reliable and rapid printing of high quality images. In the case of printers of the continuous type, this would additionally benefit the placement of drop catchers, as is well known in the art of continuous inkjet printing.

The above observations are true for both continuous and drop on demand inkjet printers, although the technologies have followed different evolutionary paths. Commercialized continuous ink jet (CIJ) printers do not employ substantially two-dimensional arrays of drop ejectors. For example, continuous ink jet printheads have typically been commercialized based on either single drop ejectors or a line of microscopically spaced drop ejectors (or at most two lines of microscopically spaced drop ejectors as in U.S. Pat. No. 7,267,433 and U.S. Pat. No. 6,536,883), but these are not substantially two-dimensional arrays. Some commercial CIJ printing systems practice airflow to assist drop placement by reducing the air resistance the drops experience as they move toward the receiver. Airflow in the direction along the row of drop ejectors generally is symmetric with a spatial periodicity of the drop ejector to drop ejector spacing, but airflow is not symmetric or periodic in the direction perpendicular to the row of drop ejectors, since the array has at most 2 lines of microscopically spaced drop ejector. Substantially two-dimensional arrays of CIJ drop ejectors have been disclosed (ref Captive CIJ), but no solution using airflow has been proposed to reduce the air resistance the drops experience as they move toward the receiver or to steer the drops toward desired pixel locations as they move toward the receiver although the need exists.

As opposed to CIJ printers, Drop on Demand (DOD) printers often have drop ejectors arranged in substantially two-dimensional arrays. Generally, the spacings between the printhead and the receiver are much smaller than those of CIJ printers, in part due to the fact that the DOD drop velocities are often small and the drops are slowed rapidly as they travel to the receiver. This is especially true for modern printers which use very small drops which are slowed very quickly in air. Airflow is not generally used to reduce the air resistance the drops experience as they move toward the receiver and to allow an increased working distance between the printhead and the receiver, although this attribute would be valuable in printer design for reliability, as discussed previously. In some cases of DOD printers, airflow is used for other purposes. For example, pressurized airflow apparatus for DOD printheads of the substantially two-dimensional array type has been disclosed to control mist (Webster et al., U.S. Pat. No. 6,561,621). The air flows across, not along, the drop trajectories and does not improve drop placement nor does it afford increased spacing between the printhead and receiver. Likewise, Kawamura et al., U.S. Pat. No. 6,997,538), Ebisaawa, U.S. Pat. No. 5,528,271), and Aldrich, U.S. Pat. No. 6,375,304) disclose apparatus for injecting pressurized air flowing across the drop trajectories to suppress turbulence as well as to suppress mist, thereby improving reliability. But these flows do not improve drop placement nor do they afford increased spacing between the printhead and receiver.

Airflow at least partially in the direction of drop trajectories is disclosed (air curtain) for a 3-dimensional printer in U.S. Pat. No. 7,979,152, issued to Davidson et al., also for the purpose of increasing reliability. In this case, a two-dimensional array of orifices under the receiver (a powder), produced by vacuum means, provides an airflow pattern that ultimately flows through the receiver. The airflow orifices are unrelated in number and position to the two-dimensional array of printhead drop ejectors but generally prevent debris from accumulating on the printhead. The velocities of airflow are small compared to the drop velocities, in part because the air must flow through the receiver material. For both these reasons, the airflow does not increase the accuracy of drop placement. U.S. Pat. No. 8,029,093 issued to Love also contemplates a curtain of airflow, but for cases where the receiver is not porous, by establishing vacuum ports along the receiver edges. Similarly, Pickup et al., in U.S. Application Publication No. 2003/0160852, discloses pressurized airflows injected at the edges of an array of drop ejectors to disperse debris that accumulates on the receiver and to hold down the paper. These airflows cannot be used to increase the accuracy of drop placement because the component of flow is highly non-uniform and depends on the position of the edge of the receiver. Vacuum ports producing curtain air flow are also disclosed in Eve, U.S. Pat. No. 7,819,519, for a printing system comprised of many line arrays of inkjet drop ejectors separated by rollers for the transport of the receiver. The flow is contemplated to hold down the receiver on the transport rollers and reduce mist for a line array of drop ejectors.

Sekiya, in U.S. Pat. No. 7,553,375, discloses a series of collimated air injectors disposed on either side of a single drop ejector in the direction of receiver motion or on either side of a line array of drop ejectors with air velocities deliberately set to be much less than the drop velocities in order to assist drop formation, evaporate solvents, and prevent contamination without perturbing the landing accuracy of drops on the receiver, particularly useful for the ejection of complex fluids such as liquid crystal or color filter materials.

Silverbrook, in U.S. Pat. No. 8,020,966, discloses a pressurized plenum positioned over a substantially two-dimensional array of DOD drop ejectors, the top of which has orifices over each ejector through which the drops move. The air pressure is highly limited, since it must not exceed the pressure required to alter the meniscus position of the DOD drop ejectors; and thus the air velocities are necessarily small compared to the drop velocities. The uniformly pressurized plenum is very thin and is designed to facilitate printer start-up and to keep the drop ejectors free of debris. It is not designed to afford substantially increased spacing between the printhead and receiver. Also, Silverbrook, in U.S. Pat. No. 6,390,591, describes a drop ejector guard for inhibiting the buildup of foreign particles on a two-dimensional DOD drop ejector array.

Other airflow apparatus has been disclosed that partly addresses the problem of drop placement and receiver spacing for some types of DOD ejectors. Apparatus disclosed by Williams et al., U.S. Pat. No. 7,083,117, facilitates accurate drop placement at distances far from the receiver by positioning conically shaped hardware over a DOD drop ejector, the hardware providing both a source and a return of airflow at each drop ejector. The complexity of the design limits the application to single drop ejectors or, at most, a line of drop ejectors. Due to the return airflow path, the drops must still traverse a distance to the receiver without airflow assistance. Ohnishi, in U.S. Patent Application Publication No. 2011/0304868, discloses airflow ejectors which produce flows in the direction of the drop trajectories to assist drop formation near the orifice and to aggregate satellites and control mist. The airflow hardware is complex and requires laterally collimated air flow along the surface of the printhead to turn rapidly in order to flow along the drop trajectories. Air is supplied to individual lines of drop ejectors through a common feed on each side of the drop ejector line. Saito et al., in U.S. Patent Application Publication No. 2004/0202863, describe air flow that is focused angularly so as to converge on the drop forming region of each drop ejector in a line of drop ejectors. A random group of drops is thereby generated and guided to an extended spot on the receiver, but individual drops are not contemplated to be positioned accurately at desired receiver pixels. Pietrzyk et al., in U.S. Pat. No. 6,491,364, disclose angularly focused collimated airflow impinging on drop landing regions of the receiver to converge the tail of the ink drop and the head of the ink drop. U.S. Pat. No. 5,798,774, issued to Okada et al., discloses air drop ejector apparatus overlying, in one or more layers, a single drop ejector or a line of drop ejectors to provide heated airflow along the path of ejected drops, providing a gas-assisted liquid jet apparatus for solid ink or hot-melt ink. The apparatus operates with collimated air flowing through channels in the printhead to accelerate the ink toward the printing medium to reduce and or control ink ligament lengths and satellite droplet formation. However, the collinear design of an ink chamber concentric with the chamber for airflow causes the airflow pressure to perturb the ink meniscus, particularly problematical for liquid inks of low viscosity. The cost of the overlying hardware is very high due to the many layers of fabrication required. Murakami et al., U.S. Pat. No. 6,883,895, describe collimated airflows that are directed at the landing spot of drops from lines of DOD drop ejectors. The airflows then rebound from the receiver to form circulation flows claimed to constrain drop splatter from the printed image. The highly non-laminar flows taught do not improve drop accuracy. Additionally, complex wiping means are required to remove the airflow-induced drop splatter from the printhead which otherwise perturbs the accuracy of drop placement. Tanaka, in U.S. Application Publication No. 2002/0089563, discloses collimated airflow sources on the printhead body, the discharge ports being in the “moving direction” of the recording head to repel mist or fine ink dust other than main ink drops, thereby increasing reliability. Since the mist drops are much smaller than the main drops, the velocity of the air from the discharge ports is necessarily much less than the velocity of the main drops. The air ports are limited to the edges of the printhead. Airflow hardware for a single DOD drop ejector is described in U.S. Pat. No. 4,223,324 for discharging air coaxially aligned with the trajectory of an ejected drop. The air and the drop pass through a common discharge channel.

Prior Art exists also for the case of CIJ printers. For example, airflow apparatus has been disclosed that partly addresses the problem of drop placement and receiver spacing for some types of CIJ ejectors. For example, “tunnel” structures have been disclosed for reducing air drag on drops produced by CIJ ejectors. Early examples include U.S. Pat. No. 3,596,275 and U.S. Pat. No. 3,972,051, which describe large machined structures, each in the shape of a tunnel, referred to as an aspirator, through which both drops and air flow collinearly, for use with single CIJ ejectors or line arrays of CIJ ejectors. More precise control is disclosed in U.S. Pat. No. 4,097,872, which describes a single drop ejector drop ejector of the CIJ type having a uniform tunnel structure for air guidance and for wake and turbulence reduction (ink jet aspirator) with the air supplied by hardware in the form of a plenum located midway to the receiver. The airflow is located above the plane of the liquid drop ejector and the hardware occupies substantial space on all sides of the drop ejector. U.S. Pat. No. 4,375,062 describes a divergent tunnel structure for a line array of CIJ ejectors which improves on the match of air velocity and drop velocity. U.S. Pat. No. 4,260,996 describes a porous tunnel structure. Similarly, an ink “aspirator” directed at print drop-placement control and comprising three distinct concatenated airflow sections is disclosed in U.S. Pat. No. 4,297,712, issued to Lammers et al., which provides collinear airflow for a line of continuous inkjet ejectors to reduce aerodynamic retardation of the drops and improves upon related airflow concepts disclosed in U.S. Pat. No. 3,596,275 and U.S. Pat. No. 4,097,872. Although effective for a single jet or a line of jets, the airflow hardware in these aspirators or tunnel structures is much too large to be extended to substantially two-dimensional ejector arrays having high drop ejector densities. These hardware devices are macroscopic structures contemplated for single drop ejectors or linear arrays of drop ejectors to provide low turbulence airflow; hence the spacing between one line of ejectors and the next line of ejectors in printer systems having air tunnels is large, typically many inches. Additionally, these structures occupy substantially all the space between the drop ejector array and the receiver. Also, in all cases, the airflow provided to the tunnel structure follows a bending path, which restricts the velocity of air that can be ejected without causing turbulence. Thus the structures are not effective for the high drop velocities.

The need for large spacings between lines arrays of CIJ ejectors is also discussed for the apparatus and airflow patterns taught in U.S. Pat. No. 6,827,429, U.S. Pat. No. 6,554,410, U.S. Pat. No. 6,588,888, U.S. Pat. No. 6,863,385, U.S. Pat. No. 7,682,002 which detail simultaneous airflows which are have components that are collinear (with the drop trajectories) as well as perpendicular (to the drop trajectories). The airflows provided to these structures follow smooth paths which do not severely restrict the velocity of air that can be ejected without causing turbulence. However, the apparatus required to provide the desired smooth—path airflows must occupy macroscopic (typically much greater than 100-1000 microns) spaces in order to provide non-turbulent flow when airflow velocities are comparable to drop velocities. The apparatus must be physically large and have multiple sections smoothly linked together in the direction perpendicular to the line of ejectors in order to suppress turbulence, as is well known in the art of laminar airflow. Although U.S. Pat. No. 6,536,883 discloses a method for providing much smaller spaces (microscopic spaces, typically less than 1000 microns), the method is limited to two linear rows of drop ejectors, much less than the number of closely spaced rows desired in high speed printing systems (typically 1000-10000 closely spaced rows). Thus the method is not applicable to substantially two-dimensional arrays. The distinction between single drop ejectors and lines of drop ejectors is somewhat blurred, because micro-scale walls can be placed as partitions between individual drop ejectors arranged in a single line, thus making them isolated yet closely (microscopically) spaced, as disclosed for example in U.S. Pat. No. 6,575,566. However, because the airflow sources still occupy macroscopic spaces (typically much greater than 1000 microns) distances between the lines of microscopically spaced single ejectors, the overall density of drop ejectors is limited to macroscopic dimensions in the direction perpendicular to the line of drop ejectors.

Other CIJ airflow solutions include Katerberg et al., U.S. Pat. No. 4,591,869, which describes a linear array of air tunnels for the reduction of debris in which separate motive force for the airflow is not required, the airflow motive source being either the moving receiver or the drops themselves. The size can be smaller, since the induced airflow velocities are much lower than the liquid drop velocities. Higher velocity airflows in continuous inkjet printheads having line arrays of drop ejectors have also been discussed; for example such airflows are disclosed in U.S. Pat. No. 4,928,114, issued to Fagerquist, and U.S. Pat. No. 4,623,897, issued to Brown, which disclose airflows injected at the ends of a drop ejector array. However, these flows are not primarily directed at print drop control, but rather to skiving ink from the internal structures of the printheads and capping stations. Hawkins et al., U.S. Pat. No. 6,554,389, teaches the use of high velocity, non-uniform airflow means comprised of hardware overlying a linear drop ejector array. Drop trajectories are corrected due to a component of the air velocity perpendicular to the intended drop trajectory. The airflow sources are collimated and directed toward the line of drop ejector from opposite sides of a linear array. Desse, in U.S. Pat. No. 8,091,989, discloses a wide format continuous inkjet printhead in which a directed airflow provided by hardware overlying a linear drop ejector array is injected at a zone substantially below the line of fluid ejectors, passes through the internal cavity of the print head, and flows partly along the drop trajectories to improve drop placement accuracy and to remove turbulence and mist. Anagnostopoulos et al., in U.S. Application Publication No. 2009/0033727, also in a printer of the continuous type, disclose integrated airflow apparatus in the form of a small, open ended tunnel structure through which collimated air is injected to guide drops. However, the complex internal structure and the sharp edges of the airflow sections encourage turbulence. Yamada et al., in U.S. Pat. No. 7,004,560, describe asymmetrical air injection in an enclosed ink drop tunnel whose whirlpool-shaped flow includes a mixture of air and ink to facilitate cleaning the drop ejector or line of drop ejectors. However, the whirlpool flow is not conducive to drop placement accuracy. Many prior art airflow solutions, for example those disclosed in U.S. Pat. No. 6,588,889, acknowledge the utility of conditioning airflows with regard to humidity temperature, etc. However, no opportunities to apply these conditioning technologies are available for substantially two-dimensional arrays.

It should be noted that the distance of interaction between the prior art airflows cited and the printed drops as they travel along their trajectories towards the receiver is generally restricted by hardware geometry to a distance much less than the distance between the drop ejector array and the receiver. Preferably, the airflow influence on drops or jets should occur over the entire region from drop ejector array to the receiver. Prior art airflow solutions generally do not maximize this distance or address the fluid boundary conditions of continuous inkjet ejectors that include both a liquid jet and liquid drops. As is well known in the field of fluid dynamics, boundary conditions require the airflow velocity and liquid velocity to match everywhere at air-liquid interfaces, as appreciated for the end ejectors of linear ejector arrays, for example, in U.S. Pat. No. 8,091,990.

As can be seen from the disclosures above, there have been many attempts to individually improve image quality and system reliability. But as yet no satisfactory technology to simultaneously address these system issues in an integrated manner has emerged, at least for the substantially two-dimensional drop ejector arrays that future high-speed printing systems will require to support new market opportunities such as low-cost cut-sheet printing. For example, today's inexpensive, two-dimensional printhead arrays could offer enhanced printing speeds if the cost of cut-sheet receiver transport mechanisms and accuracy of drop placement could be simultaneously addressed. A clear need exists to provide apparatus and method to increase the spacing between the receiver and the printhead while maintaining drop placement accuracy for dense drop ejector arrays having substantial drop ejector counts in both dimensions. Prior art airflow solutions addressing the case of a single drop ejectors or of a line of drop ejectors fail to offer effective means for enabling substantially two-dimensional arrays of either the continuous or the drop-on-demand type.

### SUMMARY OF THE INVENTION

It is an object of the invention to reduce the incidents of contact between the printhead and the receiver by maintaining a large distance between them. Another object of the invention to cost effectively provide high speed, high image quality printing. Another object of the invention is to provide a printing apparatus of reduced physical footprint.

The invention, according to one example embodiment, helps improve image quality and system reliability by improving the placement accuracy of drops printed onto receiver pixels from a two-dimensional printhead array of drop ejectors while providing for a large spacing between the printhead and the receiver.

The invention, according to another example embodiment, projects an intended drop pattern, generated by a substantially two-dimensional array of liquid drop ejectors, onto the receiver by controlling the interactions between the flow of ejected air and the flow of the ejected liquid drops, thereby guiding the drops from a substantially two-dimensional array of drop ejectors toward desired locations on the pixel grid of the receiver in a one to one correspondence.

Advantageously, the airflow ejectors and the liquid drop ejectors of the invention can be fabricated at low cost using the tools of silicon device technology.

According to one aspect of the invention, a printhead includes an array of liquid drop ejectors (drop ejectors) with each liquid drop ejector capable of ejecting a plurality of liquid drops in response to imaging data onto a receiver in motion with respect to the printhead. The array includes an integral array of airflow ejectors (gas ejectors) with each airflow ejector being capable of ejecting a non-collimated flow of air. The airflow ejectors are interspersed amongst and substantially coplanar with the liquid drop ejectors in a one to one correspondence and controllably enabled by pressure means to eject air flowing unimpeded by overlying device structures above the printhead. Ejected air flows with the drops toward the receiver and spreads onto the receiver, the airflow symmetry being broken in the direction of receiver motion.

According to another aspect of the invention, a printhead includes a substrate having an enclosure that includes an aperture through which liquid drops and gas flow are emitted. An array of liquid drop ejectors is included in the enclosure, which eject the liquid drops emitted through the aperture in response to image data. An array of gas flow ejectors is included in the enclosure, which emit the gas flow through the aperture.

### BRIEF DESCRIPTION OF THE DRAWINGS

FIG. 1 shows a top-view of a prior art linear array (substantially one-dimensional array) of liquid drop ejectors of an inkjet printer.

FIGS. 2 and 3 illustrate schematically in cross-section the component layers of a prior art inkjet printhead in relation to one another and to the receiver. (Note that in some figures, the orientation (up-down) is inverted, and the receiver is shown below the printhead.) The inset details in cross-section a prior art drop ejector 12 comprising a printing liquid from which ejected drops 4 separate.

FIGS. 4, 5, and 6 show a top-view (FIG. 4) and two cross sectional side views (FIGS. 5 and 6), respectively, of a substantially linear array of liquid drop ejectors (solid circles) interspersed with a substantially linear array of airflow ejectors (open circles) comprising an inkjet printhead in accordance with the present invention. The insets show cross-sections of an airflow ejector, which is shown schematically as either air contained in a pressurized air enclosure and flowing out an air aperture in the enclosure top or alternatively as an air source whose airflow impinges on an air aperture in the ejector array top surface.

FIGS. 7 and 8 show a top-view and a cross sectional side view, respectively, of a substantially linear array of liquid drop ejectors (solid circles) interspersed with a substantially linear array of asymmetrical airflow ejectors (shaded ellipses) comprising an inkjet printhead in accordance with the present invention.

FIGS. 9 and 10 show a top-view and a cross sectional side view, respectively, of a substantially linear array of liquid drop ejectors (solid circles) interspersed with a substantial linear array of airflow ejectors comprising airflow ejectors (also shown in detail) in accordance with the present invention.

FIGS. 11 and 12 show a top-view and a cross sectional side view, respectively, of a linear array of coaxial drop and airflow ejectors (detailed in cross-section) in accordance with the present invention.

FIGS. 13 and 14 show a top-view and a cross sectional side view, respectively, of a substantially linear array of collinear drop and airflow ejectors within an air slot enclosure through which airflow is symmetrically provided with respect to the direction of receiver motion.

FIG. 15 shows a side-view of an airflow ejector apparatus for providing airflows through a thin membrane interspersed with drop ejectors. The airflow through the rightmost air aperture is dispersed by dispersive elements located in the air aperture.

FIG. 16 shows a side-view of an airflow ejector apparatus for providing airflows through a thick membrane interspersed with drop ejectors.

FIG. 17 shows a side-view of an airflow ejector apparatus for providing controllably directed airflows interspersed with drop ejectors. The right two air flow ejectors eject air angled with respect to the plane of the ejector array top surface.

FIG. 18 shows a side-view of an airflow ejector apparatus for providing airflows directed toward the base of the drop ejectors and interspersed with the drop ejectors.

FIG. 19 shows a side-view of an airflow ejector apparatus for providing airflows directed toward the base of the drop ejectors and directed upwards.

FIG. 20 shows a graph of the vertical air velocity above an array of 4 airflow ejectors.

FIG. 21 shows air velocity contours in top-view for the array of FIG. 20.

FIG. 22 shows the dependence of vertical airflow as a function of the height above the drop ejector array of FIG. 4 along a drop trajectory. The four curves correspond to four airflow sources have increasing degrees of collimation, left to right.

FIG. 23 shows airflow streamlines for uniform airflow for the geometry of FIGS. 9 and 10.

FIG. 24 shows the trajectory of ejected drops corresponding to FIG. 23.

FIG. 25 shows the trajectory of ejected drops corresponding as in FIG. 24 but for no airflow through the airflow ejectors.

FIG. 26 shows a top-view of a substantially two-dimensional drop ejector array in accordance with prior art.

FIG. 27 shows airflow streamlines for uniform air injection in a substantially two-dimensional drop ejector array. The printhead is located at 0.4 mm and the receiver at 0.0 mm. Airflow from airflow ejectors travels downward. Receiver induced airflow travels left to right.

FIG. 28 shows the trajectory of ejected drops corresponding to FIG. 27. The airflow induced by receiver motion pushes the drops to the right before they can land on the receiver.

FIG. 29 shows airflow streamlines for uniform air injection in a substantially two-dimensional drop ejector array similar to that of FIG. 27 but for much higher initial velocities for the ejected drops.

FIG. 30 shows the trajectory of ejected drops ejected periodically from the ejector array corresponding to FIG. 29.

FIGS. 31, 32, 33 show top-views of substantially two-dimensional drop ejector arrays interspersed with airflow ejectors having different geometrical relationships with one another in accordance with the present invention.

FIGS. 34, 35 illustrate device configurations for connecting drop ejectors and airflow ejectors to liquid and air sources respectively.

FIG. 36 shows air velocity contours in top-view for the array of FIG. 31.

FIG. 37 shows a cross-section of a substantially two-dimensional array having airflow steering devices. The steering devices shown are not activated. Two drop trajectories are angled with respect to the array top surface.

FIG. 38 shows a top-view of the substantially two-dimensional array of FIG. 37 as well as selected airflow velocity contours for the case the steering devices are not activated.

FIG. 39 shows a cross-section of a substantially two-dimensional array having airflow steering devices for the case the steering devices are activated.

FIG. 40 shows a top-view of the substantially two-dimensional array of FIG. 39 as well as selected airflow velocity contours for the case selected steering devices are activated.

FIG. 41 illustrates schematically the flow of air initially injected downwards from a airflow ejector array toward a receiver for the case of a substantially two-dimensional array which is large compared to the separation distance between the printhead and the receiver.

FIG. 42 shows model computations of the trajectory of drops ejected downwards from the drop ejector array toward the receiver in FIG. 41. Many of the ejected drops fail to print because of the size of the printhead and the flux of airflow.

FIG. 43 shows model results for airflow from a substantially two-dimensional array in accordance with the present invention for the case of initial airflow velocities less than the initial drop velocities.

FIG. 44 shows model results illustrating spatial positions of drops at sequential time steps for drops ejected from a substantially two-dimensional array in accordance with the present invention for the case of FIG. 43.

FIG. 45 shows model results of drop trajectories (position vs. time) for the case of FIG. 43.

FIG. 46 shows the landing positions as deviations from the “ideal” positions discussed in text of drops (line with red dots) on the moving receiver for the case of FIG. 43 for drops launched simultaneously. Dashed line shows landing position deviations in the case the ejections times are compensated. Middle line (at left of graph, i.e. the line with blue dots) shows landing position deviations in the case of an initial airflow velocity matched to the initial drop velocity.

FIG. 47 shows model results for airflow from a substantially two-dimensional array in accordance with the present invention for a preferred airflow.

FIG. 48 shows model results illustrating spatial positions of drops at sequential time steps for drops as in FIG. 44 but for a preferred airflow.

FIGS. 49, 50, 51 plot a dissipation performance parameter for drops ejected from substantially two-dimensional arrays in accordance with the present invention for three different initial airflow velocities, as discussed in the text.

FIGS. 52, 53, 54 plot drop trajectory performance parameters for drops ejected from a substantially two-dimensional array in accordance with the present invention as discussed in the text.

FIG. 55 shows a top-view of a printhead having a substantially two-dimensional array in accordance with the present invention illustrating a first preferred geometry for coaxial drop and airflow ejectors.

FIG. 56 shows a cross-section of a first preferred geometry for a coaxial drop and air ejector.

FIG. 57 shows a top-view of a printhead having a substantially two-dimensional array of drop ejectors in accordance with the present invention illustrating a second preferred geometry for coaxial drop and airflow ejectors.

FIG. 58 shows a cross-section of a second preferred geometry for a coaxial drop and air ejector.

FIG. 59 shows a top-view of a printhead having a substantially two-dimensional array of drop ejectors in accordance with the present invention illustrating a third preferred geometry for coaxial drop and air ejectors.

FIG. 60 shows a cross-section of a third preferred geometry for a coaxial drop and air ejector.

FIG. 61 shows a top-view of a printhead having a substantially two-dimensional array of drop ejectors in accordance with the present invention illustrating a fourth preferred geometry for coaxial drop and air ejectors.

FIG. 62 shows a cross-section of a fourth preferred geometry for a coaxial drop and air ejector.

FIG. 63 shows a top-view of a printhead having a substantially two-dimensional array of drop ejectors in accordance with the present invention illustrating a fifth preferred geometry for coaxial drop and air ejectors.

FIG. 64 shows a cross-section of a fifth preferred geometry for a coaxial drop and air ejector.

FIG. 65 shows a top-view of a printhead having a substantially two-dimensional array of drop ejectors in accordance with the present invention illustrating a sixth preferred geometry for coaxial drop and air ejectors.

FIG. 66 shows a cross-section of a sixth preferred geometry for a coaxial drop and air ejector.

FIG. 67 shows a cross-section of a printhead having a substantially two-dimensional array of drop ejectors and air ejectors in accordance with the present invention illustrating a preferred distribution of drop ejectors alternatingly interspersed with airflow ejectors.

FIG. 68 plots a preferred distribution of initial airflow velocities along the direction of receiver motion.

FIG. 69 shows the improvement in drop print positions for the preferred distribution of initial airflow velocities along the direction of receiver motion for the case shown in FIG. 67.

FIG. 70 shows the improvement in drop energy dissipation for the preferred distribution of initial airflow velocities along the direction of receiver motion for the case shown in FIG. 67.

FIG. 71 shows a cross-section of a printhead having a substantially two-dimensional array of drop ejectors interspersed with air ejectors including a gap between interspersed ejectors which contains an air ejector operating to extract air from the region between the printhead and the receiver in accordance with the present invention.

FIG. 72 shows a cross-section of a preferred printhead having a substantially two-dimensional array of coaxial drop and airflow ejectors interspersed with air ejectors operating to extract air in accordance with the present invention.

FIG. 73 shows model results for airflow from a substantially two-dimensional array in accordance with the present invention for the preferred geometry of FIG. 72.

FIG. 74 shows model results of the drop velocity as a function of distance between the receiver and printhead along a drop trajectory for the array of FIG. 73.

FIG. 75 illustrates schematically a prior art interposer comprising a low pressure enclosure overlying a two-dimensional drop ejector array having an enclosure top and receiving air from an air source located on the side of the enclosure.

FIG. 76 illustrates an interposer according to the present invention comprising a high pressure enclosure having an enclosure top overlying a two-dimensional drop ejector array and receiving air from an air source located on the side of the high pressure enclosure. Because the air sources fluidly connect, the ejectors are not of the coaxial drop and air ejector type.

FIG. 77 illustrates in cross-section the interposer of FIG. 76, the high pressure enclosure receiving air from air sources interspersed with the drop ejectors at the drop ejector array top surface.

FIG. 78 illustrates in cross-section an interposer related to that of FIG. 76, the interposer additionally having a deflector to direct airflow towards the drop ejectors.

FIG. 79 show a top-view of the drop and airflow ejectors of a printhead similar to that shown in FIG. 76 having a particular arrangement of two-dimensional drop and airflow ejectors as seen through the interposer.

FIG. 80 show a top-view of FIG. 79 as viewed from above the interposer.

FIG. 81 shows a top-view of a printhead similar to that shown in FIG. 76 but having an alternate enclosure top. As the air sources are fluidly connect, the ejectors are not of the coaxial drop and air ejector type.

FIGS. 82 and 84 each show a cross-section of a printhead similar to that shown in FIG. 76 but having an enclosure top which supports structures over the air sources. The structures have planar surfaces to guide the airflow from the air sources. The enclosure top includes orifices through which ejected drops pass.

FIGS. 83 and 85 each show a top-view of the printhead of FIGS. 82 and 84, respectively, illustrating preferred shapes for the structures over the air sources having planar surfaces.

FIG. 86 illustrates in cross-section an interposer similar to that of FIGS. 82 and 84 but the enclosure top (not shown) supports curved surfaces to guide the airflow from the air source. Because the air sources fluidly connect, the ejectors are not of the isolated coaxial drop and air ejector type.

FIG. 87 illustrates in cross-section an interposer similar to that of FIG. 86 but the enclosure top additionally supports catch chambers to capture catch drops on the curved surfaces. Because the air sources fluidly connect, the ejectors are not of the isolated coaxial drop and air ejector type.

FIGS. 88 and 89 illustrate in cross-sectional and top views an interposer related to that of FIG. 87 having a preferred geometry for the catch chamber and additionally showing in detail the drop ejector location and the method of making the air sources free of turbulence. Because the catch surfaces extend to the plane of the drop ejectors, the ejectors can be of the coaxial drop and air ejector type.

FIG. 90 illustrates in cross-section an interposer similar to that of FIG. 41 having a preferred geometry for the catch chamber and additionally showing in detail a feed tube for feeding ink to the drop ejector locations. Because the catch surfaces extend to the plane of the drop ejectors, the ejectors can be of the isolated coaxial drop and air ejector type.

FIG. 91 illustrates in cross-section an interposer similar to that of FIG. 90 having a preferred geometry for the catch chamber and additionally showing conditioning ejectors which eject fluid onto the catch surfaces. Drops from the conditioning drop ejectors strike the catch surface near the plane defined by the drop ejectors.

FIG. 92 is a top-view showing the arrangement of the conditioning drop ejectors of FIG. 91 in the drop ejector plane.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art. In the following description and drawings, identical reference numerals have been used, where possible, to designate identical elements.

The example embodiments of the present invention are illustrated schematically and not to scale for the sake of clarity. One of the ordinary skills in the art will be able to readily determine the specific size and interconnections of the elements of the example embodiments of the present invention.

As described herein, the example embodiments of the present invention provide liquid ejection components typically used in inkjet printing systems. However, many other applications are emerging which use inkjet printheads to emit liquids (other than inks) that need to be finely metered and deposited with high spatial precision. As such, as described herein, the terms “liquid” and “ink” refer to any material that can be ejected by the liquid ejection system or the liquid ejection system components described below.

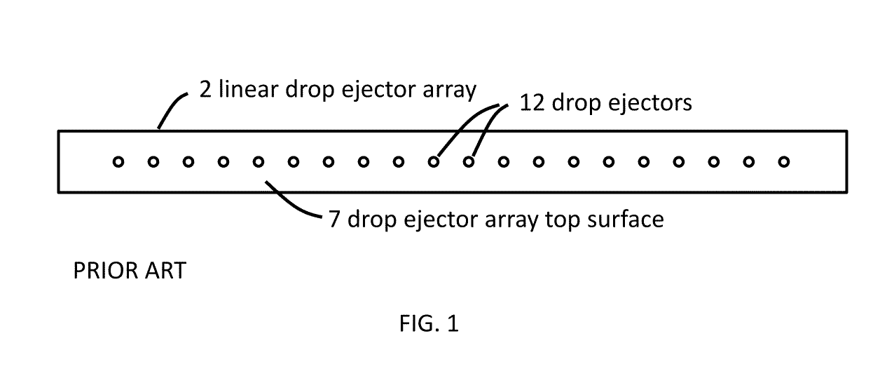

FIG. 1 is a schematic illustration of a prior art inkjet printhead component comprising a prior art linear ejector array 2 having ejector array top surface 7 of substantially closely spaced drop ejectors 12 which can eject liquid drops, typically ink, for printing on a receiver, typically moving in a direction perpendicular to the line of ejectors, as is well known in the art of inkjet printing. For the purposes of the current discussion, substantially closely spaced ejectors are assumed to be spaced apart by a distance of less than 1000 microns, typically uniformly. The linear array geometry is cost effective for manufacture using VLSI (Very Large Scale Integration) circuit technology, because it conserves the area of the silicon wafer used to form the ejector array 2 and thus lowers the cost for each printhead. CMOS (Complementary Metal Oxide Semiconductor) circuitry (not shown) is generally included along the edges of ejector array 2, typically on the ejector array top surface 7, to activate actuators associated with the drop ejectors, as is well known in the inkjet art. Non-silicon technologies also are used to produce linear arrays of substantially closely spaced drop ejectors 12; for example, stainless steel and piezo materials have been successfully commercialized in geometries similar to FIG. 1. Linear ejector arrays include arrays in which the drop ejectors are only approximately in a straight line, for example differing in position from a straight line by distances less than about 1000 microns, or arrays which have a very small number, for example less than ten, of closely spaced straight lines of drop ejectors, the line-to-line distance being typically less than a few hundred microns, as is well known in the art of printhead manufacture. Typically, the number of drop ejectors in a line is very large, for example between 100 and 10,000.

Printheads of the Drop-on-Demand (DOD) type, as found in most desk top printers, do not generally include hardware for the specific purpose of controlling airflow between the printhead and the receiver. Airflow is typically generated by the relative motion between the receiver and the printhead surface and by the motion of the ejected drops, in accordance with the fluid dynamic requirement of a continuous velocity boundary condition between solid surfaces, such as the printhead and the receiver, and air; and, to a good approximation, between moving liquids, such as the ink drops, and air. For example, the velocity of the air at the receiver surface is tangential to and equal to the velocity of the receiver. Although some DOD printheads include hardware designed to provide airflow, most are limited to providing low air velocities used to keep debris from the ejectors, to aid drop formation, or to control misting. Such low air velocities, i.e. air velocities small compared to drop velocities, do not substantially influence the drop trajectories. For some special purpose printheads, for example printheads intended to deposit non-ink liquids for biological assays, single drop ejectors and linear arrays of drop ejectors have been designed to include overlying hardware providing high air velocities, i.e. velocities comparable to the drop velocities, which assist accurate drop placement of the liquid material on the receiver. Such “collinear” airflow provides sources of airflow in the direction of the drop trajectories with air velocities substantially (at least 80%) equal to the ejected drop velocities to reduce the drag experienced by the ejected drops due to the velocity difference between the drops and the surrounding air. However, such hardware adds significant cost and complexity and occupies substantial space between the printhead and the receiver, and has not been generally commercialized for the mainstream consumer desktop inkjet printer markets. Substantially two-dimensional arrays of drop ejectors for inkjet printing, as described later, have not been disclosed with hardware providing high velocity collinear airflows, in part due to the very high degree of complexity, the large amount of space occupied by such hardware, the lack of practical fabrication means, and the difficulty of managing the large amount of airflow between the printhead and the receiver.

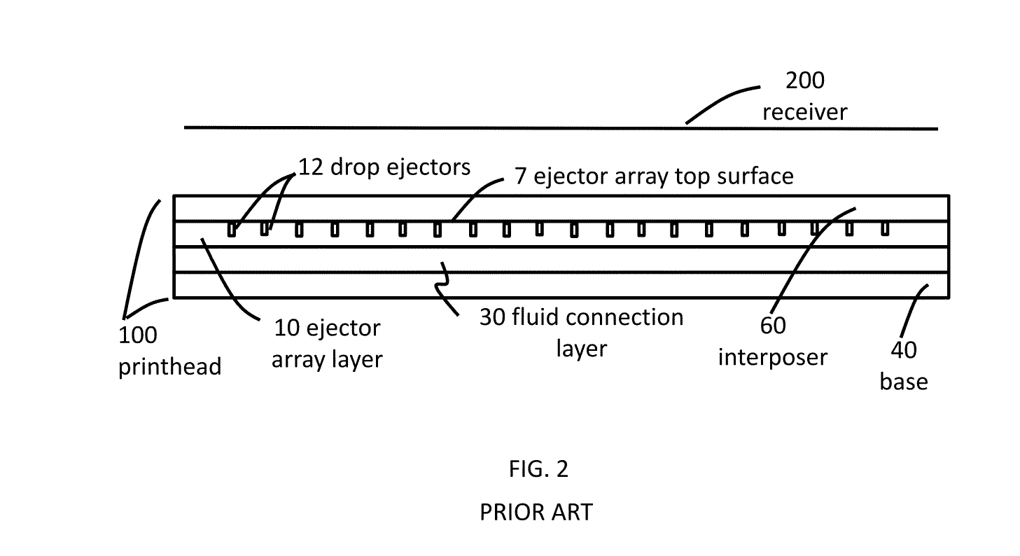

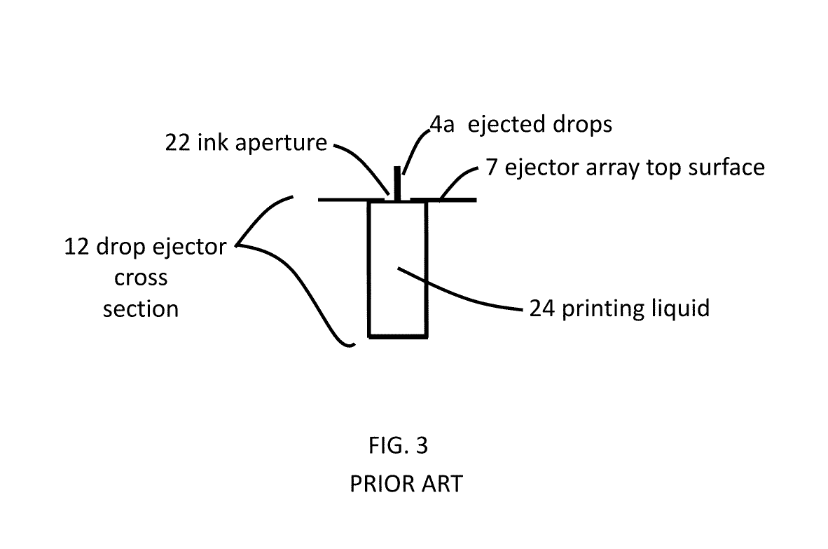

FIGS. 2 and 3 illustrate in cross-section the general relation of an ejector array, such as linear ejector array 2, to its associated printhead 100 and receiver 200 moving with respect to the printhead. Typically, printhead 100 includes other layers such as base layer 40 which supports the entire structure mechanically, fluid connection layer 30 which contains fluid channels to direct fluid to drop ejectors, and interposer 60 which contains mechanical structures placed between the top of the ejector array and the receiver, for example structures designed to alter drop trajectories, catch drops, guide drops, or protect the printhead from receiver contact. Not all printheads have all layers present. FIG. 2 is a reference figure appropriate to either linear or two-dimensional ejector arrays. Note that in this figure, drops from the printhead 100 are shown traveling upwards, not downwards, to the receiver 200. Inkjet printers having drops traveling upwards are well known, as are printers having drops traveling downwards, as gravity has a negligible effect on the ejected drops in inkjet printing due to their small sizes. In the figures describing the present invention, drop travel may be shown either as being upwards or downwards. The travel direction of the drops is typically indicated by a bold arrow at the location of the drop ejectors, the arrow pointing away from the ejector array top surface.

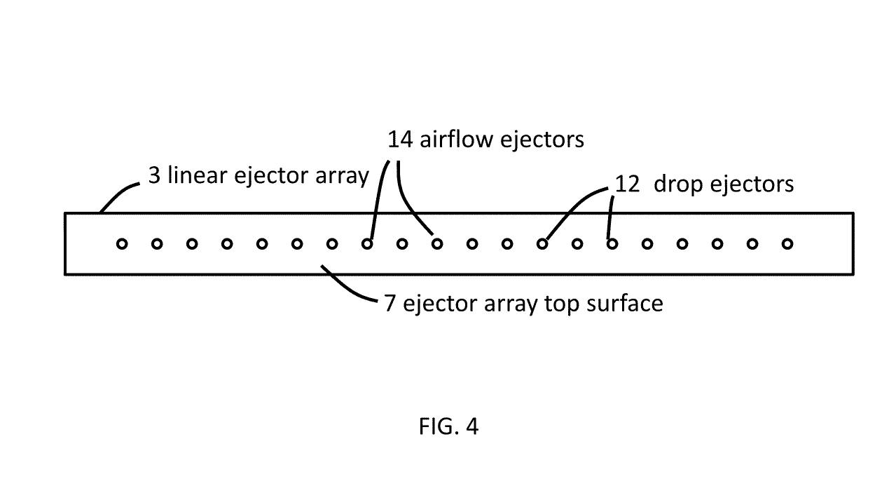

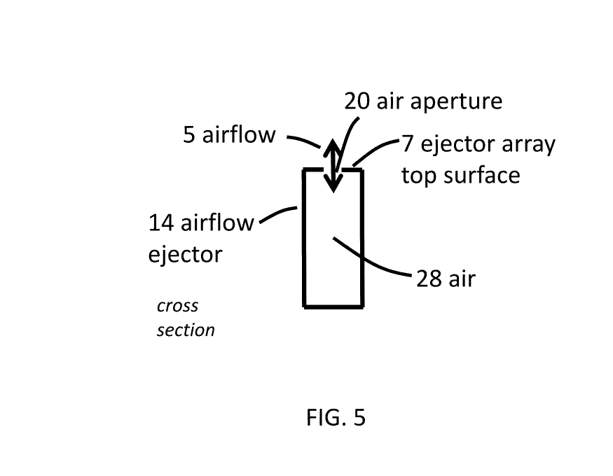

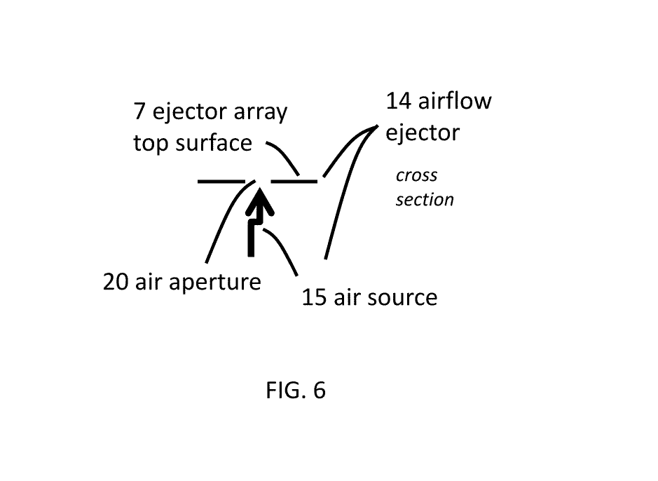

One embodiment of the current invention, shown in FIGS. 4 and 5, comprises a linear ejector array 3 which includes airflow ejectors 14 interspersed amongst drop ejectors 12, as discussed below. In accordance with the present invention, linear ejector array 3 comprises closely spaced (less than 1000 microns) drop ejectors 12 which can print liquid drops on a receiver, typically moving in a direction perpendicular to the line of ejectors, interspersed with an array of substantially closely spaced (less than 1000 microns) airflow ejectors 14. In the simplest embodiment of the present invention, liquid drop ejectors 12 are linearly aligned and airflow ejectors 14 are linearly aligned; the liquid and airflow ejectors being collinear, coplanar, equally spaced, manufactured concurrently using the same processes, and sharing a common mechanical ejector design. Thus the difference in the ejectors (air vs. liquid) in this embodiment is due only to the connection of the ejectors to either an air or to a liquid source, as will be discussed latter in conjunction with substantially two-dimensional arrays. Although this is the simplest and least costly embodiment, it is also contemplated that airflow ejectors 14 and liquid drop ejectors 12 can be of different designs or slightly different geometrical locations. FIGS. 5 and 6 show cross-sections of an airflow ejector, which is represented schematically as either air contained in a pressurized air enclosure and flowing through an air aperture in the enclosure top or, alternatively, as a flowing air source (compound arrow), for example an air source could be a fan or pump, whose airflow impinges on an air aperture in the ejector array top surface. For the purpose of the present invention, these representations are functionally similar, since ejected drops are influenced by airflow regardless of the mechanism producing it. In principal, the direction of the airflow can be either toward or away from the receiver (up or down in FIGS. 4, 5, and 6), depending on the pressure of the air in the enclosure or the direction of the air source.

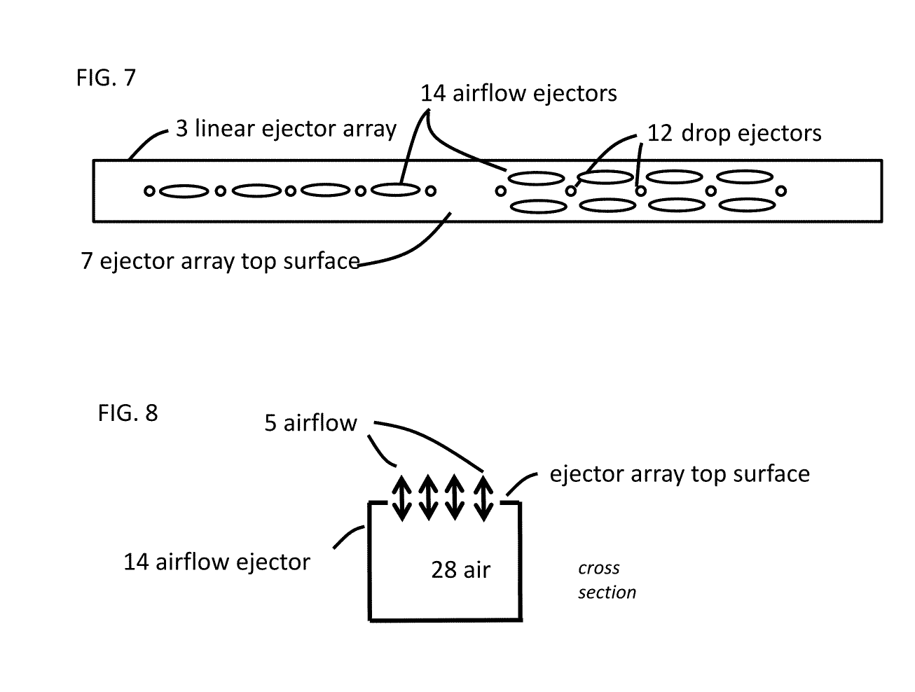

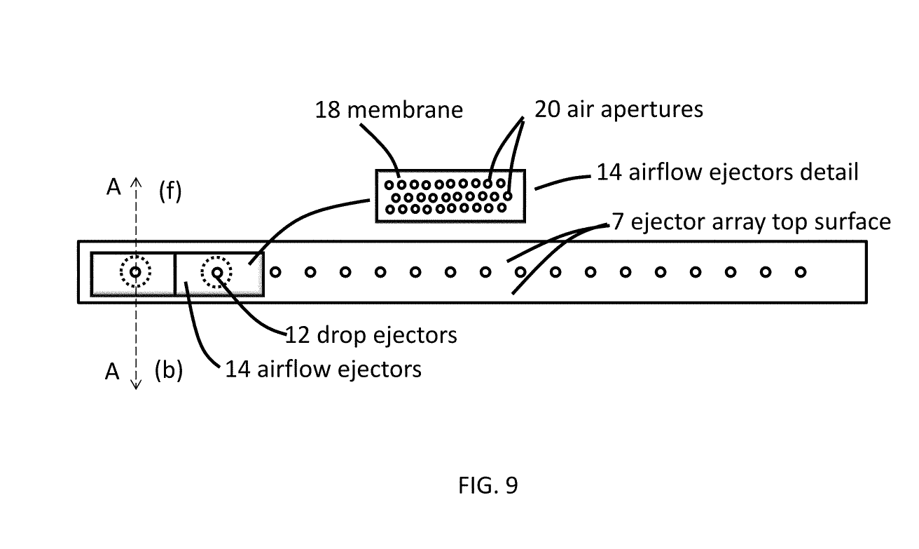

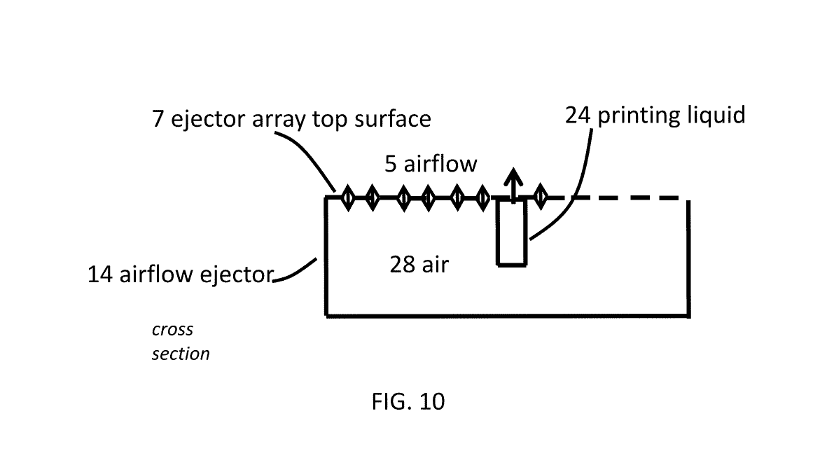

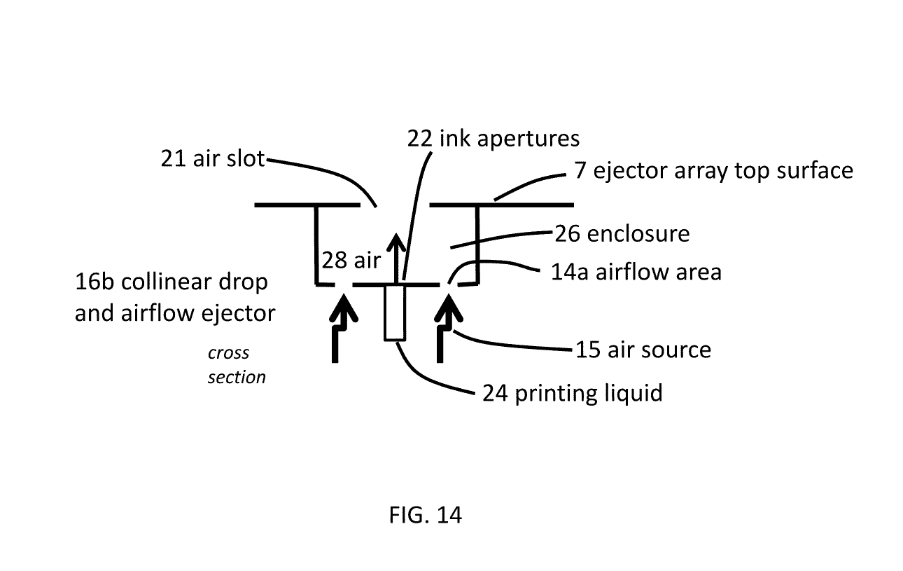

Although preferably the drop ejector and airflow ejector are manufactured in a common process, it is also contemplated that their manufacturing processes could be different. Preferably, in the simplest embodiment, the space between the plane of the ejectors and the receiver is entirely unencumbered with mechanical hardware, i.e. there is no interposer in the simplest embodiment. Also preferably in the simplest embodiment, the airflow ejectors 14 are of the non-collimated (or diffusive or dispersive) flow type, discussed later. This geometry efficiently disperses airflow laterally toward the liquid drop ejectors so that the airflow contacts the ejected drops near the ejector array top surface. The equal velocity boundary condition, well known in fluid dynamics, between the velocity of the ejected drops and the velocity of airflow surrounding the drops is met principally by energy supplied by the airflow source rather than by the drops themselves over a large portion of the drop trajectories, particularly along the portions of the trajectories nearest the ejectors due to the close spacing of airflow and drop ejectors. The symmetry of the positions of the airflow ejectors 14 with respect to the liquid drop ejectors 12 shown in FIGS. 4, 5, and 6 (and FIGS. 7, 8, 9, and 10) ensures that the airflow from the airflow ejectors 14 is nearly vertical (i.e. parallel to the drop trajectories) over each drop ejector, as can be appreciated by one skilled in fluid mechanics and as will be discussed later in association with FIG. 14. The airflow from airflow ejectors 14 helps guide the drops towards the receiver, minimizes the drag that the ejected drops experience traveling towards the receiver, provided the airflow velocities are close to the drop velocities, and enables the use of large throw distance (the distance between the printhead and the receiver), which is desirable, for example for maximizing mechanical tolerances of the printer or for printing on rough surfaces. In the detail cross-section of FIGS. 9 and 10 of drop ejector 12, ejected drops 4 are shown being ejected vertically from printing liquid 24.

Related embodiments of linear ejector array 3 are shown in FIGS. 4, 5, 6, 7, 8, 9, and 10, in which the airflow ejectors 14 have slightly different shapes and positions, but provide similar benefits in guiding drops to their desired locations. Shapes include ellipses and rectangles arranged proximate each drop ejector and may include structural membranes 18 (as in FIGS. 9 and 10) with a plurality of apertures 20 to provide both airflow and mechanical support for the drop ejectors.

The embodiments of FIGS. 4, 5, 6, 7, 8, 9, and 10 can be made inexpensively by MEMS (Micro Electro-Mechanical) silicon fabrication technology. It is important to note that linear ejector arrays can provide airflow with minimal air turbulence because there is no restriction on the size and shape of the air connections supplying airflow ejectors in the direction perpendicular to the line of ejectors. For example, a “whistle-shaped” curved air duct, known to suppress turbulence, can be employed to feed air to a linear ejector array such as linear ejector array 3. This duct can be advantageously made large in the direction perpendicular to the line of drop ejectors.

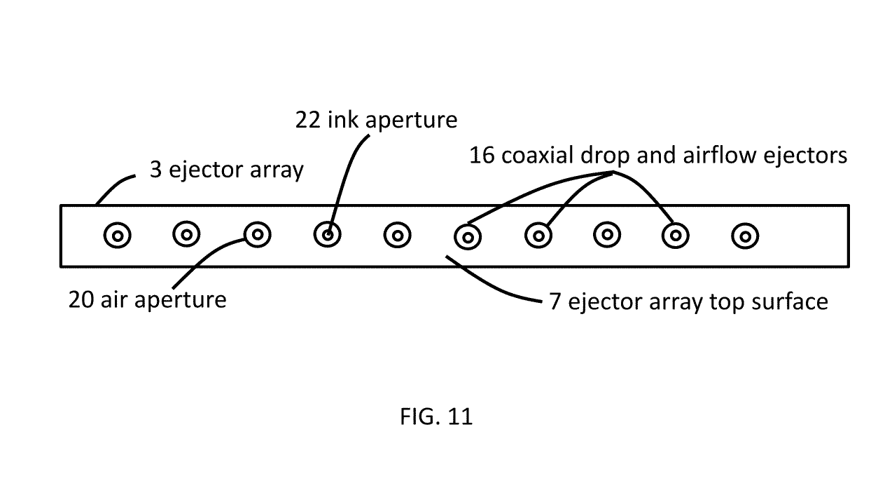

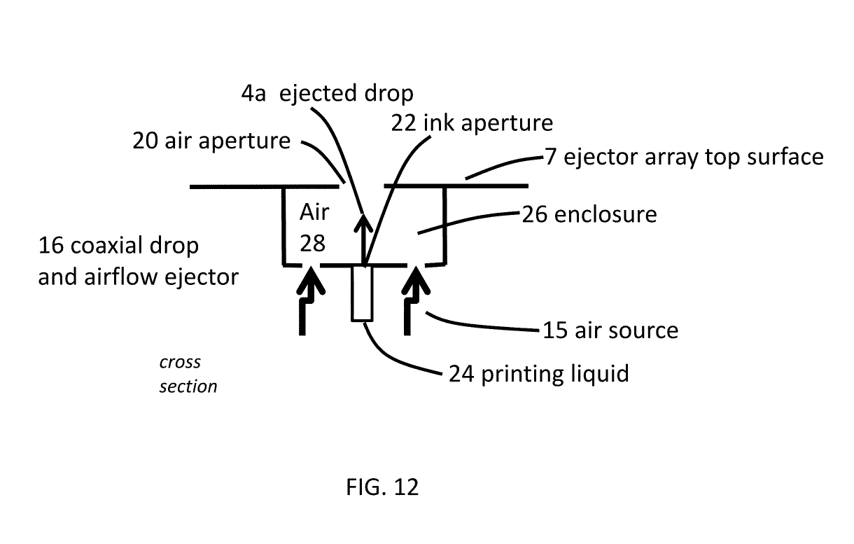

Other examples of linear ejector arrays include arrays of coaxial drop and airflow ejectors 16, FIGS. 11 and 12, which provide both air and liquid ejection through a common air aperture 20. In FIGS. 11 and 12 an isolated enclosure 26, associated with each coaxial drop and airflow ejector 16, provides a symmetrical airflow pattern to the ejected drops so the airflow does not alter the drop trajectory (so called “line symmetry”). The ejector array top surface 7 can support a line of isolated enclosures 26 of isolated drop and airflow ejector 16 to form a fully integrated structure for the ejector array layer in FIGS. 2 and 3.

Line symmetry includes the case of complete rotational symmetry, in which the detail in FIGS. 11 and 12 is axial symmetric about the ejected drop and the structure is an isolated, fully symmetric, drop and airflow ejector 16. The ejector array top surface 7 can support a line of isolated enclosures 26 of isolated, fully symmetric, drop and airflow ejector 16 to form a fully integrated structure for the ejector array layer 10 shown in FIG. 2.

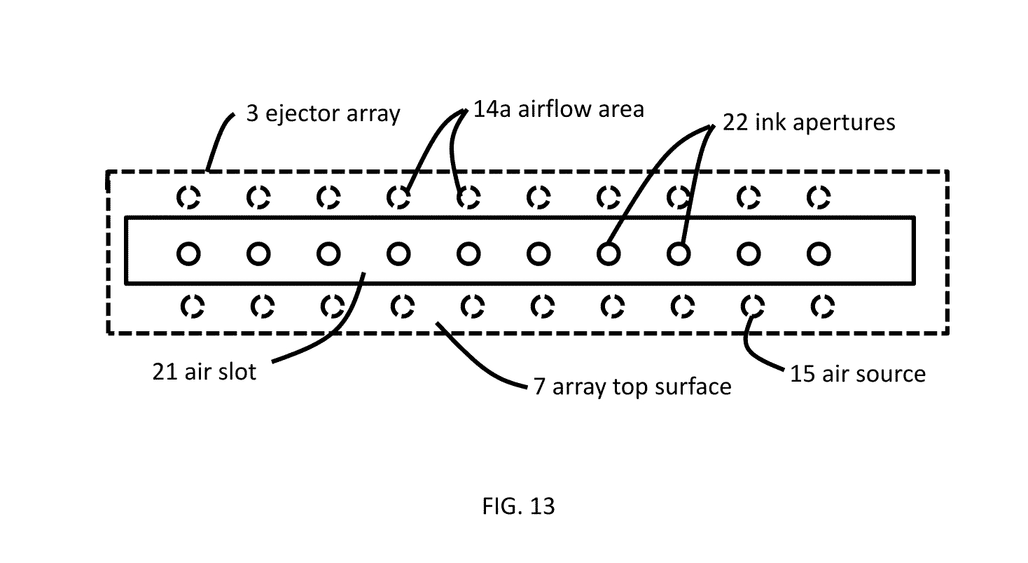

If the enclosures are not isolated, i.e. the enclosure 26 is in the form of a slot 21, housing multiple drop ejectors, and the air sources 15 do not provide symmetrical airflow patterns, the resulting printhead is related to those disclosed in U.S. Pat. No. 6,491,362 B1. If, on the other hand, the enclosures are not isolated but the air sources 15 provide airflow patterns that are symmetrical about the line of drop ejectors, the resulting printhead, shown in FIGS. 13 and 14, comprises a substantially linear array of collinear drop and airflow ejectors with the enclosure 26 being in the form of an air slot 21, as in FIGS. 13 and 14.

Other embodiments of the present invention relate particular types of air ejectors which are differentiated by their design and the extent of collimation of the air they inject. The particular type of airflow ejectors differ particularly in the collimation of the air they inject as well as the direction of the airflow. Such air ejectors can be used in either substantially linear arrays, as described in the previous embodiments, or in substantially two-dimensional arrays, to be described. The fabrication of ejectors is typically more complex when they are to be used in substantially two-dimensional arrays and the consequences of their use are very different in linear and two-dimensional arrays, due to the large amount of airflow along the direction of the receiver path in two-dimensional geometries.

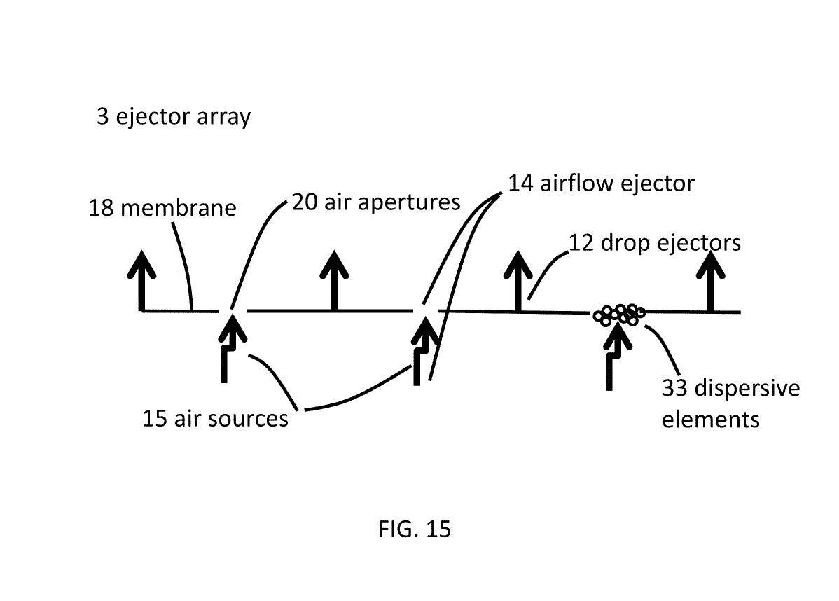

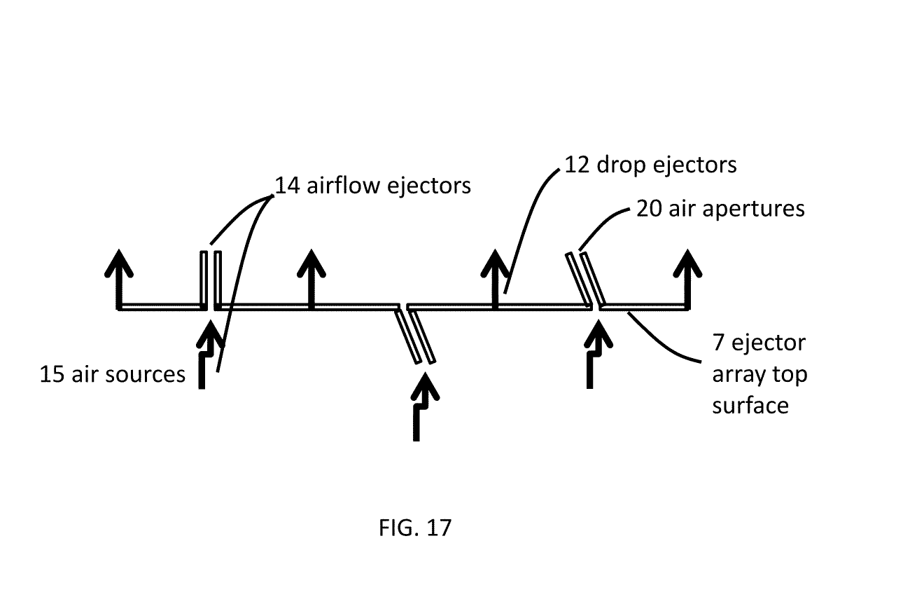

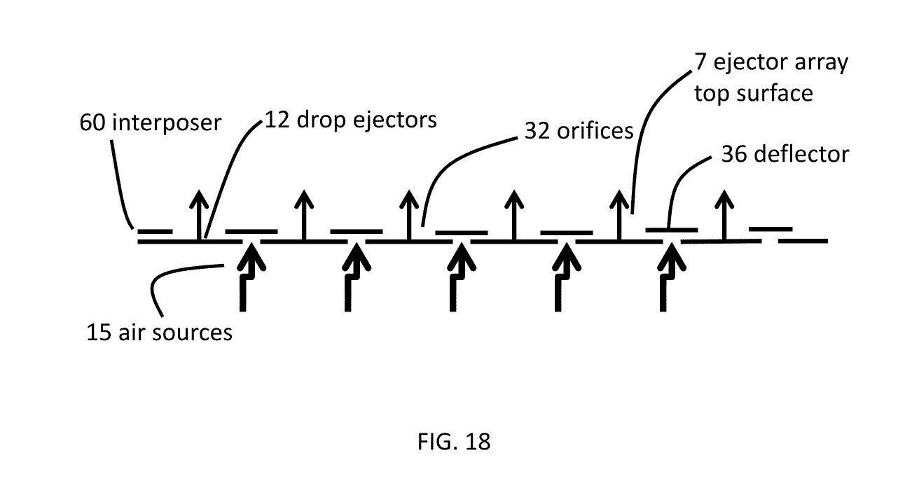

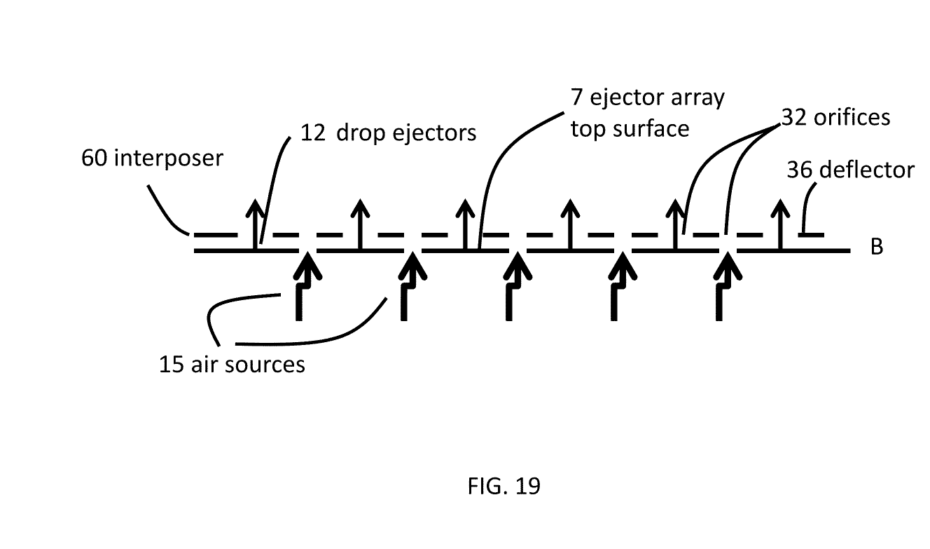

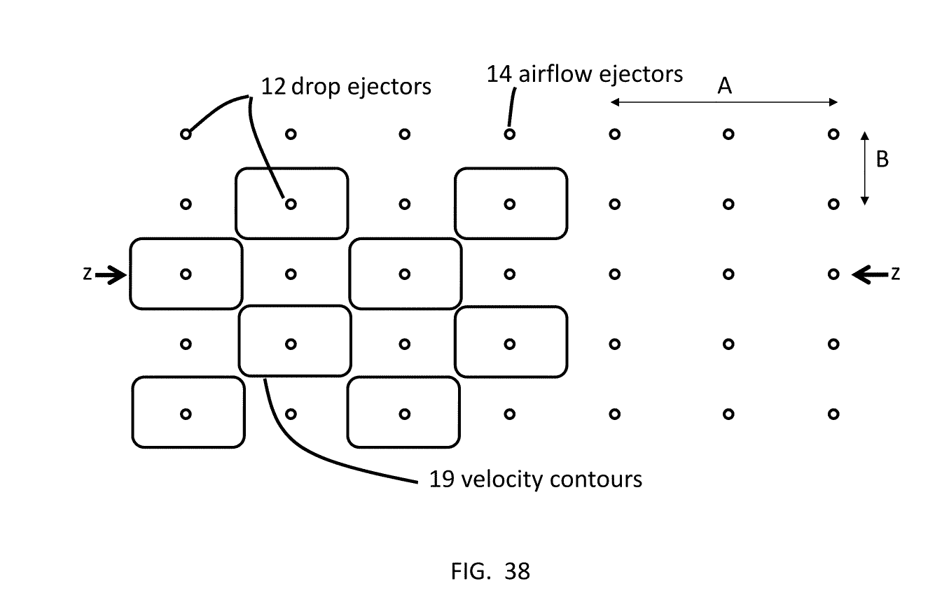

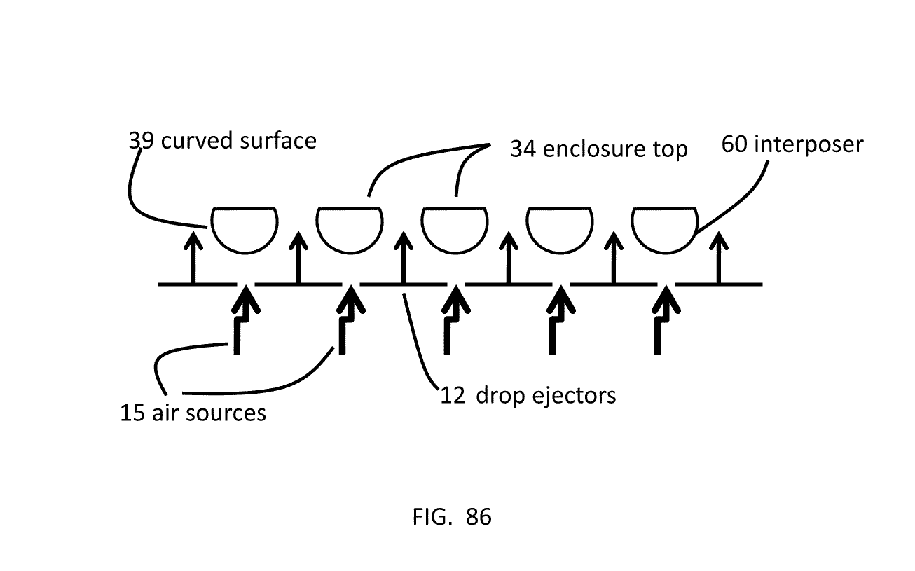

The three extreme types of individual airflow ejectors are collimated (non-dispersive) ejectors, non-collimated (dispersive or diffusive) ejectors, and ejectors which can be steered, for example by mechanical mechanisms which can alter the average direction of airflow velocities. Some examples of these ejector types are illustrated in FIGS. 15, 16, 17 and in FIGS. 18 and 19. Other more extreme examples are described in the discussions associated with FIGS. 38 and 86. Airflow ejectors can be classified as passive (fixed direction or directions of air ejection) and active (meaning they have additional functionality such as steering actuators to steer the direction of airflow as illustrated in FIG. 17 and in FIGS. 14 and 15, to be discussed, or flow control actuators to modulate the airflow flux.)

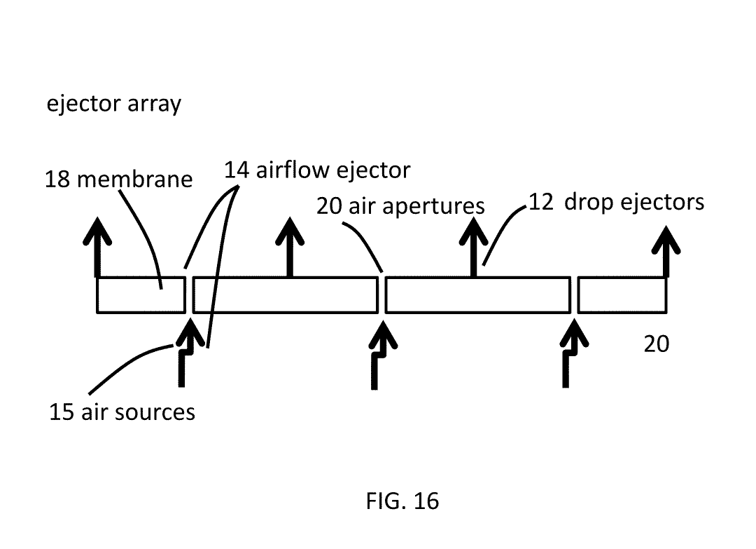

The air apertures at the left of FIG. 15 illustrates one example of a substantially collimated airflow ejector 14 in cross-section, as is well known in the art of fluid mechanics, as do the air apertures in FIGS. 16 and 17. The air apertures at the right of FIG. 15 illustrates one example of a substantially non-collimated (or dispersive or diffusive) airflow ejector 14 in cross-section, which includes a thin membrane 18 with an apertures 20 in the membrane having air dispersive elements such as granular solids or spherical beads of frit-like material, commonly made from glass, that mechanically disperse the airflow in multiple directions. Many other methods for dispersive airflow exist, as is well known in the art of fluid mechanics. For example, other means of dispersing airflow include larger mechanical deflectors, such as those shown in FIGS. 18 and 19, which direct air both horizontally, FIG. 18, and in a combination of horizontal and vertical directions, FIG. 19.

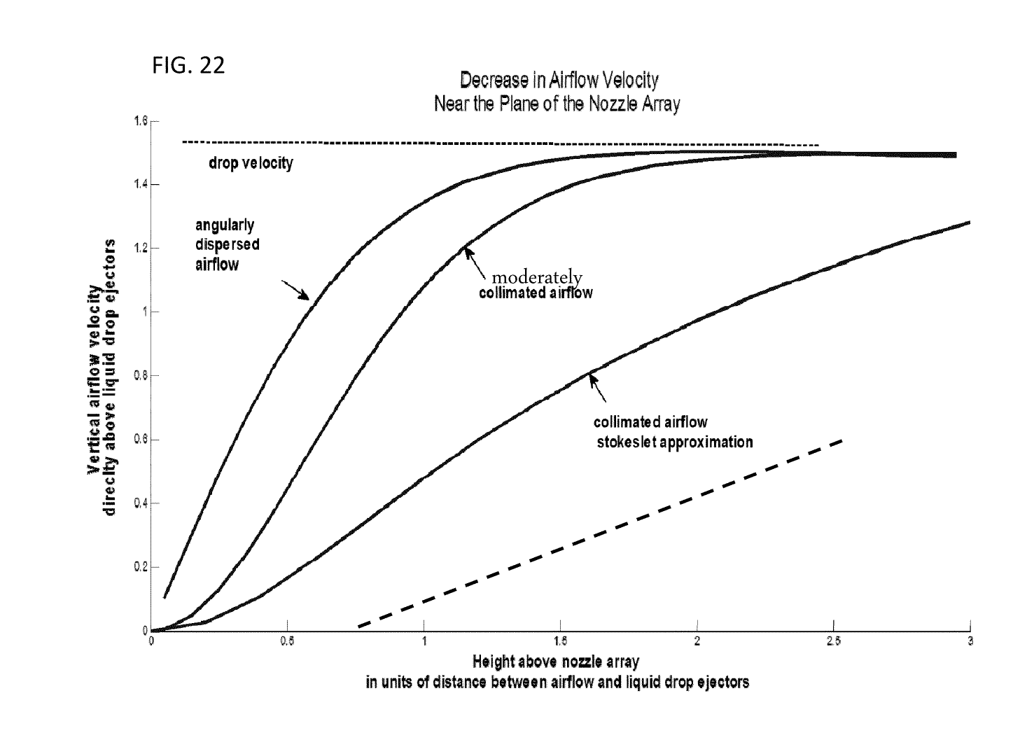

The dispersive geometry disperses some airflow laterally toward the liquid drop ejectors, that is to say the airflow pattern is more angularly dispersed compared to a collimated airflow pattern, and this is advantageous according to the present invention for improving image quality. Although some designs for dispersive airflow ejectors could apply principally to linear drop ejector arrays and others principally to two-dimensional drop ejector arrays, the degree of collimation of airflow is a useful concept for ejectors of use in either two-dimensional or linear arrays. The degree of collimation of an airflow ejector also depends on the properties of the air ejected, such as the density, viscosity, and Reynolds number of the air. Therefore, it is preferable to specify the collimation directly, rather than specifying the geometry of the airflow ejector and the properties of the air, in determining the optimal airflow for a given application. The collimation is specified by the angular dependence of the air flux over the air aperture of the airflow source. Such ejectors can help deliver air along the trajectory of ejected drops even close to the plane of the drop ejectors and even if the airflow ejector is spaced away from the drop ejector, as shown in FIG. 18. A vertical flow of air along the drop trajectories for each drop ejector results from the combination of airflows from the horizontal airflows produced by the deflectors 36 surrounding each drop ejector. However, for such dispersed flow, the vertical flow velocity along the drop trajectories occurs much closer to the plane of the drop ejectors, which reduces air drag and the drops and promotes formation of uniform drops, as will be discussed in association with FIG. 22. In all these figures, the airflow ejectors, shown as compound (jagged) arrows in FIGS. 15-19 are shown interspersed with drop ejectors 12, shown as (straight) arrows. The base of the simple arrows correspond to the location of physical drop ejector devices, for example a bubble jet drop ejector device or a piezo drop ejector device, as is well known in the art of inkjet ejectors, while the head of the simple arrow indicates the drop paths of ejected drops. The drop ejectors may be of the DOD or CIJ; for CIJ types, the head of the simple arrow represents the end of the jet or liquid column where it breaks into drops. The current discussion applies to either DOD or CIJ ejector types. The compound (jagged) arrows in FIGS. 15-19 indicate the path and general direction of airflow; the slight jag in the tail of the compound arrow is included only to identify the flowing material is air, not liquid. Typically, air pressure propels air along the path indicated by the compound arrows. Each air source could have its own means of creating local pressure or, alternatively, all air sources could be connected to a common air pump (not shown) remote from the printhead, since air generally flows continuously, as opposed to the ejection of drops of liquid to be printed, which occurs only at selected times. Airflow ejectors 16 shown in FIG. 15 are simple openings or apertures in a thin membrane (compared to the diameter of the opening) and are therefore easy to fabricate. Other airflow ejectors contemplated include airflow ejectors which have thicker membranes, for example membrane thicknesses in the range of from 5 to 100 the aperture diameter, as illustrated by the device structures of FIGS. 16 and 17. In all these cases, FIGS. 15, 16, and 17, the airflow is collimated as it leaves the ejection apertures and flows in a direction perpendicular to the drop ejector plane. However, the airflow does not strike the ejected drops as near the ejector array top surface 7 as is desirable for the airflow to engage the drops immediately after ejection (or in the case of CIJ drop ejectors, immediately after the formation of the liquid jet.). Otherwise, these related embodiments share the advantage with the preferred embodiment that the space between the plane of the drop ejectors and the receiver is entirely unencumbered with mechanical hardware; that is, there is no interposing layer required.

Another example of control of the direction of airflow is shown in FIGS. 2 and 19, where air from air sources 15 is deflected by deflectors 36 which are regarded as a parts of interposer 60, lying very close to the ejector array top surface 7, which cause air to flow laterally toward the base of drop ejectors 12. In FIG. 19, the deflectors 36 have additional orifices 32 to allow air to flow vertically as well as laterally. In these cases, the net result of the air interacting with the deflectors 36 of interposer 60, lying very close to the ejector array top surface 7, is to produce airflow toward the receiver having an angular distribution of velocities. For example, in the case of FIG. 19, the velocity profile clearly peaks at 90 degrees (lateral flow) and 0 degrees (vertical flow) when viewed from a distance above the ejector array top surface. Generally, a specific collimation of airflow as seen by the drops some distance above the ejector array surface may be achieved by a combination of the geometry of the air ejectors, the fluid properties of the air, and the surfaces above the airflow ejectors associated with interposer 60. It is preferable to specify the airflow collimation directly as an angularly dependent air flux, rather than by specifying the geometry of the airflow ejectors, interposer surfaces, and air properties in determining the optimal airflow for a given application.

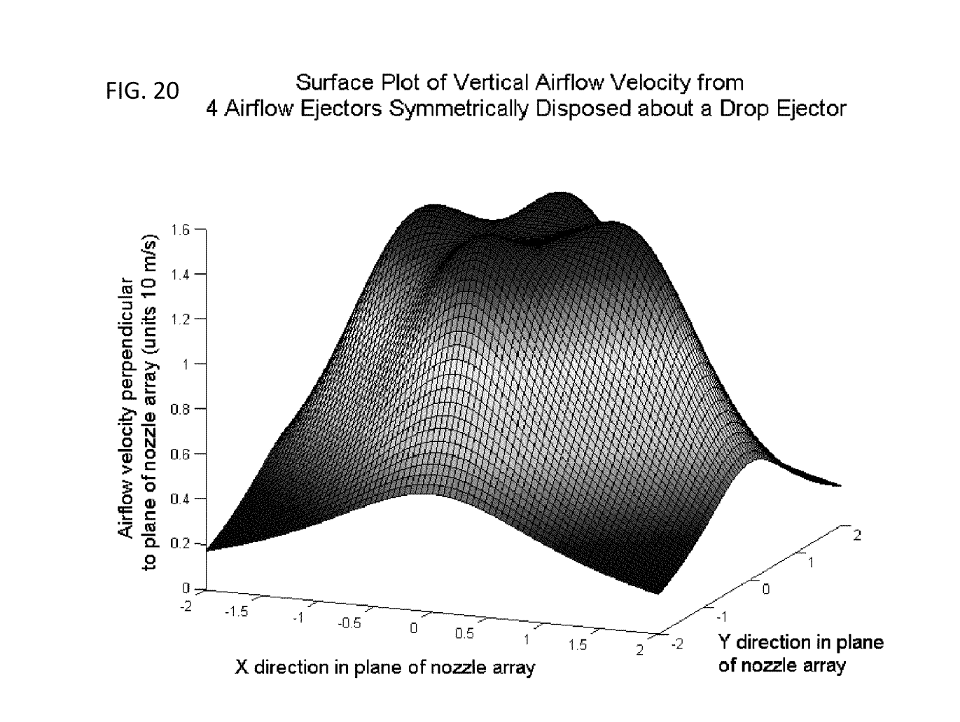

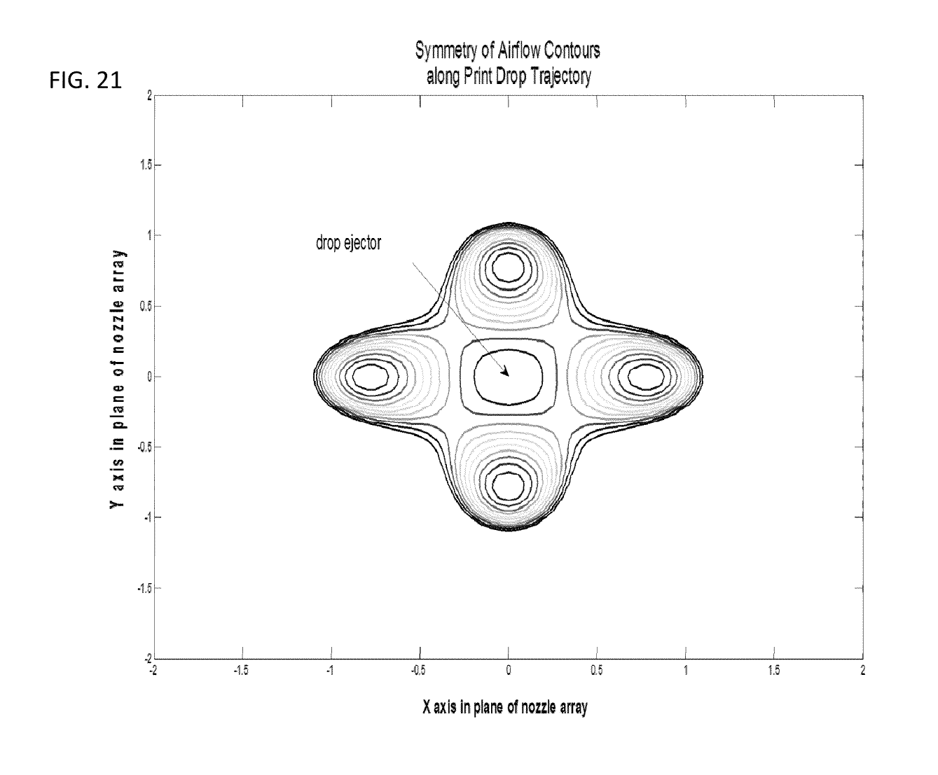

FIGS. 4 and 5 illustrate this specification in terms of a surface plot and a contour plot of a modeled vertical component of airflow velocity produced from four airflow ejectors located in four-fold symmetry about a drop ejector positioned at the origin. All the ejectors lie in the plane of the ejector array top surface, with locations of the airflow ejectors similar to those shown in FIG. 6. Each of the modeled airflow ejectors in FIGS. 4 and 5 is of the dispersive type, each ejector providing airflow rotationally symmetric about its location in the plane of the ejector array and sending its maximum airflow upwards. The angular spread of the airflow falls off as the cosine of the angle measured from the vertical direction for the modeled airflow source. The contour plots of FIG. 21 are derived from the surface plot of FIG. 20, as is well known in the art of mathematical modeling. Although the present invention will later contemplate a substantially two-dimensional array of drop ejectors interspersed symmetrically with a substantially two-dimensional array of airflow ejectors, FIGS. 4 and 5 usefully serve to illustrate the model concepts. FIG. 20 plots the vertical airflow velocity at a location of one distance unit above the plane of the ejector array top surface, the ejectors all lying in the x-y plane of FIG. 20. The vertical velocities at each point in the x-y plane are plotted along the vertical (z) axis. All distances are given in units equal to the distance between adjacent airflow and drop ejectors. The 4 peaks in airflow correspond to the location of the airflow ejectors. FIG. 21 is a contour plot of FIG. 20 showing lines of constant vertical velocity at one unit above the ejector plane. The 4 contour peaks correspond to the location of the 4 airflow sources surrounding the drop ejector located at coordinates (+−1, +−1) in the x-y plane, as can be appreciated by one skilled in airflow modeling. The contours around the drop ejector at the origin (0, 0) of the x-y plane are approximately rectangles with rounded corners extending toward the saddle points between airflow ejectors, as can also be appreciated by one skilled in airflow modeling. Because the number of airflow ejectors is very small, namely 4, the vertical airflow falls off rapidly far away from the drop ejector. The particular value of vertical velocity in the center of FIG. 20 is chosen to be very near the value of the velocity assumed for the ejected drops, in this example 16 m/s, to minimize the drag of air on the drops in accordance with the present invention. The airflow from each of the 4 airflow ejectors interacts with the ejected drops, so that modeling is required to determine the airflow velocities for each ejector individually in order that the sum of the 4 airflows matches the assumed drop velocity. The velocity contours in FIG. 21 have been calculated with invisid airflow models to illustrate how the symmetry of the location of airflow sources mirrors the symmetry of the velocity contours surrounding each ejected drop as well as how this information is used to compute the drag of air on ejected drops (FIG. 22).

FIG. 22 plots the airflow velocity in the vertical direction along the trajectory of the drop ejected at location (0,0) of FIG. 20 against the vertical distance from the x-y plane, based on the models illustrated in FIGS. 4 and 5. This plot differs from FIGS. 4 and 5 because it reveals the air velocity only along the drop trajectory (perpendicular to the array top surface) but at all distances above the x-y plane of the ejector array top surface. The calculation is done for three different types of airflow sources having different degrees of collimation. The angularly dispersive airflow source shown by the left plot corresponds to a hypothetical source whose airflow radiates outwards equally in all directions. This source provides vertical airflow whose velocity more nearly matches the velocity of the ejected drops at distance much closer to the ejector array from which the drops are ejected than do the less dispersed sources show as plots on the right side of FIG. 22. This preferred airflow pattern reduces the drag on ejected drops, particularly close to the array top surface (zero height above the array), which allows the drops to travel further to a receiver and to dissipate less energy. (The performance measure of energy dissipation for a printing system operating with different airflows will be quantified later in discussions on substantially two-dimensional arrays.) The less dispersive (moderately collimated) airflow source corresponding to the middle plot collimates the air according to a multiplicative cosine factor multiplying the air velocity by the cosine of the angle with respect to a normal to the drop ejector array, as discussed for FIGS. 4 and 5. The more collimated airflow source corresponding to the right plot approximates the angular dependence of a solution to non-turbulent “Stokeslet” airflow. (REF. Currie, Stokeslet solution of Navier Stokes equations.) Note in FIG. 22 that the saturation velocity at distances far from the x-y plane for each of the three degrees of airflow ejector collimation is that of the initial velocity of the ejected drops, here arbitrarily assumed to be about 16 m/s. All flows contemplated in FIG. 22 are effective in guiding the airflow along the drop trajectories in accordance with the present invention, due to the symmetry of the interspersed airflow sources and drop ejectors. However, as shown in FIG. 22, greater degrees of collimation imply larger distances of mismatch between the initial drop velocity and the airflow velocities close to the array top surface. Thus while not required by the present invention, the more dispersive airflow sources better guide ejected drops and minimize air drag on them, as will be quantified later. The dotted line in FIG. 22 corresponds to a numerical simulation of the airflow for the geometry of interspersed drop and airflow ejectors depicted in FIGS. 15 and 16, which are highly collimated. Because the airflow ejectors are spaced away from the drop ejectors by one unit of measure, the airflows from the airflow ejectors on either side of the drop ejector require many units of travel toward the receiver before they spread to overlap with the drop trajectory. This can be compensated by the angled geometry of the airflow ejectors, such as the single angled airflow ejector shown in the center of FIG. 17. When two such ejectors on either side of a drop ejector are each aimed at the ejector at an angle of 40 degrees from the vertical, the resulting plot of airflow velocity in the vertical direction along the trajectory of the drop is nearly identical to that of the left plot in FIG. 22. The degree of dispersion of airflow for this configuration better guides drops than that of the geometry of FIGS. 15 and 16.

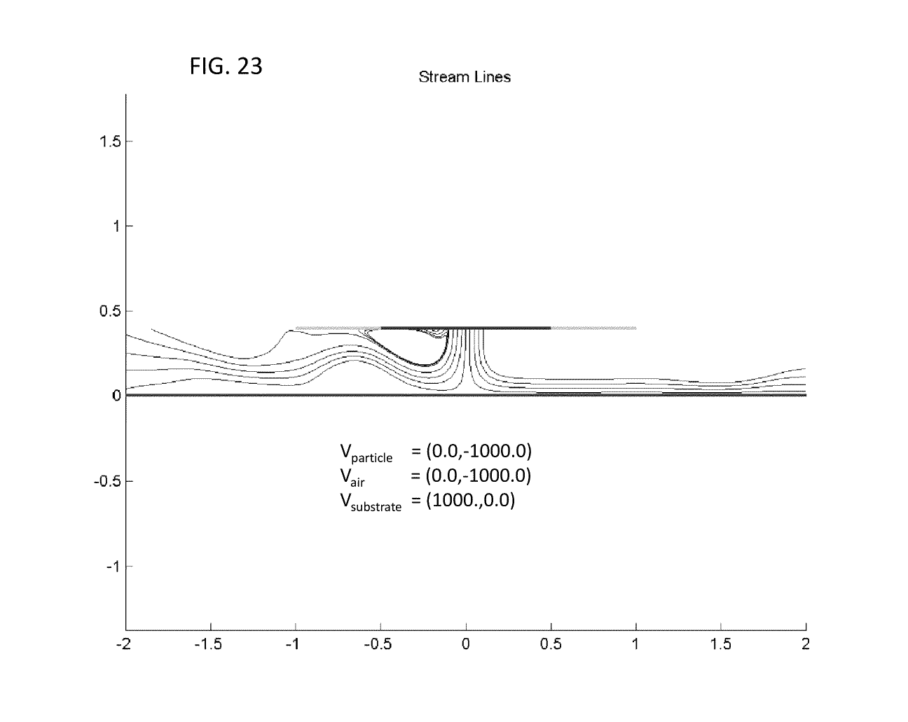

FIG. 23 is a model simulation of airflow streamlines for a preferred embodiment of the linear ejector array 3 of FIGS. 9 and 10. Because the air apertures in FIGS. 9 and 10 are very close to the drop ejectors, preferable 10 to 100 microns from the drop ejectors, the airflow impinges on the ejected drops very close to the ejector array top surface. Results similar to those shown in FIG. 23 would be obtained with the airflow ejector geometry of FIG. 2. Although the airflow ejectors shown in FIGS. 4, 5, and 6 are effective in guiding drops toward the receiver, they are less effective than the ejectors of FIGS. 2 and 3. Preferably, the airflow velocity along the central streamline in FIG. 23, i.e. along the trajectory of an ejected drop, reaches a maximum as close as possible to the ejector array top surface, preferably within a distance comparable to the drop formation length, typically 50-1000 microns, as is well known in the art of inkjet printing, to aid drop formation.

For the geometry shown in FIGS. 4, 5, and 6, the airflow velocity at the air aperture of the airflow ejectors should be increased, even to values greater than the initial velocity of the ejected drops, to provide more total airflow as well as to ensure a match of the velocity of the airflow as closely as possible to the drop velocity during the travel of the drop to the receiver, because the number of airflow ejectors is less than that for other cases, and the streamlines must therefore spread out as the airflow moves toward the receiver, as can be appreciated by one skilled in fluid dynamics.

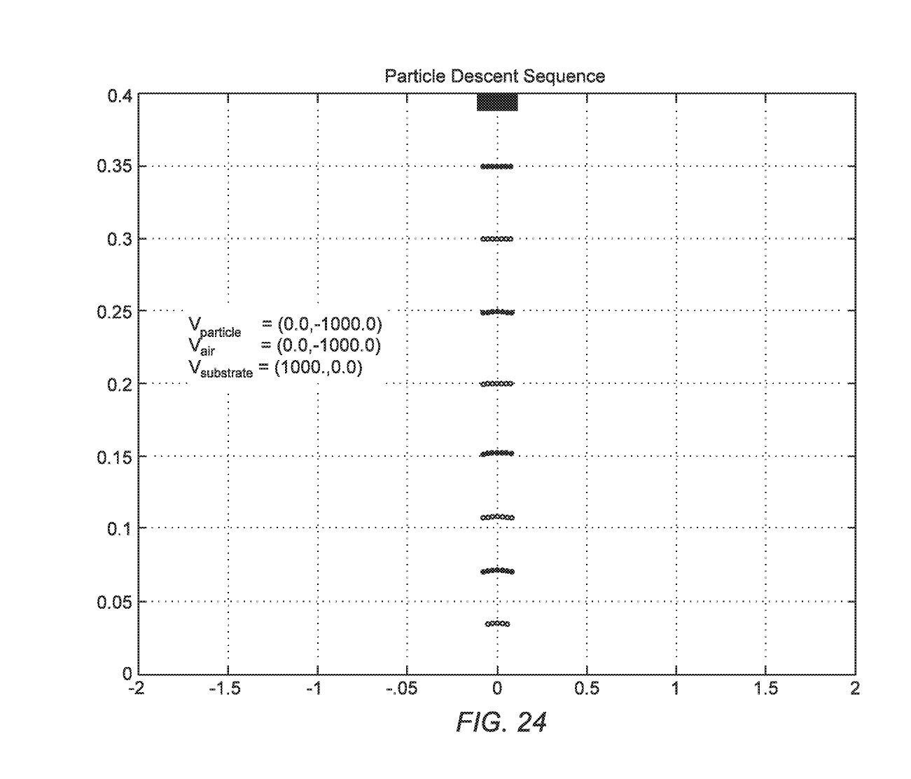

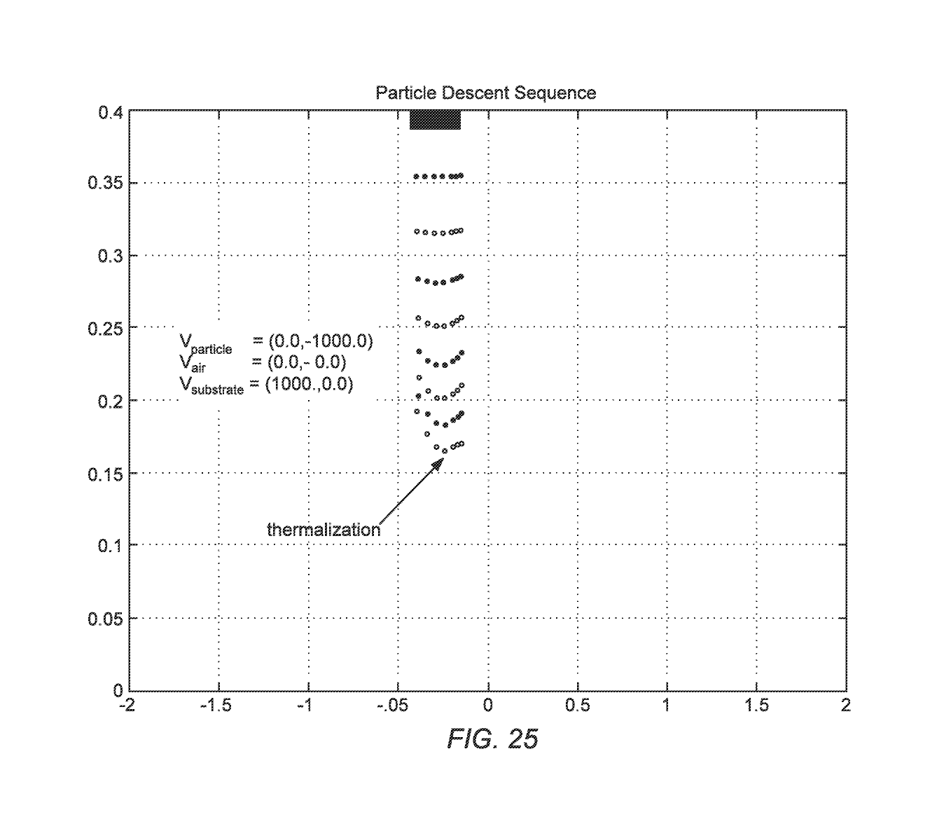

A cross-sectional view of the airflow associated with the drop ejector array of FIG. 10, along a line labeled AA in FIG. 9, is shown in FIGS. 23 and 24. FIG. 23 shows airflow streamlines and FIG. 24 shows time snapshots of drops ejected into the streamlines one after another from a particular ejector, for example the ejector touched by line AA in FIG. 9. In this embodiment, the drop ejectors are surrounded symmetrically in the direction of receiver motion by airflow ejectors, and the airflow ejectors extend away from the drop ejector along line AA by a distance that is a small fraction of the distance between the ejectors and the receiver, preferably 5% to 20%. If the length of the airflow ejector (along line AA) is less than about 5% of the distance between the ejectors and the receiver, the airflow is insufficient to optimally guide the drops to the receiver. If the length of the airflow ejector (along line AA) is greater than about 20%, the additional airflow increases the drop transit time slightly, which is generally undesirable, due to pressure build-up in the region below the printhead. The trajectories in cross-section would be essentially identical for drops ejected from any of the ejectors in FIGS. 9 and 10, except for negligible differences for the drops at the very ends of the array, since most of the airflow for a given drop ejector is contributed by only a few airflow ejectors on either side of that ejector, especially if the airflow is collimated. The test drops shown in FIG. 24 show drops “ejected” at regular time intervals from the ejector on line AA in FIG. 9. In this example, the airflow velocity at the drop ejector array (1000 cm/s) in FIG. 24 is made identical to the initial drop velocity (1000 cm/s) just after ejection, to minimize air drag after drop ejection. To illustrate the beneficial effect of the airflow of FIGS. 23 and 24, test drops are in FIG. 25 ejected as in FIG. 24 but with the airflow turned off. These drops do not reach the receiver, even after substantially long times (for example times long compared to the time required for the receiver to move the width of the printhead, typically 1-10 ms for a linear drop ejector array 3), making printing completely impractical. As is known in fluid dynamics, the drops under such conditions eventually slow to thermal velocities (thermalize, forming a mist) and undergo random motion, degrading print quality, even if they could be printed. It therefore clear in this example that the presence of airflow for the linear ejector array 3 of FIG. 4, under the conditions discussed in FIGS. 23, 24, and 25, is highly effective in guiding ejected drops and minimizing air drag, making the difference between failure and success of the printing system.

In fact, in practice if the drops at the location of the receiver have a velocity reduction of 90% of their initial velocity, practical image quality suffers greatly due to many effects, including horizontal air currents induced by motion of the receiver, which perturb the motion slow drops, making their trajectories substantially parallel to the receiver motion. Due to random air currents, characteristic of practical printing systems operating in ambient environments, for slowly traveling drops, especially drops with a horizontal velocity components comparable to their vertical velocity components, the landing position of the drops is very sensitive to fluctuations in drop velocity, drop ejection angle, and drop volume. These fluctuations occur in all practical systems during drop ejection and formation.

In summary, as drops slow due to air drag in the absence of airflow ejectors, drop travel times to the receiver are large, and the landing position on the receiver can be very far from the printhead. Fluctuations in receiver velocity, stretching of the receiver due to wet loading, and vertical motion of the receiver due to vibrations of the transport mechanism contribute to random errors in drop placement. Additionally, in the absence of airflow, air drag on the drops may not only slow the drops excessively, it may interfere with drop formation and drop stability, especially near the drop ejectors, distort drop shapes, and exacerbate drop-drop interactions, all of which can severely limit image quality. Thus reduction of drop velocity to about 90% of the initial value is here considered as a severe restriction on image quality. It should be noted that the distance from printhead to receiver for which a velocity reduction of 90% occurs is very close to (typically within a mm of) the distance for which drops just fail to reach the receiver in a practical time, i.e. a time long compared the time required for the receiver to move the width of the printhead, typically 1-10 ms for a linear drop ejector array 3. And since designers of print systems typically space the receiver as far from the printhead as good image quality allows, to avoid holding very tight mechanical tolerances or to enable printing on rough substrates, the printing system to be considered a candidate for improvement is taken to be a system for which, in the absence of vertical airflow from airflow ejectors, drops just fail to reach the receiver in a time of about 1 ms.

In summary, it should be noted that the print system of FIGS. 23, 24, and 25 was deliberately configured to maximally illustrate the benefits of airflow ejectors. For example, had the receiver in FIGS. 23, 24, and 25 been placed much closer to the printhead, for example at a distance of 2.5 mm instead of 4.0 mm, the drops would have printed even with no airflow from the airflow ejectors, as can be anticipated from FIG. 24. (And similarly had the receiver in FIGS. 23, 24, and 25 been placed much further from the printhead, for example at a distance of 40 mm instead of 4.0 mm, the drops would have not have printed even with airflow from the airflow ejectors.) As discussed above, for comparing examples of print systems with and without airflow from airflow ejectors, we find it useful to place the receiver an approximate distance from the printhead at which ejected drops, unassisted by airflow, have about 10% percent of their initial velocity at the receiver. This is due to the fact that printing without airflow at a distance where drops just barely reach the receiver provides marginally good image quality and to the fact that the distance where drops barely reach the receiver is not far from the distance from which drops fail to reach the receiver in times of about 1 ms. The present invention addresses means by which image quality and throw distance may be increased by the use of airflow ejectors. These increases will be quantified by comparing systems having no airflow for which image quality just suffers from an overly long throw distance with a similar systems having airflow ejection of particular airflow types and airflow velocities. Improvements may come in the form of increased image quality for the same throw distance, increased throw distance for the same image quality, or a combination of both. These system comparisons are useful for both substantially one-dimensional arrays of ejectors as well as substantially two-dimensional arrays of drop ejectors.

Air drag due to receive motion is not generally large for substantially linear arrays. For substantially linear arrays of drop ejectors, the printhead width in the direction of receiver motion, shown in cross-section in FIG. 23, can generally be made small, for example 1 mm to 10 mm, since only one row of drop ejectors need be made, and in this case, the influence of receiver motion on the air is restricted to a small boundary layer near the receiver and only slightly perturbs the motion of drops as they reach the receiver. However, a very different result will be encountered for substantially two-dimensional arrays, as will be described, for which the width of the printhead is typically large, for example 10-1000 mm, in which case, the influence of receiver motion on the air can more significantly perturb the motion of drops before they reach the receiver.

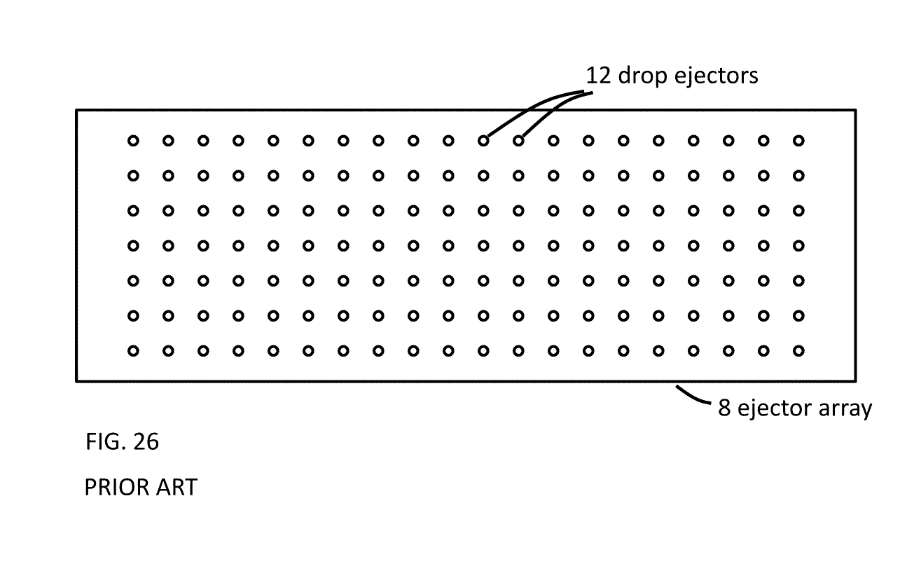

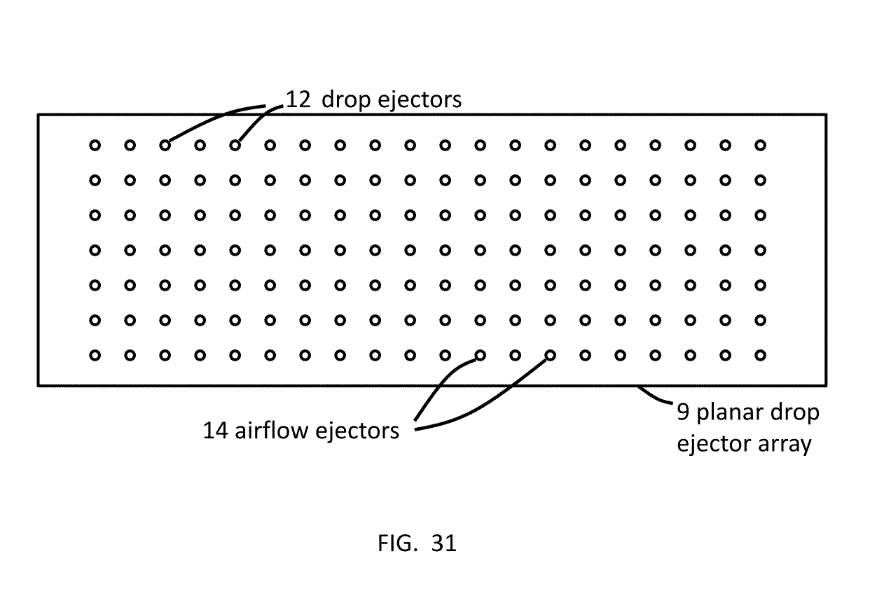

Preferred embodiments are now described for substantially two-dimensional drop ejector arrays. Two-dimensional inkjet arrays are much more difficult to manufacture than linear drop ejector arrays; but, if properly designed, they can print high quality images at much higher speeds. A prior art substantially two-dimensional array of drop ejectors is shown in FIG. 26. A substantially two-dimensional array of drop ejectors interspersed with airflow ejectors in accordance with the present invention is shown in FIGS. 31, 32, and 33, to be discussed later. For the purposes of the current discussion, substantially two-dimensional arrays of ejectors, either of the liquid drop type or of the airflow type or of mixed types, are assumed to be very large arrays of ejectors, spaced apart by a distances of less than 1000 microns. Airflow ejectors which can be used in two-dimensional arrays necessitate very robust designs, and often special materials and manufacturing processes for reasons of size and strength. Typical sizes of substantially two-dimensional arrays include, but are not limited to, arrays having 100-10,000 ejectors in each direction. Airflow ejectors for use in substantially two-dimensional arrays can be used for linear arrays as well, since an ejector sufficiently robust for application in two-dimensional arrays will generally be sufficiently robust for linear arrays.

The descriptions and attributes of the two-dimensional arrays of the present invention parallel the discussions of the linear arrays described in the first embodiments. The liquid drop ejectors 12 and airflow ejectors 14 are typically interspersed in both dimensions and are closely spaced (less than 1000 microns). As discussed above for substantially one-dimensional ejector arrays, from airflow ejectors, we find it useful in the case of substantially two-dimensional ejector arrays to consider as a base case a configuration with the receiver spaced from the printhead so that drops have about 10% percent of their initial velocity at the receiver without airflow. The present invention addresses means by which image quality and throw distance for a substantially two-dimensional array may be increased from the base case by the use of airflow ejectors. Improvements may come in the form of increased image quality for the same throw distance, increased throw distance for the same image quality, or a combination of both and will be systematically quantified by modeling drop trajectories, transit times, energy dissipation, and sensitivity to fluctuations in drop ejection parameters such as velocity, mass, and direction of drop ejection.

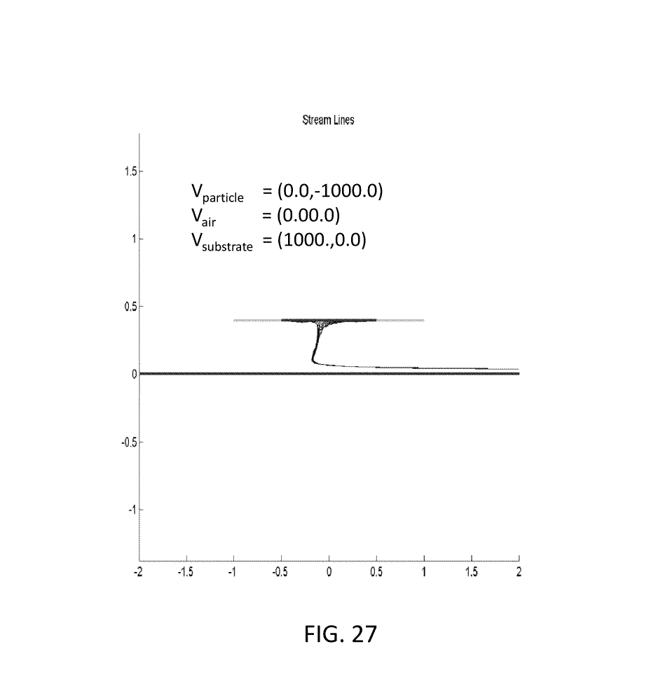

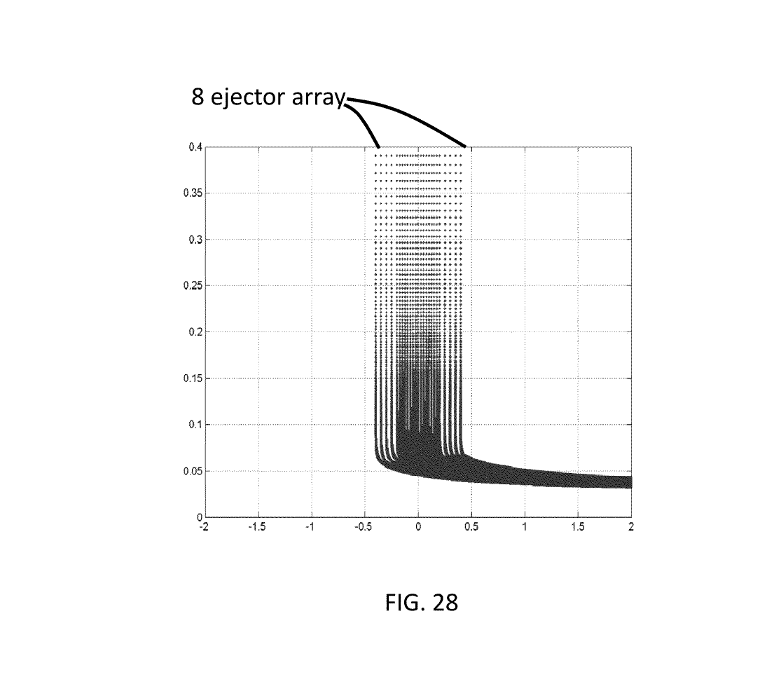

It is not only more difficult to manufacture two-dimensional arrays than linear arrays; it is also more difficult to control airflow for the two-dimensional geometry, even if no airflow ejectors are contemplated. FIGS. 27 and 28 illustrate one of many problems encountered in the practice of substantially two-dimensional arrays that do not arise or arise with lesser consequence in the case of linear arrays. Additional problems in controlling airflow in two-dimensional geometries, namely those having to do with the use of airflow ejectors to increase print quality and drop throw distance, will be discussed later, in reference to FIG. 16. As will be seen, airflow ejection must not only guide drops vertically toward the receiver, it must compensate for horizontal airflow induced by receiver motion under the large printhead width of a two-dimensional ejector array.

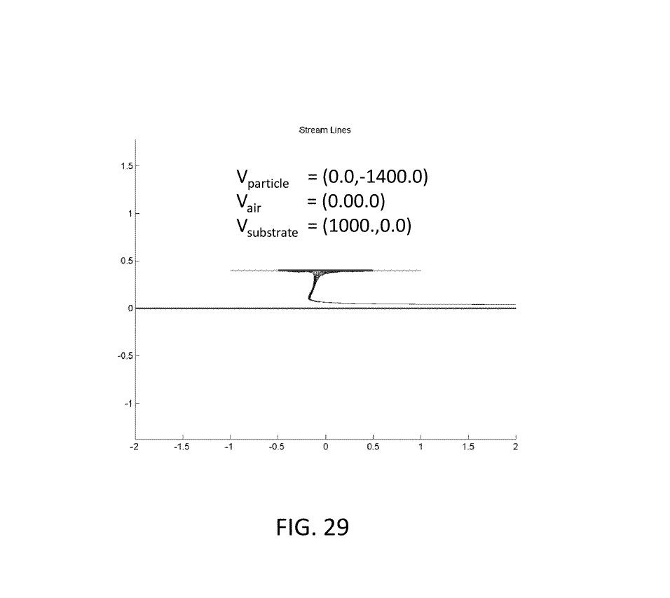

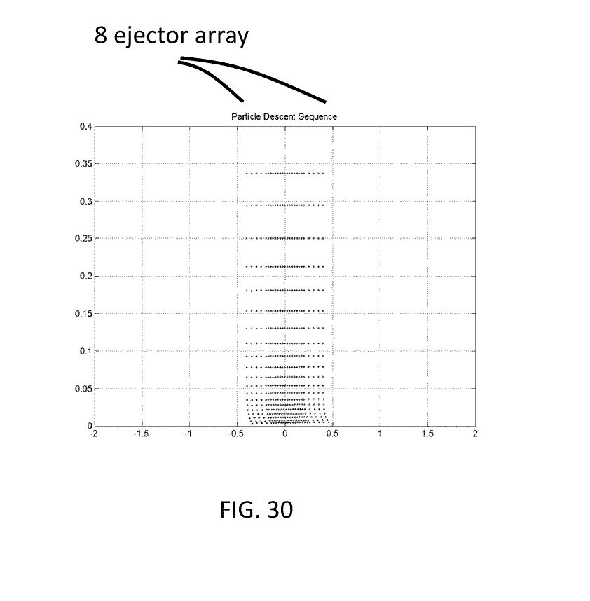

In FIG. 27, model airflow streamlines are shown for the printhead illustrated in FIG. 26 having dimensions of 20 mm in the direction of receiver motion with drop ejectors spaced every 200 microns in a central region of width 8 mm. The receiver in this example is assumed to be moving 1000 cm/s at a distance 4 mm beneath the ejector array. The problem encountered for the substantially two-dimensional array that does not arise or arises with lesser consequence in the case of linear arrays is shown in FIG. 28, which displays the drop trajectories of ejected drops with initial velocities of 1000 cm/s, matching the receiver speed. As can be seen in FIGS. 27 and 28, the air velocity induced in the direction of receiver motion is sufficient to expel all the drops out of the print region, so that they do not reliably land on the receiver. The larger width of the printhead in the direction of receiver motion exaggerates this effect in comparison with the linear array of FIG. 9. Of course, for very large drops, typical of low quality inkjet printing, this would not occur because of their more substantial mass, as can be appreciated by one skilled in the art of fluid dynamics. A prior art solution to this problem is shown in FIGS. 29 and 30, similar to FIGS. 27 and 28, in which an increase in the initial velocity of the ejected drops from 1000 to 1400 cm/s results in the drops landing on the receiver. Unfortunately, it is not generally possible to arbitrarily increase the initial drop velocity, due to consequent lack of control of the drop ejection mechanism nor is it possible to arbitrarily increase the drop mass and retain high resolution image quality; therefore the base cases to be considered assume that mass and velocity parameters have already been optimized, and additional benefits from airflow ejection are sought.

FIG. 31 illustrates the simplest two-dimensional embodiment of the current invention comprising a substantially two-dimensional array of drop ejectors 12 interspersed in a uniform grid pattern with a substantially array of airflow ejectors 16. In the simplest embodiment, the rows of airflow ejectors 14 and the rows of drop ejectors 12 lie in straight lines. Similarly in FIG. 31 the columns of air flow ejectors 14 and the columns of drop ejectors lie in straight lines. The airflow ejectors 14 and the drop ejectors 12 are coplanar (located on the top of drop ejector array 20), equally spaced, and manufactured identically, in the simplest embodiment. The difference in the two types of ejectors in this embodiment is due only to the connection of the ejectors to either an air or a liquid source. However, as in the discussion of the linear array embodiments, it is also contemplated that airflow ejectors 14 and liquid drop ejectors 12 can be of a different design or geometrical dimension or slightly altered in location, although preferably they are commonly manufactured. Preferably, the space between the plane of the drop ejectors and the receiver 200 is entirely unencumbered with mechanical hardware; that is, there is no interposer 60 in simplest embodiment. Also preferably, the airflow ejectors 14 are of the dispersive type. This disperses the airflow laterally toward the liquid drop ejectors 12. This embodiment is now made possible by MEMS (MicroElectroMechanical) silicon fabrication technology and is the least expensive to manufacture. It provides directed airflow toward the receiver at the liquid ejector locations with minimal air turbulence. This geometry efficiently disperses airflow laterally toward the liquid ejection orifices with minimal viscous interaction. The four fold symmetry, FIG. 31, of the airflow ejectors 14 with respect to the liquid drop ejectors 12 ensures that the airflow from the airflow ejectors is entirely vertical (i.e. collinear with the drop trajectories) along a path perpendicular to the drop ejector array and located directly over each liquid ejector, as can be appreciated by one skilled in fluid mechanics.

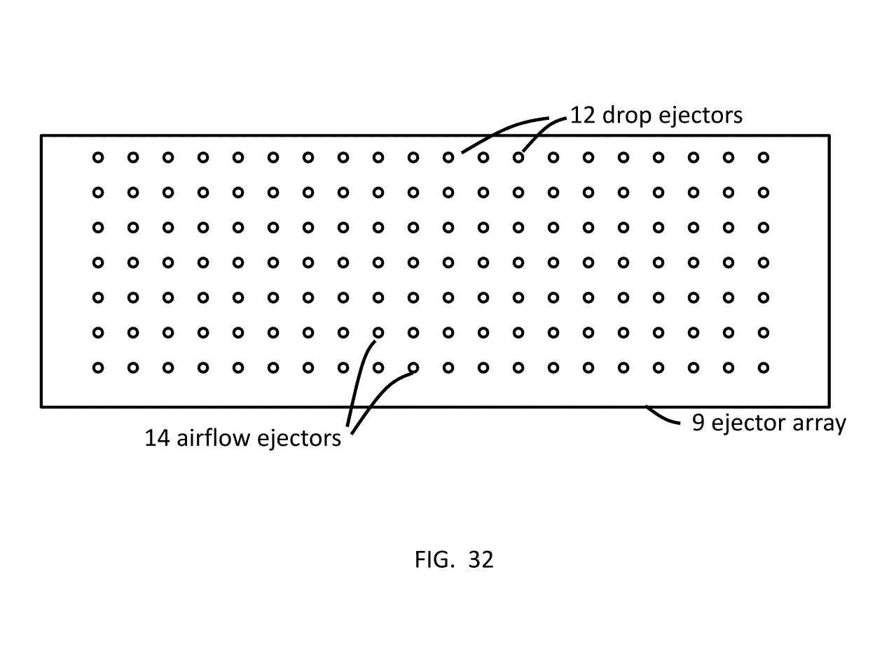

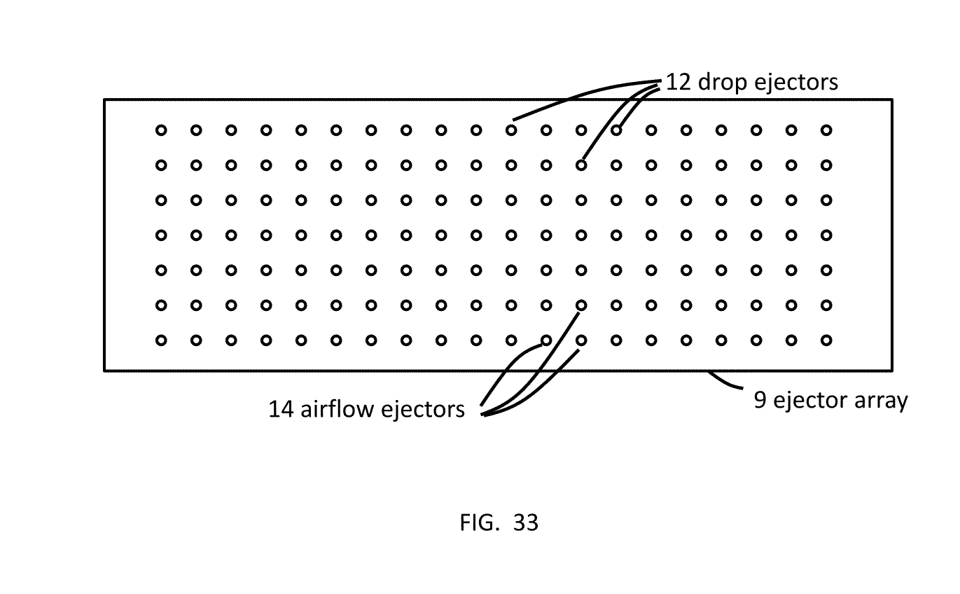

In FIGS. 32 and 33, two of many possible alternative geometries for interspersing airflow and drop ejectors are shown. As in the case of the linear array embodiments, airflow ejectors partially collimate the ejected air. If the airflow is collimated as is leaves the airflow ejectors, and flows in a direction perpendicular to the drop ejector plane at the location of the liquid drop ejectors, it will not interact with the ejected drops as efficiently as for the case of diffuse airflow ejection, and drops will pass through a zone of lower than desired airflow velocity just after being ejected.

It is recognized that in the context of this discussion, that the preferred symmetries of the locations of the airflow ejectors relative to the drop ejectors (no alteration by airflow of the drop trajectories) are slightly broken by the fact that the area of the drop ejector array is finite. Thus each drop ejector experiences very slight differences in the number of ejectors between it and the various outer edges of the drop ejector array. However, the primary effects of airflow ejectors on a given drop ejector are limited to very short distances, typically a few ejector to ejector spacings. Thus the substantially identical pattern of airflow ejectors about a given drop ejector refers to a local environment about that drop ejector and is approximately valid for most ejectors but not valid along the edges of the drop ejector array. For substantially two-dimensional drop ejector arrays, this results in a negligible fraction of drop ejectors whose interactions with airflow are non-optimal. Such drop ejectors are preferably not used to print.

The geometry shown in FIG. 31 shares the attributes of simplicity of design and fabrication, collinear airflow of air along the drop trajectories, and absence of hardware between the two-dimensional drop ejector array 20 and the receiver with previous embodiments. Each drop ejector in FIGS. 31 and 32, except those on the perimeter of the drop ejector array, is two-fold symmetric with respect to the airflow ejectors, as can be appreciated by one skilled in device design, and each drop ejector is surrounded by a substantially identical pattern of airflow ejectors, ensuring that the airflow and drop trajectories are collinear along the intended path of the drops (perpendicular to drop ejector array 20). As can be also appreciated by one skilled in device design, many other geometrical arrangements of drop ejectors interspersed with airflow ejectors are possible. For designs in which each drop ejector, except those on the perimeter of the drop ejector array, is surrounded by a substantially identical pattern of airflow ejectors, such as drop ejectors in FIGS. 31 and 32, the airflow and drop trajectories are collinear along the intended path of the drops (perpendicular to drop ejector array 20). For designs for which this is not the case, such as the pattern of liquid drop ejectors 12 and airflow ejectors 16 shown in FIG. 33, the airflow and drop trajectories are not collinear along the intended path of the drops; for example adjacent pairs of drop ejectors in FIG. 33 experience airflow which tends to direct their paths toward one another. Thus the drops may not land on the desired pixel locations with airflow, assuming the drop would land on the desired pixel locations with no airflow, unless the positions of the drop ejectors are altered or the drops steered to correct for lack of symmetry. While such embodiments are possible, embodiments for which each drop ejector is surrounded by a substantially identical pattern of airflow ejectors are preferred.

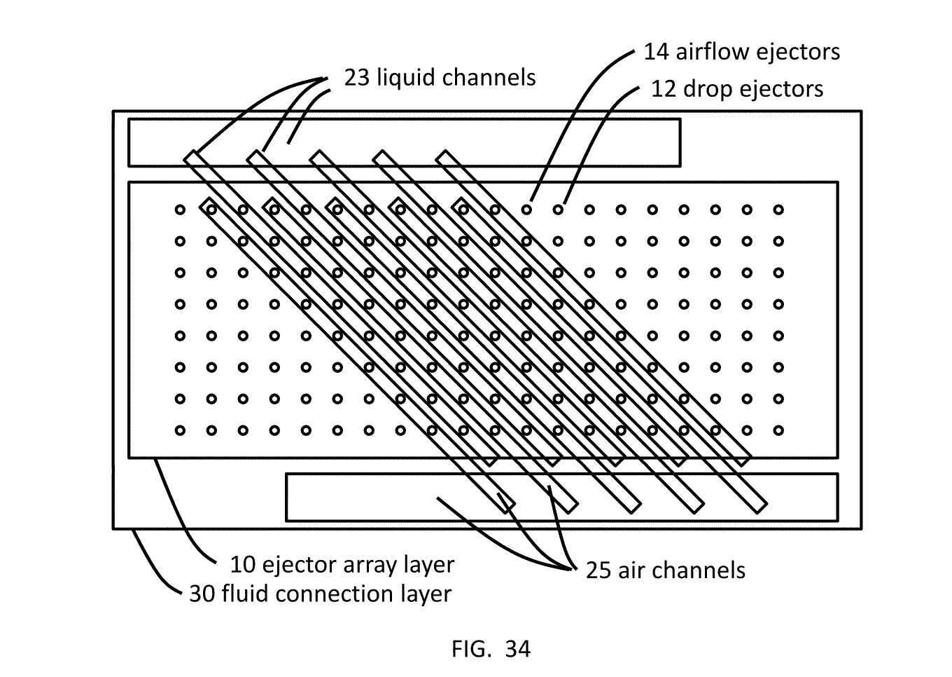

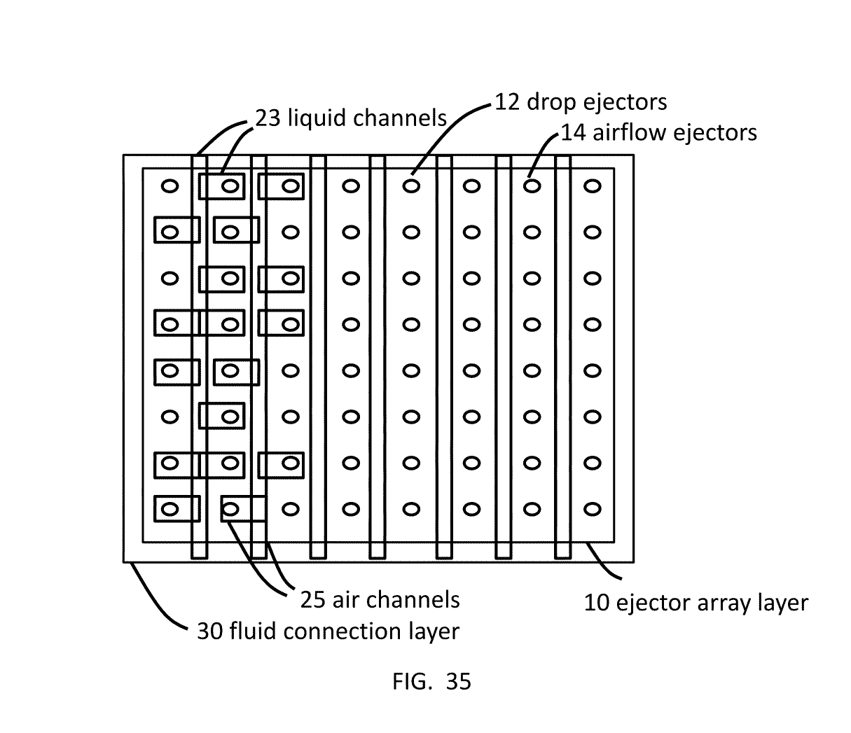

FIGS. 34 and 35 show possible connection means for substantially two-dimensional arrays for connecting the liquid drop ejectors to liquid-containing channels 23 and for connecting the airflow drop ejectors to air containing channels 25, as would be well known in the art of microfluidic fabrication. In general, air and liquid channels act as ducts or plenums to carry air or liquid to a specific row or rows of drop ejectors. The air and liquid channels can be aggregated into a larger plenum at the top and bottom of the printhead in FIGS. 34 and 35 which can be pressured by an external source of air or fluid, or each air and liquid channel can be separately supplied, possibly at different pressures, if it is desired to vary the airflow or liquid flow rate along the length of the printhead (direction of receiver motion), as will be discussed. FIG. 34 shows an arrangement of liquid channels 23 and air channels 25 etched into fluid connection layers 30 that is appropriate for the configurations of interspersed airflow and liquid drop ejectors shown in FIG. 31. FIG. 35 shows an arrangement of liquid channels 23 and air channels 25 etched into fluid connection layers 30 that is appropriate for the configurations of interspersed airflow and liquid drop ejectors shown in FIG. 33. Many interspersed configurations and supply channels are possible, using fabrication processes that are commonly known and practiced by those skilled in microfabrication of fluidic devices, including inkjet devices.

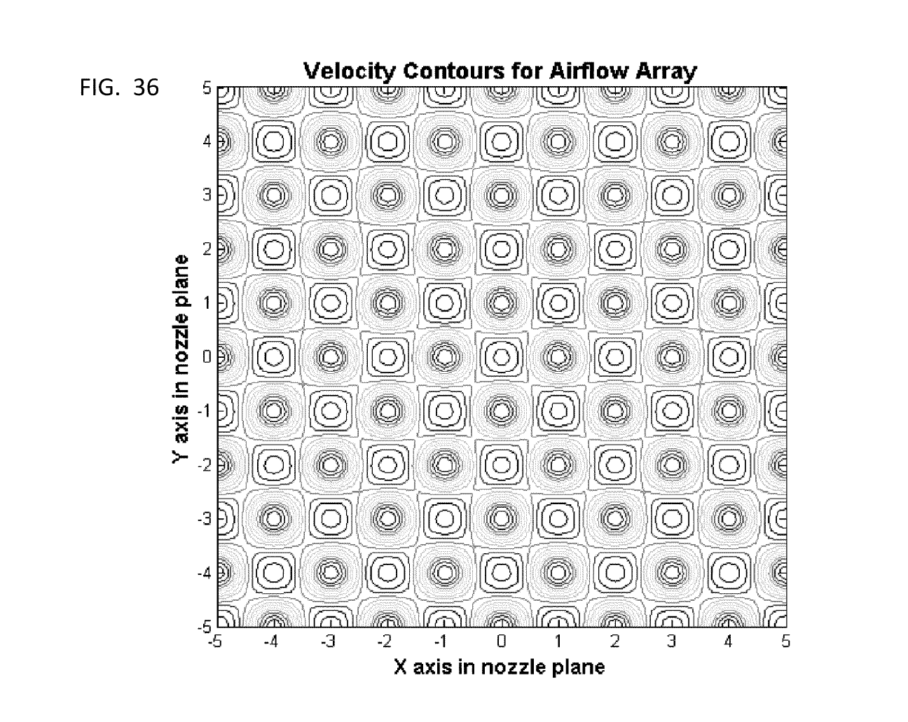

FIG. 36 shows velocity contours similar to those of FIG. 21 but for a substantially two-dimensional array having 1000 ejectors in both directions, of the vertical component of airflow in a substantially two-dimensional array of drop ejectors interspersed symmetrically with a substantially two-dimensional array of disperse airflow ejectors, as measured a distance above the plane of the drop ejector array equal to the spacing between adjacent airflow and drop ejectors. A drop ejector is located at (0,0), (1,1), etc. An airflow ejector is located at (0,1), (1,0) etc. The peaks in airflow correspond to the locations of the airflow ejectors. The vertical velocities above the x-y plane are plotted as velocity contours, the contours directly above the ejectors corresponding to velocities of 16 m/s, the assumed initial velocity of the ejected drops. All distances are given in units equal to the distance between adjacent airflow and drop ejectors. The contours around the drop ejectors are approximately rectangles with rounded corners extending toward the saddle points between airflow ejectors, as can be appreciated by one skilled in airflow modeling. Because the number of airflow ejectors is large, the vertical airflow does not fall off away from any one drop ejector, except at the very edges of the substantially two-dimensional array. The particular value of vertical velocity above each drop ejector derives from all airflows from all ejectors. Quantitative modeling is required to determine the airflow velocities for each ejector individually in order that the sum of all the airflows matches the assumed drop velocity far from the ejector array top surface. The velocity contours in FIG. 36 have been calculated with airflow models to illustrate quantitatively how the symmetry of the location of airflow sources mirrors the symmetry of the velocity contours surrounding each ejected drop.

As expected, the surface profile is much more uniform in the xy plane (plane of the drop ejectors) when a large array of airflow sources is included, rather than only four airflow sources as in FIG. 21. At distances above the plane of the drop ejector array that are several times the spacing between adjacent airflow and drop ejectors, the surface profile uniformity further increases, reflecting the intuitive fact that far from the plane of the drop ejector array, the air flow is essentially a uniform “wall′ of” airflow. Of course, the uniform ‘wall’ of airflow has the same air flux as the non-uniform flux of airflow averaged over the many ejectors near the plane of the drop ejector array, as is well known in fluid dynamics, due to conservation of mass. In FIG. 36, the contour peaks corresponding to the location of the airflow sources surrounding the drop ejectors are shown, reflecting the large number of airflow sources, vs. the case of FIG. 21. The contours around the drop ejectors are approximately rectangles with rounded corners extending toward the saddle points between airflow sources. As in the case discussed in association with FIG. 21, the velocity of airflow along the drop trajectories increases and saturates with distance above the array. The match of velocities with the initial ejected drop velocity is better near the ejector array top surface for lesser degrees of collimation of the airflow sources. The saturation velocity in all cases is easily adjusted by controlling the air pressure in the airflow sources.

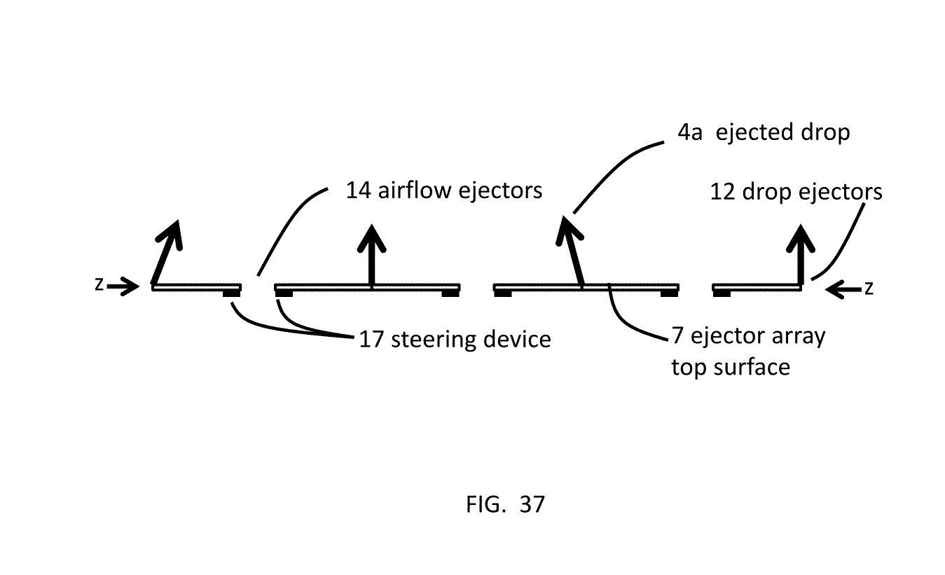

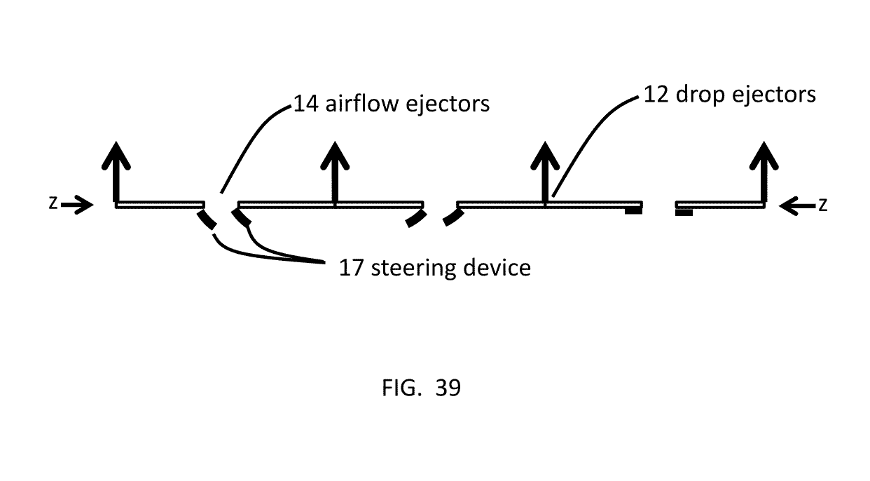

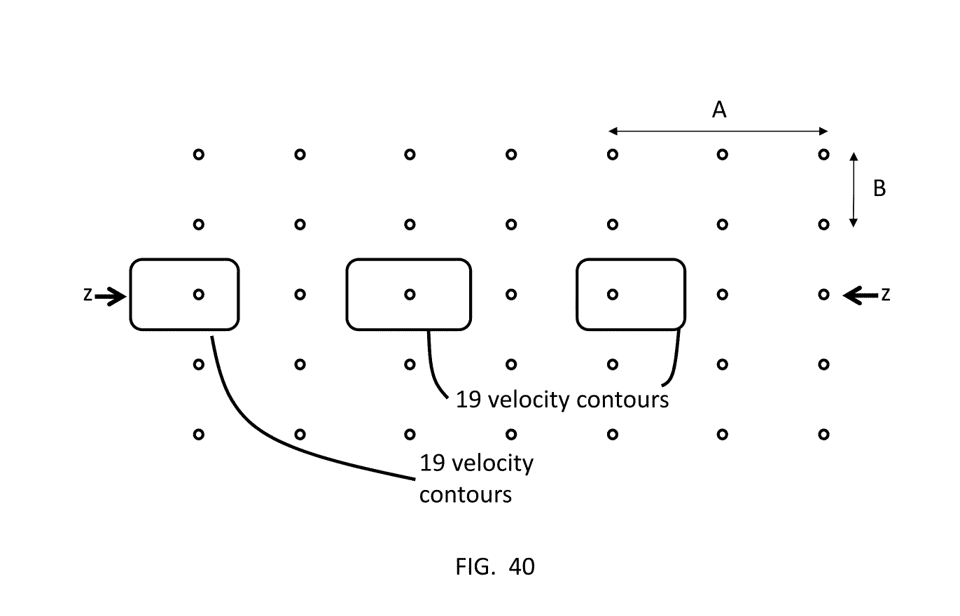

Many principals of the use of airflow ejectors in accordance with the present invention carry over from linear arrays to substantially two-dimensional arrays, as illustrated in FIGS. 37 and 38, which show airflow ejectors 14 having steering devices 17 for controllably steering airflows at each airflow ejector with a controller (not shown) similar in concept to the airflow ejector shown as an angled airflow ejector in the linear array of FIG. 17 but here for a substantially two-dimensional array of interspersed drop and airflow ejectors. In FIGS. 37 and 38 the steering devices 17, which could, for example comprise piezo thin films that can move with electrical stimulation, as is well known in the art of micro-device fabrication, are shown in a non-activated position in which the airflow through the airflow ejectors 14 is perpendicular to the plane of the ejector array top surface. This results in airflow velocity contours 19 in FIG. 38 which are symmetrically centered over the drop ejectors 12, similar to the velocity contours of FIG. 36. However, additionally in FIGS. 37 and 38, two drop ejectors 12 are shown to be misdirected, which could for example be the result of the accumulation of debris on the ejector array top surface or to a fabrication error. The utility of steering devices 17 is illustrated in FIGS. 39 and 40 in which two of the airflow steering devices 17 have been activated, for example by electrical stimulation, to guide the airflow in the vicinity of the misdirected drop ejectors so as to cause the misdirected drops to more nearly lie along their desired trajectories, in this case perpendicular to the plane of the ejector array top surface. Not only can the airflow ejectors assist drops in traveling towards the receiver by reducing air drag, they can, in combination with steering devices 17, correct for drop placement errors. As is well known in the art of drop control, additional equipment, not shown can be used to assess drop placement and to provide feedback to controllers, not shown, to adjust the steering devices 17 to achieved improved drop placement. Such adjustment is useful in both substantially linear arrays as well as substantially two-dimensional arrays of interspersed drop and airflow ejectors.

As noted previously, while many principles of the use of airflow ejectors carry over from linear arrays to substantially two-dimensional arrays, there are substantial differences that make operation much more difficult for two-dimensional arrays in accordance with the present invention. These differences arise from two effects, both of which are exacerbated by the stated objectives of high print productivity and high image quality, which require the use of a large number of drop ejectors each ejecting very small drops of printing ink. The first effect, described in reference to FIGS. 27 and 28, is the large amount of shear force drag on the ambient air caused by the rapid movement of the receiver underneath a printhead of substantial width (direction of receiver motion), as is well known in the art of fluid dynamics. As noted in the discussion of FIGS. 27 and 28, this shear drag pumps air into the region between the receiver and printhead, and the resulting air velocity flows in the direction of receiver motion, causing the ejected drops to be displaced horizontally out of the print region. The amount of air flow in the receiver direction close to the printhead increases with distance from the receiver entrance side of the printhead, perturbing the ejected drops in substantially two-dimensional arrays to a greater extent than in substantially one-dimensional arrays due to the difference in printhead width compared to printhead to receiver separation. For comparison, in the case of FIG. 25, the rapid horizontal airflow left to right caused by the receiver motion alone did not prevent drops from landing on the receiver. Receiver induced drag of ambient air is minimized in a linear geometry, where the printhead can be made small in the direction of receiver motion, as can be appreciated from fluid modeling.

The second effect that makes operation much more difficult for two-dimensional arrays having air ejectors is due to the large flux of air ejected between the printhead and the receiver which increases with the width (direction of receiver motion) of the ejector array. As opposed to the case of a linear array, it is more difficult for ejected air to escape, as schematically illustrated in FIG. 16, and it must do so by flowing horizontally, both left and right, accumulating over the entire printhead width containing the air ejectors. The larger the array size, the greater the amount of horizontal airflow left and right in FIG. 16.

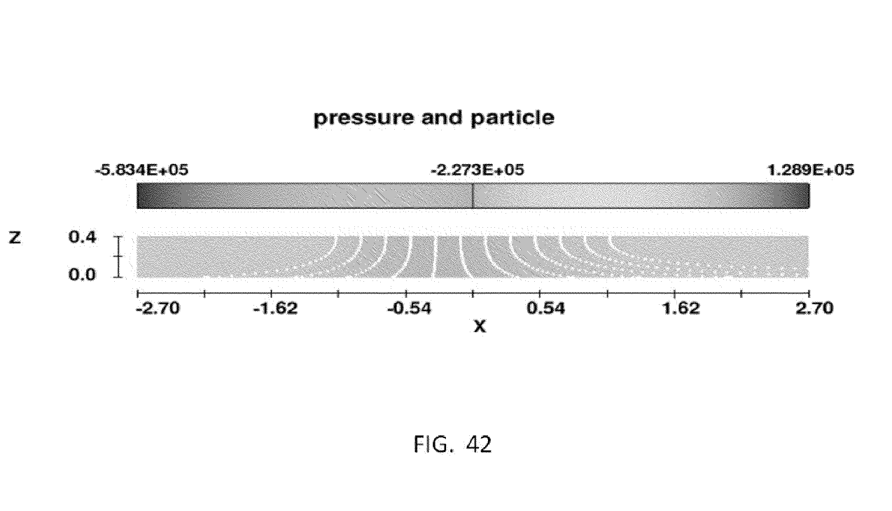

The use of airflow ejectors to compensate for air drag on ejected drops, which was a successful strategy for increasing image quality and throw distance in the linear array of FIGS. 23 and 24, fails generally for two-dimensional arrays for two distinct reasons: greater receiver induced horizontal air drag and greater accumulation of vertically ejected air flowing between the printhead and the receiver. The combination of these two airflow effects is not linear, as is well known in fluid dynamics, and restricts the ability to use vertically injected airflow in substantially two-dimensional arrays to increase image quality and throw distance. For example, this failure is illustrated in the computational simulations shown in FIG. 42 which is a quantitative example of the schematic airflow of FIG. 16 A, corresponding to the arrangement of airflow ejectors shown in FIG. 31. Here, the ability to print with substantially two-dimensional arrays is quantified by modeling the trajectories of drops as they are ejected from the drop ejectors, travel across the region between the printhead and the receiver, and land on (are printed on) the receiver. In this example, in which the length of the drop ejector array is about 11 cm and the average velocity of airflow (that is the areal average velocity in a plane parallel to the drop ejector array top surface) from the ejectors is chosen to equal the value of the initial drop velocities (a successful strategy in the case of a substantially one-dimensional linear array). However, as can be seen from FIG. 42, most of the drops are ejected from the region between the printhead and the receiver due to accumulation of vertically ejected air and thus fail to be printed on the receiver. Shear induced airflow due to the motion of the receiver also contributes to drop ejection, but does so asymmetrically: shear flow contributes to drop ejection on the right side of FIG. 42 but suppresses drop ejection on the left side. This asymmetry complicates system operation; airflow ejectors must overcome enhanced shear flow in two-dimensional arrays.

The example of FIG. 42, illustrating how the effects of receiver induced air drag and excessive accumulation of ejected air limit the ability to print with substantially two-dimensional arrays, would seem to indicate that the use of airflow to increase the ability to print at large separations between printhead and receiver for substantially two-dimensional arrays of drop ejectors fails in comparison to the success found in the case of substantially linear arrays. However, as will be discussed, we have found preferred parameters of operation for which high quality printing can be enabled by vertically injected airflow. These parameters can be obtained from careful modeling of the interaction of ejected drops with the airflow in the region between the printhead and the receiver, even for very rapid receiver velocities and very large printheads. Before discussing these preferred parameters of operation, a method is first established to quantitatively model the pattern of printed drops in order to characterize print quality, as described below.

The position of each printed drop on the receiver (print position) depends on the drop firing time, the shape of the drop trajectory, and the transit time of the drop as it travels from the drop ejector to the receiver. Drop firing times can be accurately controlled, as is well known in the art of ink jet printing, by electronic circuitry. Drop trajectory shape is determined for each drop by the airflow forces on the drop perpendicular to its trajectory, which bends the trajectory from an otherwise straight line. Drop travel time to the receiver (transit time), depends on the initial drop velocity, the length of the trajectory, and the amount by which the drop velocity is altered by air drag forces parallel to the drop trajectory during the transit time. To quantitatively characterize printing systems comprising substantially two-dimensional arrays of drop ejectors, it is found useful to compare the spatial pattern of drop ejectors to the spatial pattern of drop print positions. As a reference, one can consider the pattern of drop print positions made by an “ideal” or “standard” case in which drops act like “bullets,” traveling extremely fast, or, equivalently in a hypothetical extreme limit, were represented by laser pulses capable of printing by burning or punching holes in the receiver. In this “ideal” or “standard” case, the trajectories would not be disturbed by airflow, the transit times would be essentially zero, and the pattern of printed drops would be the same as the pattern of drop ejectors, assuming all drop ejectors fire simultaneously. Moreover, the drop print pattern would occur exactly below the drop ejector pattern. Thereby, the concept of an “ideal” or “standard” case provides a simple reference point to quantitatively compare the patterns of real and ideal drops by defining the difference in position of a laser drop coming from an ejector in the center of the array to a real, printed drops coming from an ejector in the center of the array to be zero.

For real drops, especially small drops travelling in high airflow regions and landing on a rapidly moving receiver, the drop print pattern will differ from the pattern of the drop ejectors. While it is obvious that bending of the trajectory by airflow alters the print position, the effect of transit time on print position is less intuitive. It is a very large effect for high speed printer because the receiver is moving rapidly, for example 1000-5000 ft/m. The longer the transit time, the more the receiver moves before the drop lands on it, and if two drops have different transit times, they will appear to be displaced differently when printed. The effect of the shape of the drop trajectories on drop print positions and the effect of transit times on drop print position are each large compared to typical drop ejector spacings (10 microns to 1 mm) and also to the drop accuracy required (1-100 microns) for high image quality and the two terms can have opposite signs for different drop ejectors. Therefore, a complete model is required to predict the sum of both effects and thus to understand how the pattern of drop ejectors on a particular drop ejector array is imaged onto or represented by the pattern of printed drops on the receiver.

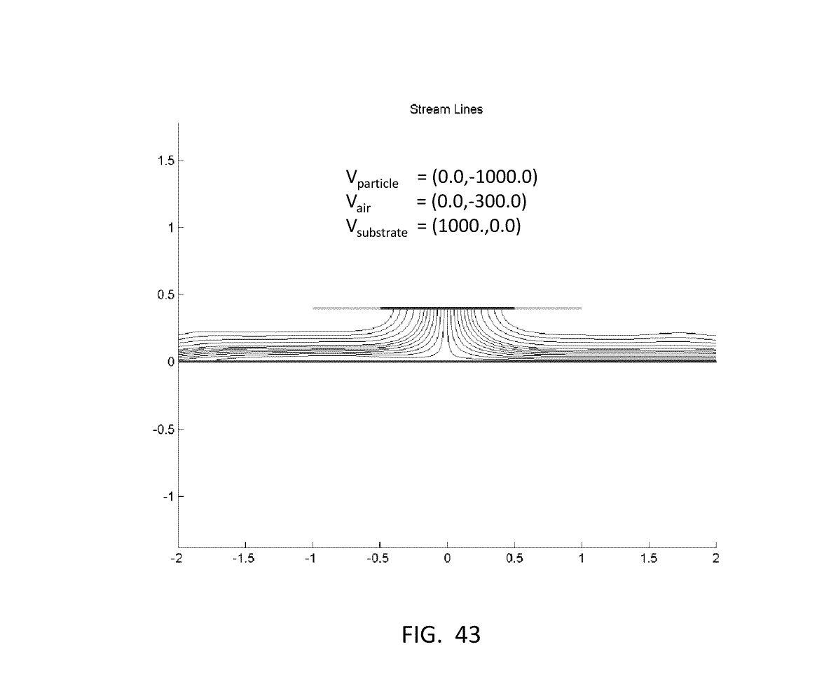

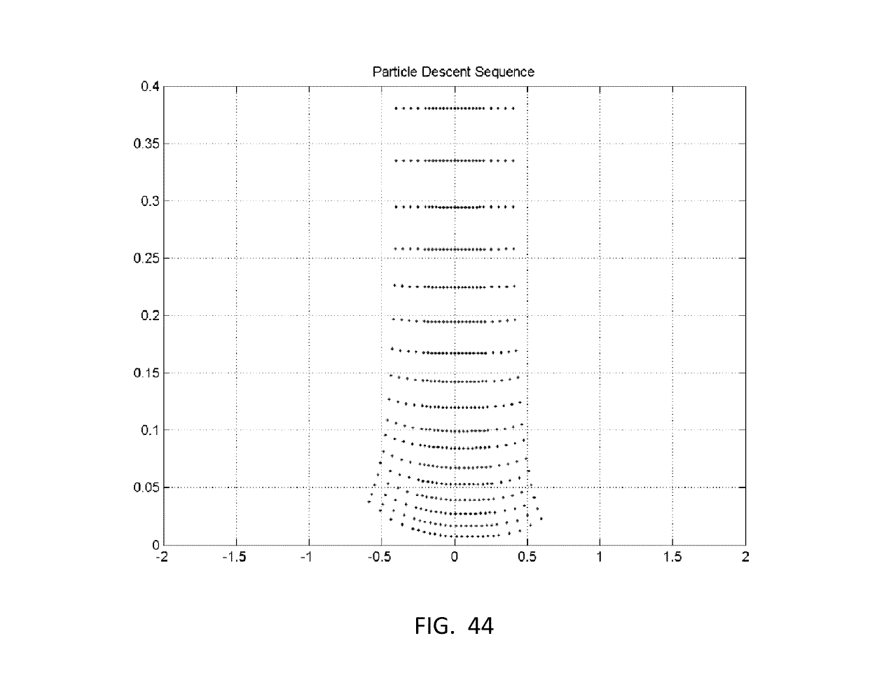

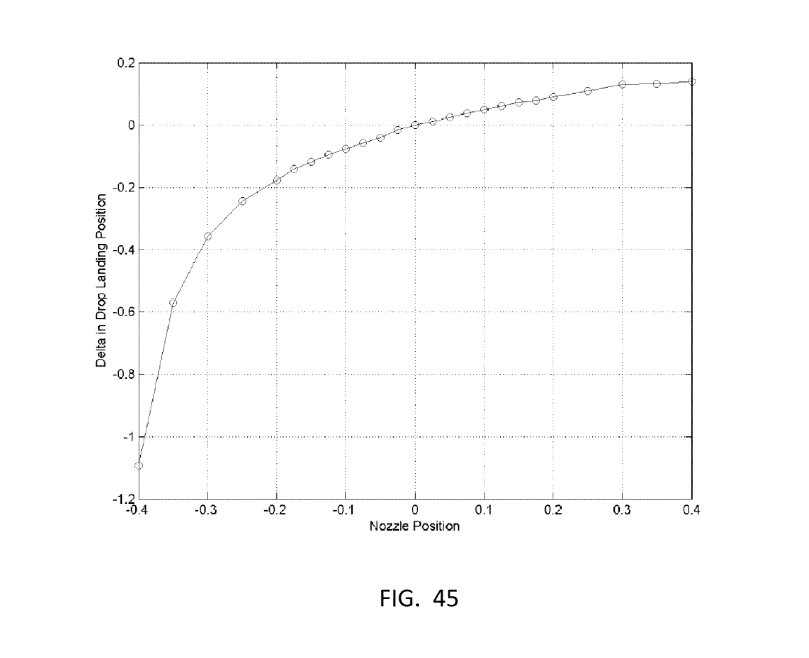

FIGS. 43 and 44 illustrate a first preferred embodiment which solves the problem of drop expulsion from the print zone in extended array FIG. 42 while still providing a high speed, high quality printing system configured with a printhead to receiver spacing of 4 mm, achieved by confining the airflow to a constrained central region of the printhead, of length 1.0 cm, centered on a constrained drop ejector region, of slightly less length, 0.8 cm, and restricting the airflow velocity (300 m/s) to 30% that of the velocity (1000 m/s) of the ejected drops. The airflow is provided in accordance with FIGS. 9 and 10, dispersed uniformly about the drop ejectors, and engages the drops within a very short distance from the plane of the ejector array. Despite the large degree of airflow horizontally shown in FIG. 43, all drops from the section of drop ejectors under these restrictive conditions, strike the receiver at know locations under the printhead. The drop trajectories are shown in FIG. 44 and the drop print positions in FIG. 45, for the case of drops released simultaneously at all drop ejector locations. The trajectories are spread out over a length (1.2 cm) only slightly larger than that (1.0 cm) of the airflow region. Although drops at the extreme left and right of the drop ejector array take more time to travel to the receiver, this effect can be compensated by launching these “slower” drops at earlier times, namely at times earlier than the “fastest” drop by the difference in drop transit times relative to the fastest drop. It important for this result that the drops do not interact with one another during transit, otherwise the time compensation algorithm would be complex and image dependent. The drops do not interact significantly for the cases shown in FIGS. 43-46, because the spacing between drop ejectors is greater than about 40 microns.

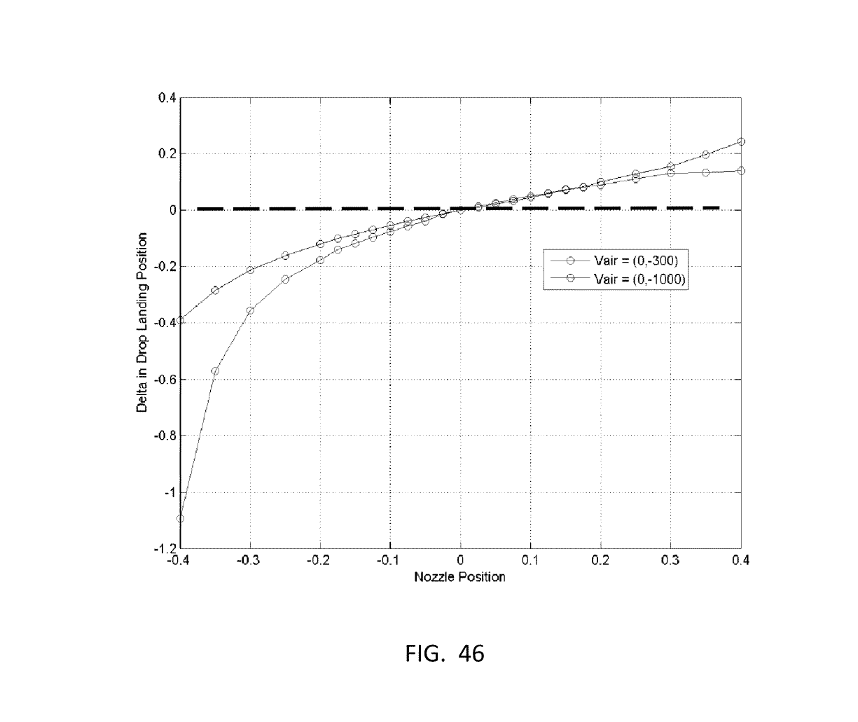

In FIG. 46, the print drop positions relative to the “ideal” or “standard” positions for print drops (discussed above) are shown for three cases, each having drop ejectors spaced equally apart on a “regular” grid and launched simultaneously. The upper and lower (along the y axis) curved lines correspond to uniform airflow velocities of 300 and 1000 cm/s respectively. The larger spread in print drop positions relative to their “ideal” positions is associated with the larger airflow velocity. As would be anticipated from FIG. 44, the drop positions for the larger airflow velocity show in the lower curve of FIG. 46 are spread out over a length of more than one cm greater than the length of the ejector array (0.8 cm). The drop positions shown in the upper curve of FIG. 46, corresponding to the lower airflow velocity, are spread out over a length of about 0.6 cm greater than the length of the ejector array. In both cases, the original spatial pattern of drop ejectors in the drop ejector array can be said to be imaged onto a new spatial pattern of printed drops on the receiver which is different from the original spatial pattern of the ejectors.

The straight, dashed line in FIG. 46, which shows no additional spread of the array of printed drop positions compared to their ideal positions, corresponds to launching the “slower” drops at earlier times, namely at times earlier than the “fastest” drop by the difference in drop transit times relative to the fastest drop. The pattern of printed drops so formed is thus identical to the pattern of drop ejectors, in this case a regular grid. Alternatively stated, the positions of the printed drops form an identical image of the positions of the drop ejectors. The timing differences for launching different drops in order the positions of the printed drops identically image the positions of the drop ejectors depends on the speed of the media, the ejected airflow between the printhead and the receiver, the spacing between the printhead and the media, and the drop sizes and velocities, all of which can be measured or calculated and adjusted during printing operations.

In some cases it is beneficial that the original spatial pattern of drop ejectors in the drop ejector array be altered from the pattern of a regular grid in order that the pattern of printed drops is a desired pattern, preferably a regular grid. Generally, a regular grid pattern of printed drops is well known to be desirable for high image quality, and the present invention using airflow ejectors contemplates a means other than establishing timing differences between drops launched from different locations to achieve a desired pattern of printed drops. In this embodiment, the spatial array of drop and airflow ejectors is designed to be altered or stretched in comparison to a regular grid, principally along the direction of motion of the media, so that even without timing differences between drops launched from different locations the printed drops are printed in a desired pattern, preferably a regular grid. As can be appreciated by one skilled in numerical modeling, the design of the desired spatial pattern of drop and airflow ejectors can be determined in many ways, including refining a trial pattern of drop and airflow ejectors based on calculating resulting patterns of printed drops. The spatial pattern of drop and airflow ejectors required to produce a desired pattern of print drops depends on the speed of the media, the ejected airflow between the printhead and the receiver, the spacing between the printhead and the media, and the drop sizes and velocities, all of which can be measured or calculated and adjusted during printing operations. The role of ejected airflow in causing the spatial pattern of the drop ejectors to be imaged onto a desired pattern the printed drops is analogous to the role of a lens in imaging a source pattern of light onto a viewing screen with magnifications and distortions determined by the lens shape.

It should be noted that the desired pattern of drop and airflow ejectors preferably differs slightly near the edges of the printhead compared to the pattern in the central portion of the printhead due to well known airflow edge effects associated with Bernouille pressure differences at the printhead edges, as can be appreciated from fluid dynamics. The straight, dashed line in FIG. 46, which shows no additional spread of the array of printed drop positions compared to their ideal positions, corresponds to a particular choice of the spatial pattern of drop ejectors chosen to form a pattern of printed drops which is a regular grid, a result essentially identical to that discussed previously in association with the use of timing differences for launching different drops. It is further contemplated that a combination of timing differences for launching different drops in conjunction with a choice of the spatial pattern of the drop ejectors can be used to provide a desired print drop pattern.

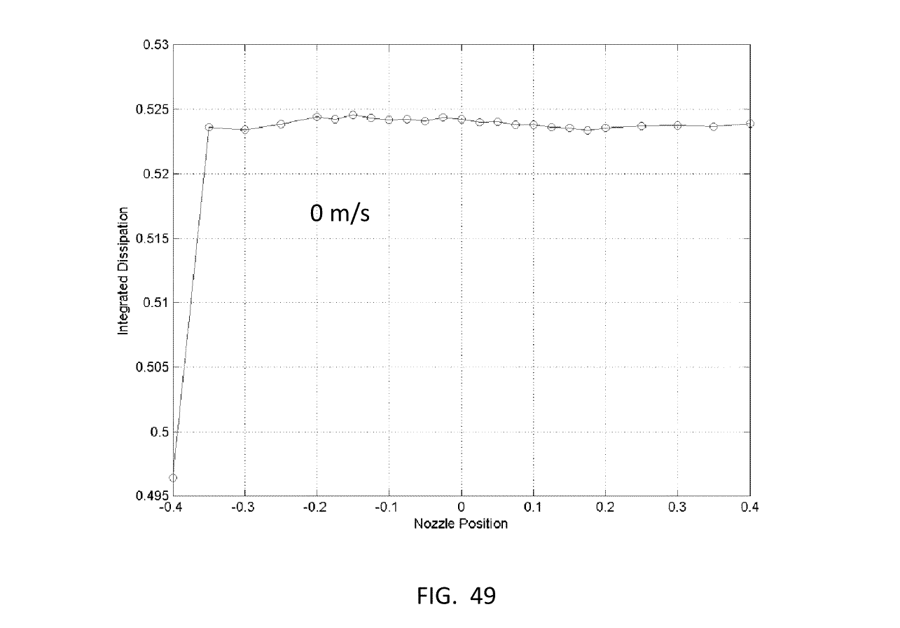

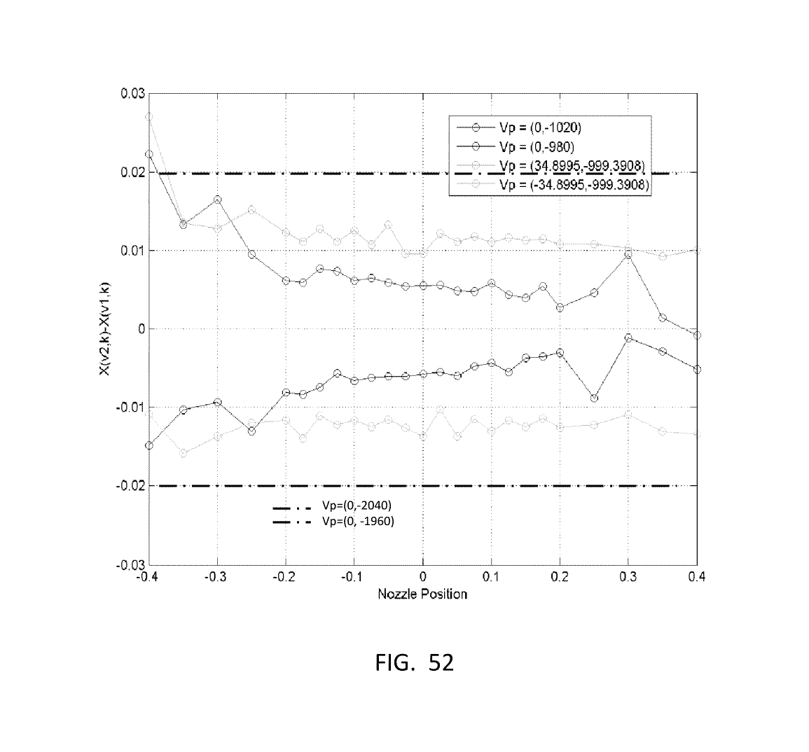

Other desirable features of printing using these airflow parameters in the substantially two-dimensional drop ejector array will be discussed in relation to FIGS. 49-51, which characterize other important system performance parameters such as the sensitivity of printed drop positions to drop velocity variations and drop directionality fluctuations. Another important performance attribute of the present invention using these airflow parameters will be discussed in relation to FIGS. 52-54, which characterizes the reduction, due to vertical airflow, of the energy dissipation each drop experiences due to air drag. These performance attributes ensure not only that the drops reach the receiver but that the resulting printed images in practical systems, in which drops are imperfectly released and in which airflow may fluctuate slightly in time, are still of high quality, as will be described.

It should be noted that the drop velocities in FIGS. 43-45 have not been increased from those in FIG. 42, although in principal the problem of drops not reaching the receiver could be solved in this way for substantially two-dimensional arrays as in the case for the substantially linear array shown in FIG. 29, in which the drop velocities were increased to 1400 cm/s so that the drops reach the receiver. (This would be a step toward an ideal drop ejector of the “bullet” or “laser pulse” type discussed above.) However, arbitrarily high drop velocities are very difficult to achieve experimentally, and real drops in substantially two-dimensional arrays, having very high velocities with respect to the air through which they travel, interact with one another, especially when they are in close spatial proximity, as is well known in fluid dynamics. Thus in most optimized systems, the drop velocity has already been made as large as practical and further increases are not possible.

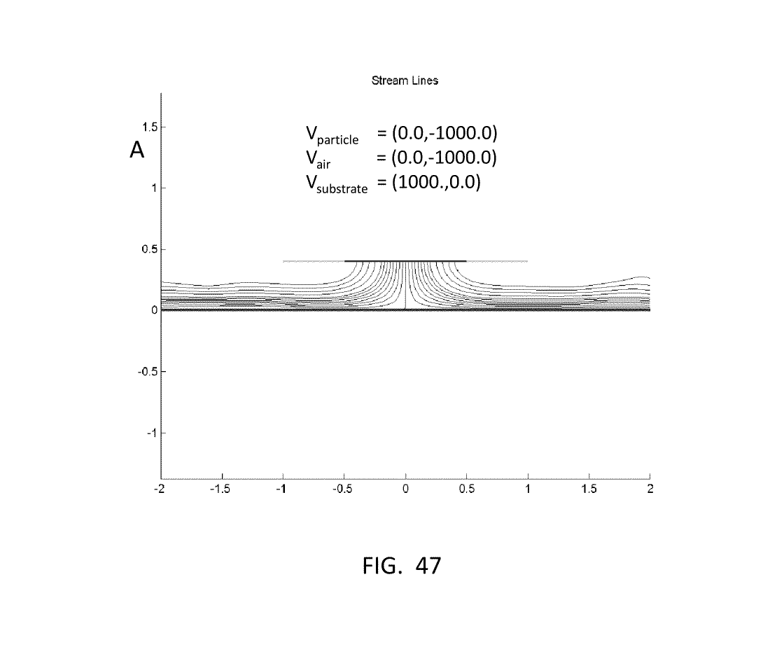

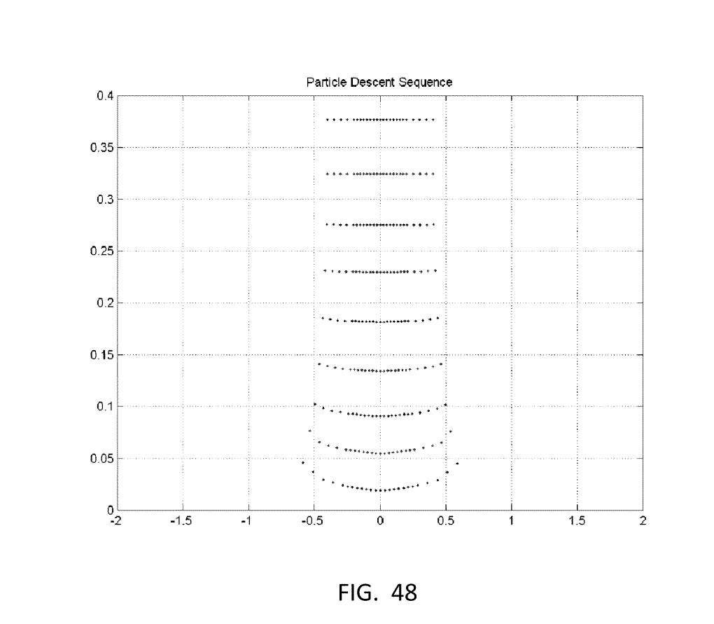

FIGS. 47 and 48 illustrate a second preferred embodiment which solves the problem of drop expulsion from the print zone in extended array FIG. 42 while still providing a high speed, high quality printing system configured with a printhead to receiver spacing of 4 mm, achieved by confining the airflow to a constrained central region of length 1.0 cm, centered on a constrained drop ejector region, of length of 0.8 cm, as in FIGS. 43-45, but additionally providing that the airflow velocity (1000 m/s) match the velocity (1000 m/s) of the ejected drops very near the drop ejectors. As in the case of FIGS. 43-46, all ejected drops strike the receiver at known locations under the printhead, spread out over a length approximately that (1.0 cm) of the airflow region, and can be placed at regular intervals by altering the timing of drop ejection to account for differences in transit times (FIG. 48). Thus the primary benefit of airflow ejectors, per the embodiments such as those discussed in relation to FIGS. 43-48, is to increase the drop throw range compared to the base case, so that drops assisted by airflow reach the receiver and can be printed or can be printed at even greater printhead to receiver spacings.

Airflow ejectors also provide a more subtle but very important advantage for high image quality printing, namely a reduction in the energy dissipation experienced by the ejected drops as they travel to the receiver. For example, in comparison with the strategy discussed in association with FIGS. 29 and 30 in which drop velocity is increased until the drops reach the receiver and are printed but no air ejectors are provided, the embodiments of both FIGS. 47, 48 and FIGS. 43-46 reduce the average dissipation of drop energies due to air drag. In particular, the embodiment of FIGS. 47 and 48 provides very small average values of dissipation of drop energies due to air drag, because of the better velocity match between airflow and drops as they are initially ejected. The embodiment of FIGS. 47 and 48 also allow for an even larger printhead to receive spacing, because of the better velocity match between airflow and drops as they are initially ejected.

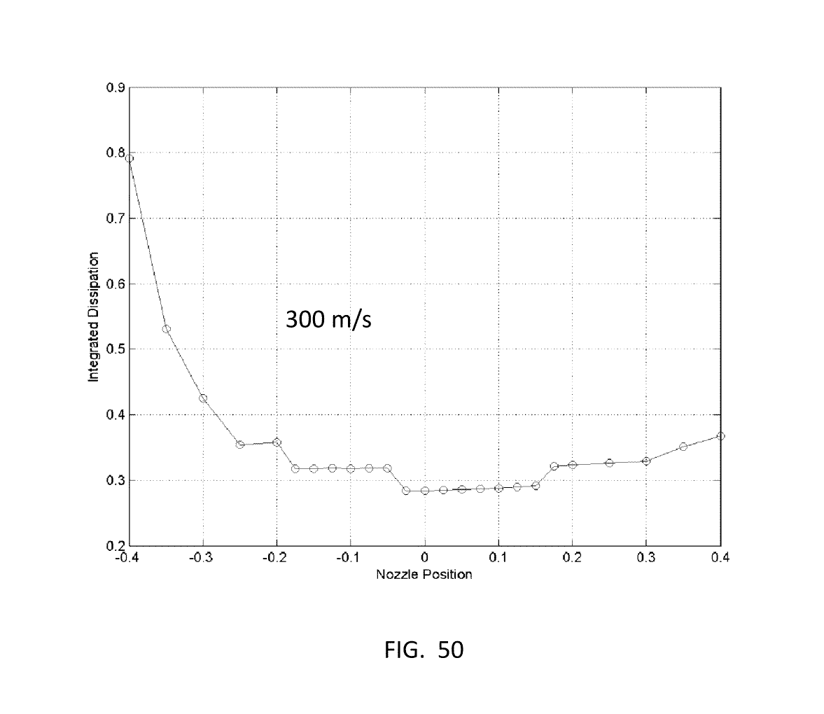

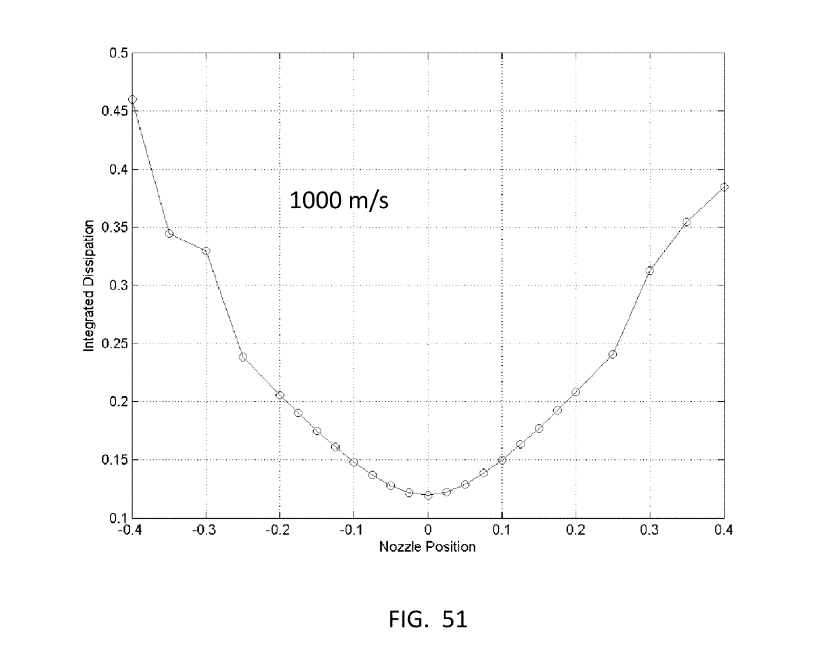

The time integrated energy of dissipation experienced by different drops ejected from different locations along the width of the printhead (along the direction of receiver motion) as they travel to the receiver is plotted in FIGS. 49, 50, and 51. In FIG. 49, the drop velocity has been increased to 2000 cm/s, which, as noted, is generally difficult, especially for DOD drop ejectors and which, even if possible, degrades image quality. While all the drops reach the receiver, the energy dissipated is greater than 0.52 nJ per drop. In contrast, the print systems of FIGS. 50 and 51, which keep the drop velocity at a more realistic 1000 cm/s but add two different levels of airflow ejection, show that the energy dissipation experienced by the drops, particularly in the central region of the printhead, is about or less than half the value of dissipation shown for the print system of FIG. 49. High energy dissipation, especially as drops are ejected and form near the drop ejectors, generally degrades image quality, as is well known in the art of inkjet printing, by perturbing the drop formation process as the drop is being ejected from the drop ejector, by altering drop break up and satellite formation, by distorting the drop shape as it experiences drag, by increasing drop to drop interactions as transmitted through the air, and by introducing noise components in the drop trajectory and the airflow velocity field.

The embodiments of FIGS. 17 and 18, in addition to reducing energy dissipation of drops and ensuring that all drops reach the receiver, additionally provides that all ejected drops are placed with sufficient accuracy so that the printed images are still of high quality in practical systems. These considerations would not be necessary except for the fact that in practical systems, drops are imperfectly released and airflows fluctuate slightly in time. It is surprising that accurate placement is achieved, because the airflow introduced from two-dimensional arrays of airflow injectors causes the drop trajectories to depart from straight lines and therefore imparts horizontal velocity components to the drops. Generally, the placement of drops having horizontal velocity components would be expected to be more sensitive to the random fluctuations in drop mass, velocity, and directionality that occur in practical systems, because the drop trajectories are complex functions of initial conditions. Just as in the case of a bullet fired with a horizontal velocity component, the landing site depends more sensitively on the initial conditions of launch, than for the case of a bullet fired straight down, which is minimally sensitive to initial conditions. However, we find that for a wide range of ejector locations, for example most locations shown in the embodiments of FIGS. 17 and 18, the sensitivity to random variations in drop launch angles and drop velocities is low. By low, we mean small compared to the appealing (but in practice impossible to implement) solution of simply increasing the velocity of the drops or the mass of the drops to arbitrary, hypothetically high values. If it were possible to do this without other consequences, the hypothetical solution would comprise an ideal method of arbitrarily improving throw distance and image quality. However, as per previous discussion, the base case assumes the velocity of drop ejection has already been chosen as large as is practically possible. (Moreover, although increasing the mass of the drops by increasing the density of the ink would equally provide a seemingly ideal hypothetical solution, printed ink is typically of aqueous density or less.) Thus the hypothetical al solution is more useful as a benchmark for image quality than as a practical system design tool.

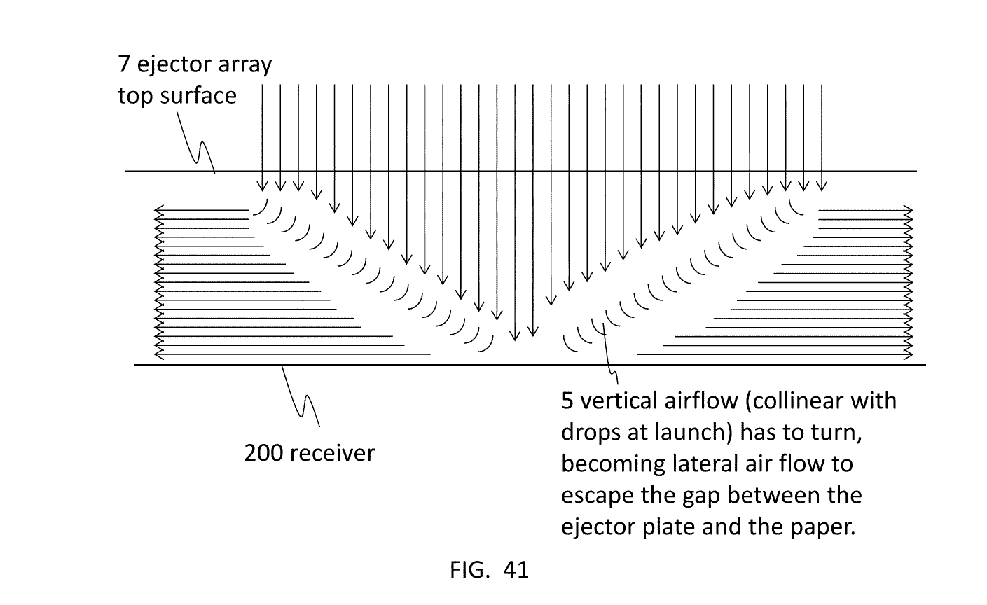

As seen in FIG. 52, the sensitivity to random variations in drop launch angles and to random variations in drop velocities is no more than the sensitivity of the hypothetical case of drops launched at higher velocities (so that all drops reach the receiver) but with no airflow injection. This is shown in the model calculations of FIG. 52, which plots the positional variation of drop landing positions realistic values for random variations of velocity (+−2% random variations) and angle of ejection (+−2 degree random variation). The dashed horizontal lines correspond to the case of no airflow but for “hypothetical” drop velocities of 2000 cm/s. The open circles correspond to drop velocities of 1000 cm/s and matched average airflow velocities. The asymmetries about the central drop ejector position correspond physically to the fact that that the horizontal component of injected airflow (FIG. 41) is asymmetric with respect to receiver motion and also to the fact that shear drag of air on the receiver is position dependent. Remarkably, the sensitivity to fluctuations in velocity direction and velocity magnitude are seen in FIG. 52 to be generally less the sensitivity of drops launched at higher velocities to such fluctuations. As discussed previously, increasing drop velocities from the base case of drops just reaching the receiver (hypothetical drop velocity increase) is always an attractive means of maximizing throw distance, but it is a strategy very difficult to implement without increasing the magnitude of fluctuations in drop ejection parameters or decreasing drop firing frequency, as is well known in the inkjet printing art. The term “hypothetical” increase refers to the fact that since the base case is by definition one which has already maximized drop ejection velocities, a further increase is not practically compatible with high quality image printing.)

Because the sensitivity to random variations in drop launch angles and to random variations in drop velocities is no more than the sensitivity of the hypothetical case of drops launched at higher velocities with no airflow injection for interspersed drop and airflow ejectors, the present invention affords a practical means of increasing the throw distance for substantially two-dimensional arrays printing very small drops. In particular, we find the airflow ejectors of the present invention allow for printers in which the spacing between the common substrate and the media is greater than 3 mm, the velocity of the media exceeds 600 ft per minute, and the volume of the ejected drops is less than 2 pL. These characteristics are highly desirable for rapidly printing high quality images, especially for drop ejectors whose maximum frequency is less than 100 kHz, since many such ejectors are required for rapid printing and hence a large (substantially two-dimensional) printhead is required to achieve a large total number of ejectors. Considering that a typical prior art spacing from the printhead to the media is 1-2 mm for ejectors ejecting very small drops, the width of a substantially two-dimensional printhead (measured in the direction of receiver motion) would be many times (for example 5-100 times) the spacing between the printhead and the receiver. This means that airflow between the printhead and the media must be controlled carefully by airflow ejectors and airflow retractors (to be discussed) because shear induced flow from a rapidly moving receiver extends to the printhead. Expulsion of drops is exacerbated in the case of a substantially two-dimensional array by high speed receiver motion.

Alternatively stated in terms of the number of ejectors per inch for a single color printhead, a substantially two-dimensional printhead capable of printing high quality images very rapidly is envisioned to comprise, in two extreme cases, about 25 to about 500 ejectors aligned in a row perpendicular to the receiver motion; and, in each of these above two extreme cases, respectively, about 200 to about 400 and about 10 to about 40 ejector rows distributed in the direction of receiver motion. The average spacing between ejectors is here envisioned to lie in the range of from 50 microns to 1000 microns, so that the width of the printhead is much larger than the spacing between the printhead and the media. The large size of the two-dimensional printheads of FIGS. 41 and 42 can also be distinguished based on the fact that the ejected airflow moves drops both toward and away from the direction of receiver motion. The airflow is so large as to map the image of the drop ejectors into a substantially different printed image, with some rows advanced and some rows retarded. Without airflow ejectors, the receiver must be exceptionally close to the printhead if the drops are small, as required for high image quality. Manufactures move the receiver sufficiently close to the printhead, typically 1-2 mm, for drops to successfully land with accuracy sufficient to meet image quality requirements. This is a problem for printing on rapidly moving receivers having topography, such as corrugated materials, for which spacings of 4 or more mm are desirable to prevent receiver-printhead contact. If the receiver-printhead spacing is adjusted, as is usually the case, so as to just enable drops to land on the receiver with no airflow, the use of airflow allows the drops to land more accurately, as discussed in association with FIGS. 43 and 47 as well as to allow a longer throw distance. The benefits of airflow ejection are actually much greater than they would appear to be from an analysis of FIGS. 43 and 47. Airflow patterns are illustrated in FIGS. 43 and 47 for two different airflow velocities (30% of the initial drop velocity and 100% of the initial drop velocity), both of which velocities allow drops to reach a receiver spaced 4 mm from the printhead. (In this example, drops fail to reach the receiver without airflow.) Surprisingly, the airflow streamlines appear similar in both figures (FIG. 43: 30% of the initial drop velocity; FIG. 47: 100% of the initial drop velocity), suggesting that little is to be gained from the larger airflow velocity. However, this is the case only if the receiver-printhead distance is fixed. In fact, much greater distances of printing than might be expected from a comparison of FIGS. 43 and 47 can be achieved by the higher airflow value (100% of the initial drop velocity) as compared with the lower airflow value (30% of the initial drop velocity), and this has not been generally recognized. The reason can be seen from the airflow streamlines in FIGS. 43 and 47, each of which show the vertical airflow stopping as it approaches the receiver. For high airflow values, this stoppage is due to the boundary condition of no perpendicular airflow at the receiver, not because the airflow intrinsically would spread and slow. For high airflow values, if the receiver is moved further from the printhead, the point of airflow stoppage moves farther out, effectively following the receiver. In this case, but not for lower airflow velocities, one may increase the receiver spacing (in this example to 1.2 cm) before the airflow fails to guide the drops to the receiver. It therefore appears understandable that no substantially two-dimensional printhead array exists having a printhead to receiver spacing greater than about 3 mm, since none incorporate airflow ejectors.

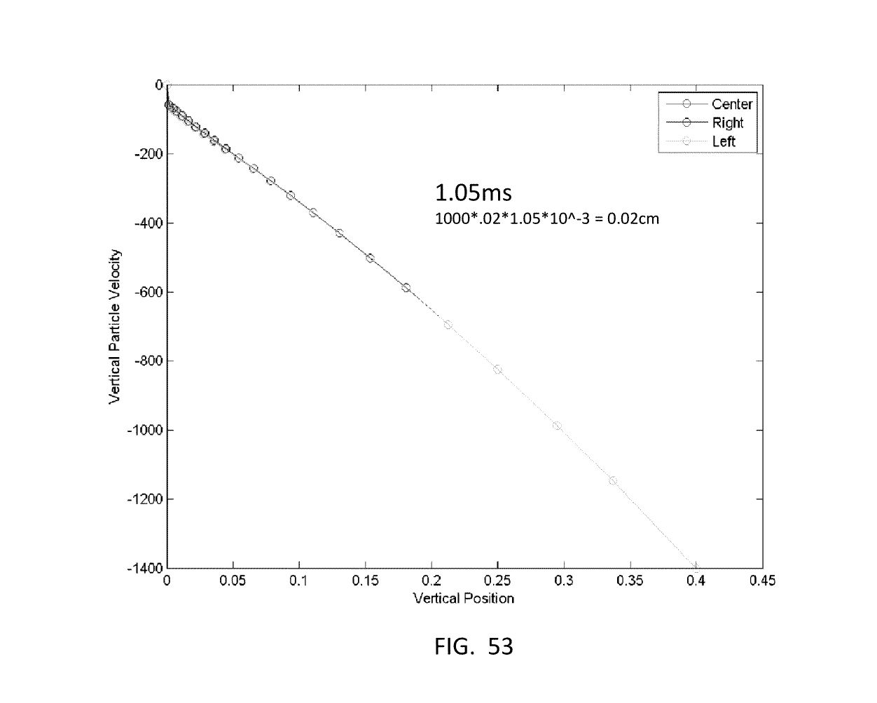

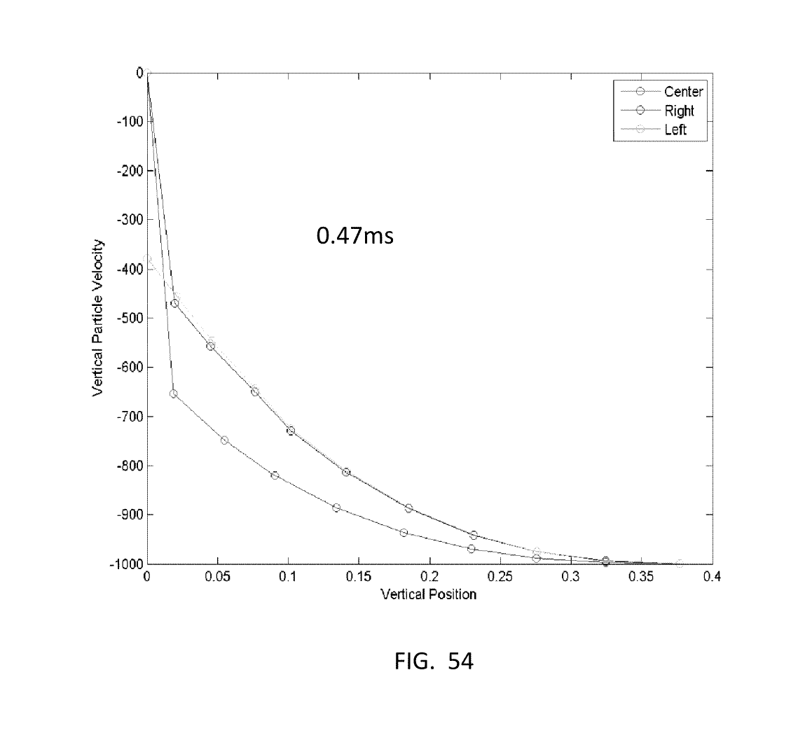

Shown in FIGS. 53 and 54 are the particle velocities vs. the distance traveled vertically from the ejectors to the receivers for drops ejected at the left, center, and right along the width of the drop ejector array. Two cases are shown: the case for drops ejected with hypothetically high velocities (20,000 cm/s) but with no airflow from airflow ejectors in FIG. 53 and for drops ejected with more practical velocities (1000 cm/s) which are guided to the receiver with airflow from airflow ejectors whose average velocity is matched to the initial velocity of the ejected drops (1000 cm/s) in FIG. 54. The shape of the curves is quite different, and reflects the fact that the embodiments of FIGS. 17 and 18 reduce drop energy dissipation, which is solely responsible for any reduction of drop velocity from its initial value. Specifically, in the case of the embodiments of FIG. 54, the drop velocity only decreases significantly as it nears the receiver and near the receiver still retains about half (500 cm/s) its initial value. This is due to the fact that the airflow ejectors provide airflow that extracts no energy from the drops near the plane of the drop ejector array. Near the receiver, of course, the injected airflow vertical velocity must decrease to zero, due to the boundary conditions for no vertical flow at the receiver itself. In contrast, for the “hypothetical” case shown in FIG. 53 for no airflow injection, the velocity of the drops decreases essentially linearly, and reaches a value of nearly zero at the receiver. The transit time for the hypothetical case is nearly twice that for the embodiment of FIG. 18. This extra transit time results in a displacement of the print drop positions of 5 mm on the moving receiver; yet another systems problem favorably resolved by vertical airflow injection. Finally, it should be noted that for the embodiment of FIG. 18, the vertical airflow would allow the receiver to be spaced even further from the receiver than might be inferred from the velocity profile of FIG. 54, because the decrease in vertical airflow velocity which accounts solely for the decrease in vertical drop velocity, itself depends on the position of the receiver. For example, at larger receiver spacings of 6-8 mm, the vertical velocity of airflow remains high until very near the receiver and the horizontal component of velocity due to airflow injection is reduced by the extra volume between the printhead and the receiver. Thus the drops are guided to the receiver even when the printhead to receiver distance is substantially increased. On the other hand, in the case of FIG. 53, the drop velocity profile is not changed substantially when the receiver is spaced further from the printhead, and the condition that drops no longer print is immediately encountered at distances only slightly greater than 4 mm. Thus the solution afforded by vertical airflow from the airflow ejectors can be used in practice to greatly improve throw distance and image quality.

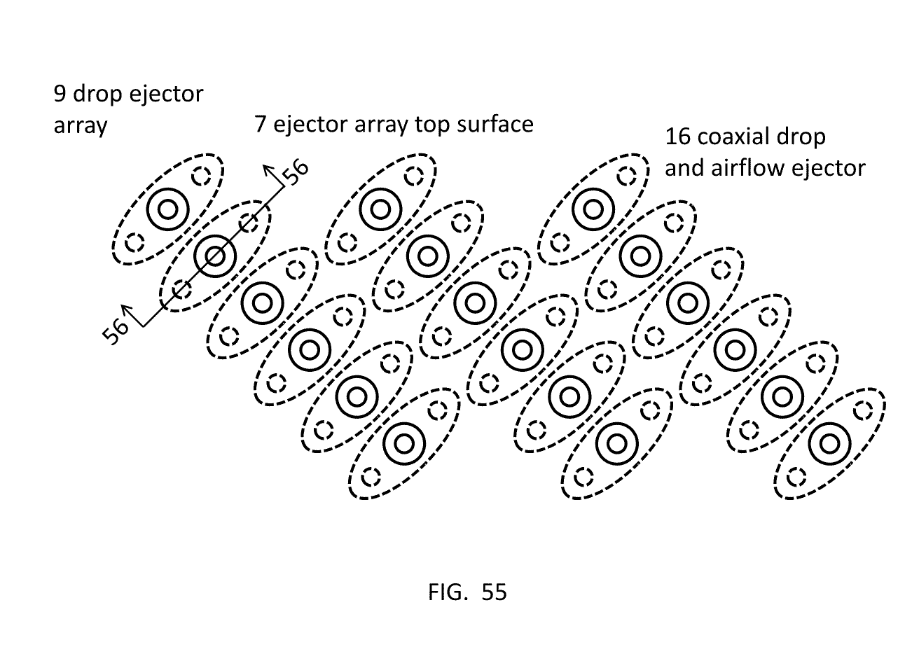

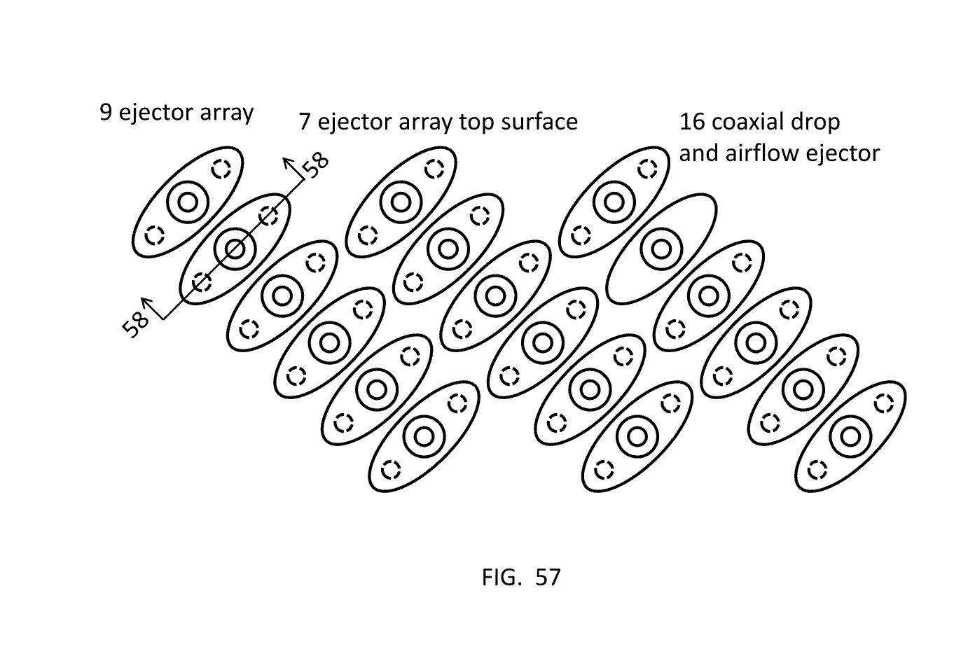

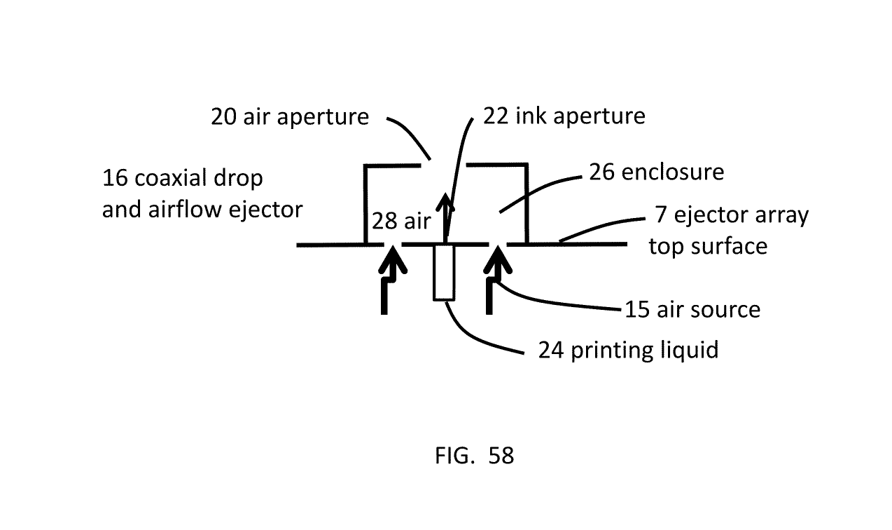

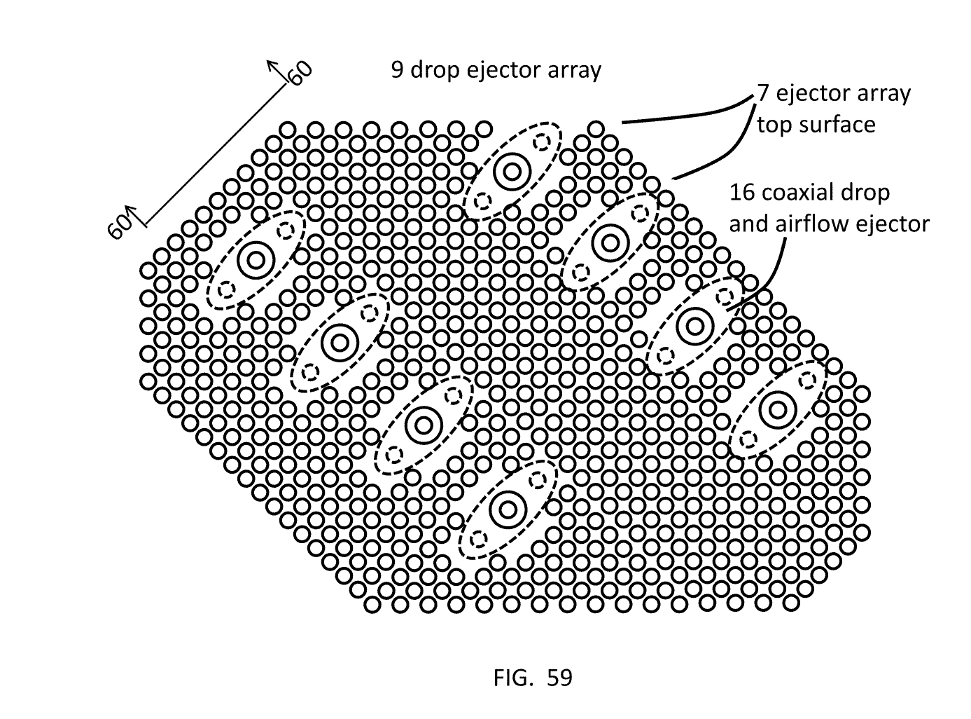

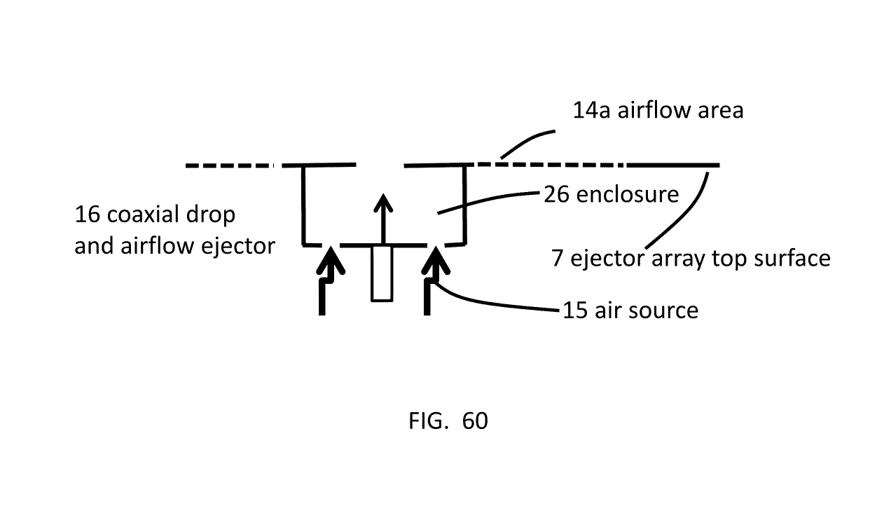

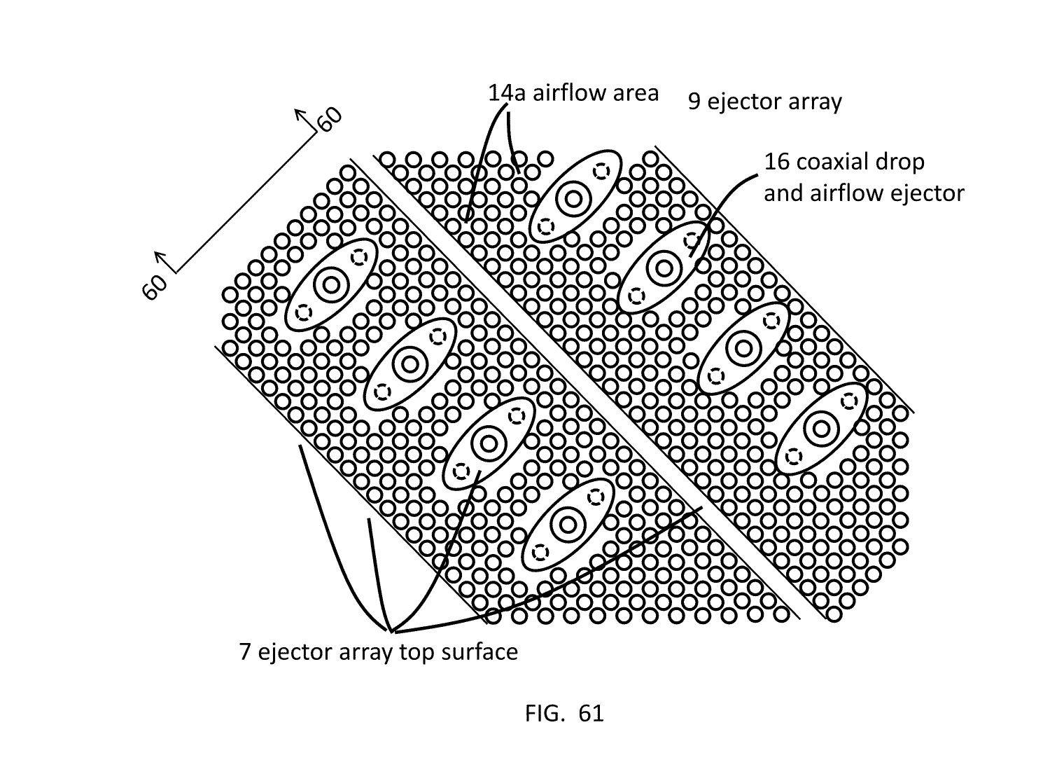

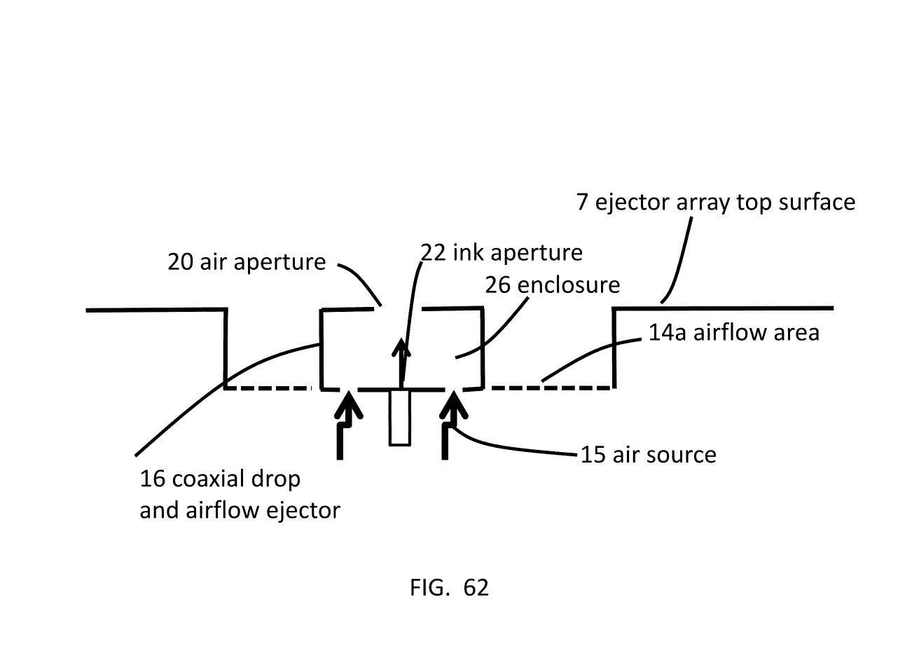

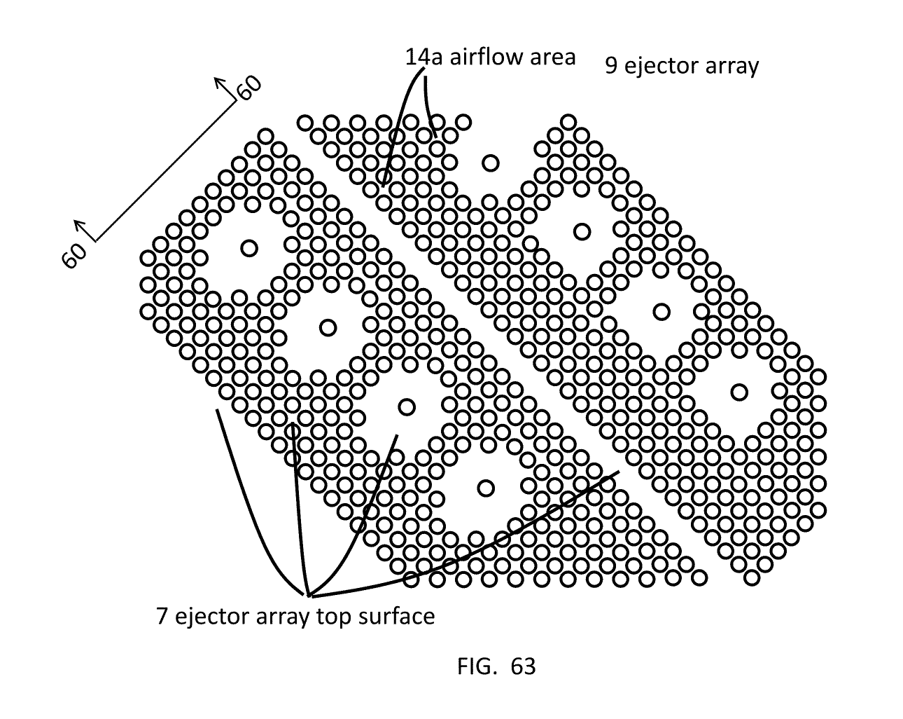

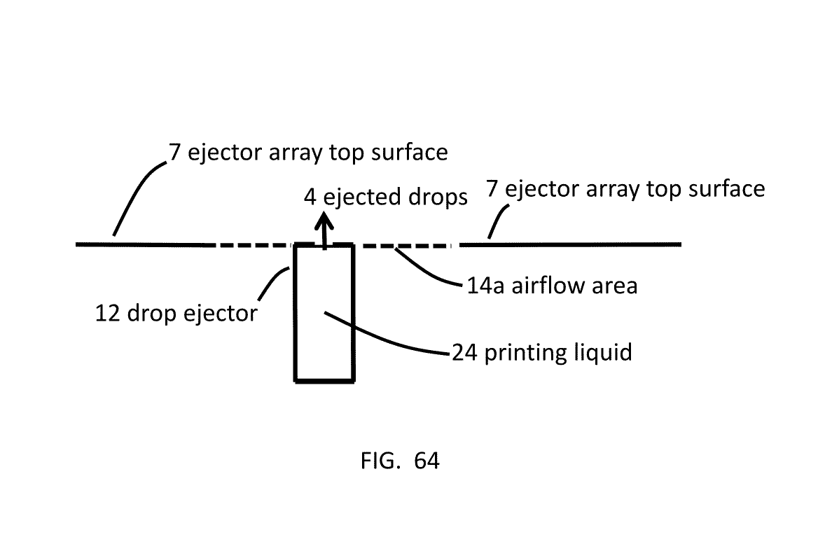

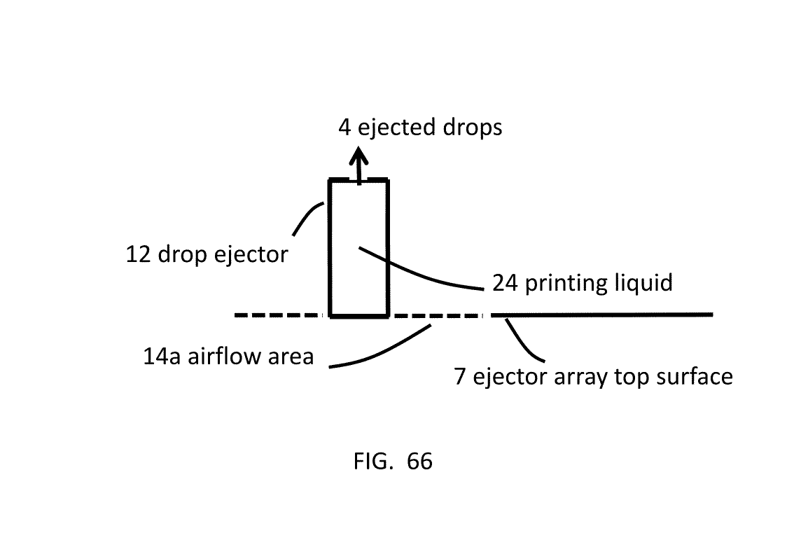

FIGS. 55-66 show related embodiments of a preferred embodiment of a substantially two-dimensional drop ejector array 9 having an ejector array top surface 7 each also showing a cross-section of a particular type of drop and airflow ejector, namely coaxial drop and airflow ejector 16, having air sources 15 symmetrically disposed within an enclosure 26, localized in the vicinity of its associated drop ejector, and having an air aperture 20. The drop ejector comprises a source of printing liquid (ink) and an ink nozzle, as previously described for all drop ejectors such as those of FIGS. 9, 10, 11, 12, and 13, and 14 generic to all inkjet drop ejectors. The top-view of each of FIGS. 55-66 shows physical locations of the coaxial drop and airflow ejectors. The geometrical arrangement of ejectors in FIGS. 55-66 is one of many possible arrangements in the accordance with the present invention, including arrangements such as those shown in FIG. 8 and FIGS. 31-33, because the airflow ejectors are associated in a one to one manner with the drop ejectors and, since the airflow is symmetrically disposed within enclosures 26, the requirements of symmetry for airflow of the entire array is automatically satisfied. (As a reference point, a case where symmetry is not satisfied in accordance with the present invention, for reference, would be for example the mixed array of drop ejectors and airflow ejectors of FIG. 11 modified by random substitutions of a subset of drop ejectors, making them instead airflow ejectors.) The reason for articulating the various related ejector arrays 9 of coaxial drop and airflow ejectors 16 shown in FIGS. 55-66 is to demonstrate the wide variety of forming the vertical positions of coaxial drop and airflow ejectors 16 with respect to the ejector array top surface 7 and the variety of types of ejector array top surfaces 7 herein contemplated. For example, in FIG. 55, the top surface of the coaxial ejector enclosure 26 is coplanar with the ejector array top surface 7, whereas in the embodiment of FIG. 22 the top surface of the coaxial ejector enclosure 26 is above the ejector array top surface 7, and bottom of the enclosures 26 are coplanar with the ejector array top surface. In FIGS. 23, 24, 25 and 26, the regions between coaxial ejector arrays shown in the top-views itself comprises an airflow area 14a made similarly to the airflow ejectors discussed in FIGS. 9 and 10, that is the airflow ejectors comprise apertures in a membrane. In FIG. 23, the airflow area 14a is coplanar with ejector array top surface 7 which surrounds the array of ejectors. In FIG. 24, the top of the enclosure 26 is coplanar with ejector array top surface 7 and the airflow area 14a is coplanar the bottom of the enclosure. FIG. 25 is included for reference to the substantially one-dimensional array of FIG. 4, which does not contain an enclosure. The drop ejector 12 is coplanar with ejector array top surface 7 and with the airflow area 14a. The airflow result is most closely related to that of FIG. 23, except that the airflow and ink nozzles are not collocated. FIG. 26 shows a drop ejector which rises above the plane of the ejector array top surface 7; the airflow area 14a is located below the plane where ejected drops separate from the body of the printing liquid 24. The airflow result is also closely related to that of FIG. 211 in that the airflow and ink nozzles are neither collocated nor located in the same plane. Many other similar geometrical arrangements are possible within the invention contemplated, and each has advantages and disadvantages as to fabrication complexity.

In all cases in FIGS. 55-66, preferably the air sources 15 are symmetrical located about the enclosure, preferably having at least two-fold symmetry about the direction of receiver motion (upwards in FIGS. 55-66), or more preferably four-fold symmetry or greater about the direction of receiver motion. However, it should be noted that as long as the air sources in all the coaxial ejectors are translationally symmetric to each other, the ejected drops will print in nearly the same pattern as the ejectors themselves. Moreover, the air in the localized enclosures associated with each drop ejector will exit the air apertures 20 approximately vertically, since the pressure within each enclosure will be approximately constant for air apertures 20 diameters small compared to the enclosure diameter, as is the preferable case for the coaxial ejectors shown in FIGS. 55-66.

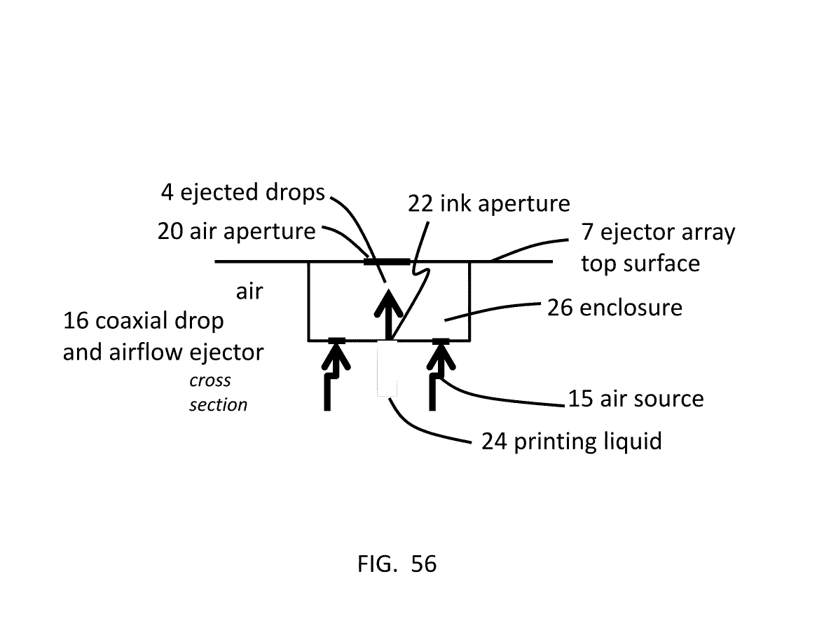

The coaxial drop and airflow ejectors shown for example in FIGS. 55-66 comprise printing liquid 24 which is ejected through ink nozzles 22 into enclosure 26 as either DOD drops, which form immediately after drop separation from the body of printing liquid 24, or CU jets, which emerge as liquid columns for some distance, typically 500-2000 microns, before breaking up into drops. In the case of DOD coaxial ejectors, the vertical height of the enclosure in for example FIG. 56 is typically greater than the DOD drop formation length (typically 50-500 microns), so that the drops form nearly completely within the enclosure. The flow of air through the air aperture 20 includes horizontal components within the enclosure 26, as is well known in the art of fluid dynamics, which help steer the drops along their desired trajectories, even if the drops are initially ejected at various angles distributed about a desired angle, typically normal to the ejector array top surface 7. If the air sources 15 enter the enclosure through a simple aperture in the enclosure bottom, the vertical component of air velocity will generally not be as much as the initial velocity of ejected drops throughout most of the enclosure, as discussed previously. On the other hand, if the air sources 15 enter the enclosure as a dispersive airflow, for example because of a frit in the path of the air in the opening for air in the enclosure bottom or because of the presence of a deflector (as in FIG. 2) just above the air aperture in the enclosure bottom, the vertical component of air velocity will generally be larger throughout most of the enclosure, as discussed previously in association with dispersive airflows. Such dispersive airflows are specifically contemplated and generally preferred for the embodiments described in FIGS. 55-66 because, although they are more difficult to manufacture, they assist drop formation in the case of DOD ejectors and may also assist drop break-off for CIJ ejectors, if the break-off length of the CIJ jet is less than the height of the enclosure 26. The extent of the velocity of airflow near the ink nozzle depends in both cases (DOD or CIJ) on the diameter of the air aperture 20, since the amount of air from air sources 15 is preferably adjusted so that the flow velocity through air aperture 20 in ejector array top surface 7 matches substantially (typically within 25%) the velocity of the drops as they pass through air aperture 20. The air pressure within enclosure 26 is a measure of the velocity distribution of air in the enclosure. If the air aperture 20 is small, for example twice the drop or jet diameter, the pressure of the air in the enclosure 26 will be much larger than ambient, and the airflow through the aperture will contain horizontal guiding components of airflow as the airflow approaches the aperture. On the other hand, if the air aperture 20 is large, for example half the diameter of the enclosure, the pressure of the air in the enclosure 26 need not be much larger than ambient, and the airflow through the aperture will largely be vertical. Both limits are contemplated in accordance with the present invention. In the case of CIJ ejectors, the preceding comments still hold true, but the consequences for system design differ, depending on whether the break-off length of the ejected jets is smaller than or larger than the height of enclosure 26. If the break-off length is longer than the height of enclosure 26, formation of the drops occurs above the enclosure and the drops experience matched (to the jet velocity) airflow velocities as they form, but no horizontal components of velocity serve to guide jets ejected at various angles distributed about a desired angle, typically normal to the ejector array top surface 7. However, in this case, the jet itself can be guided within the enclosure by horizontal components of velocity in the enclosure if the enclosure pressure is high. Conversely, if the break-off length is shorter than the height of enclosure 26, formation of the drops occurs within the enclosure (below the enclosure top in FIG. 56) and the jet and the drops at break-off may not experience matched velocity airflow if the enclosure pressure is high. In this case, the horizontal components of velocity in the enclosure serve to guide drops after break-off if the drops were ejected at various angles distributed about a desired angle, typically normal to the ejector array top surface 7. Because of the complex design trade offs (for example, if break-off length must be accurately controlled, it is desirable that the airflow match the jet velocity as close to the ink nozzle as possible) as well as tradeoffs based on cost of manufacture, the various geometries discussed in FIGS. 55-66 are useful related embodiments.

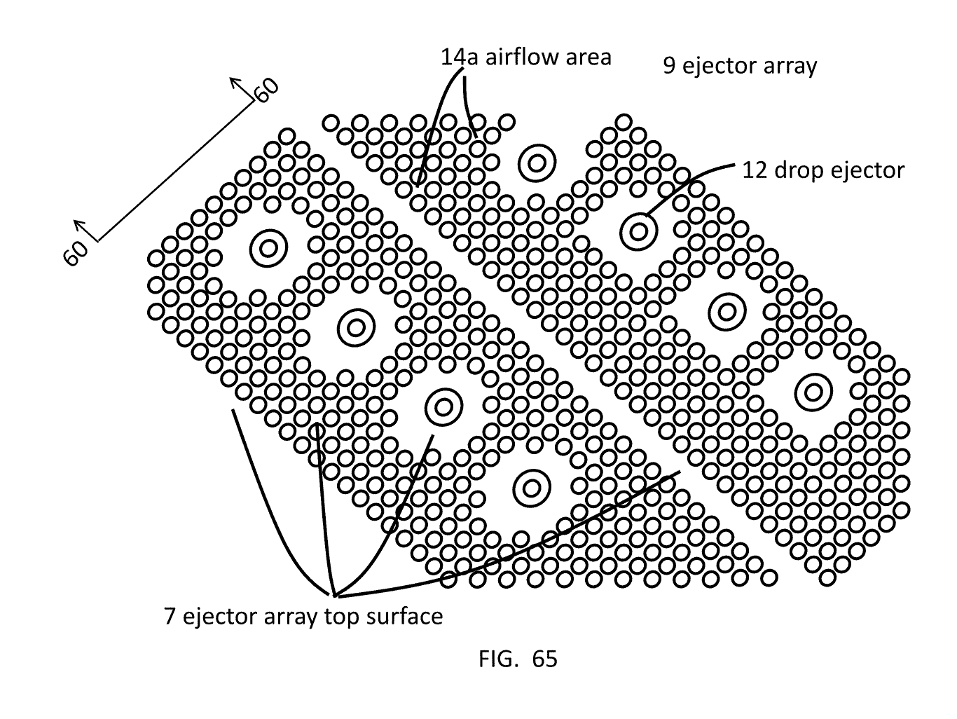

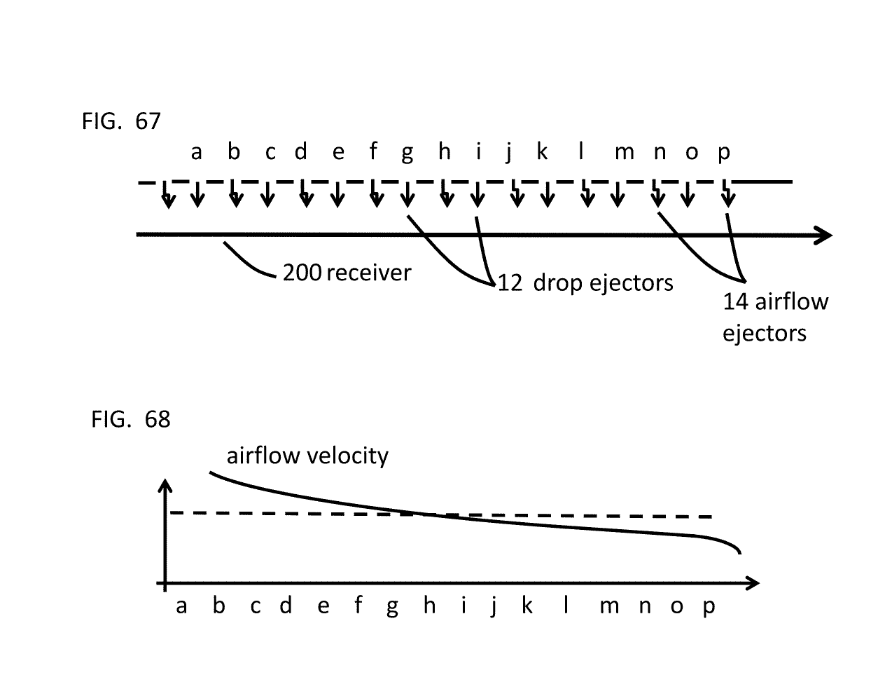

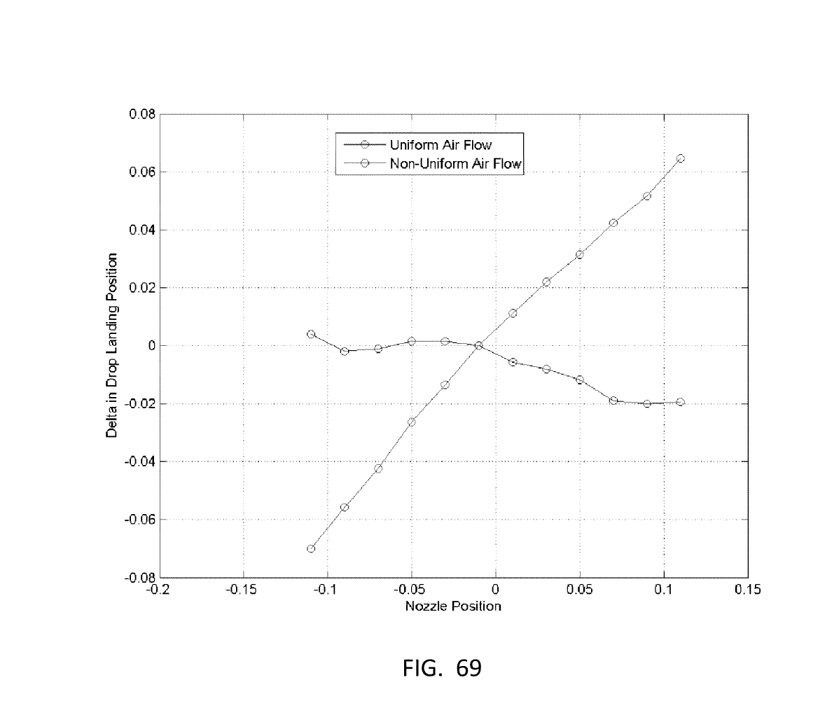

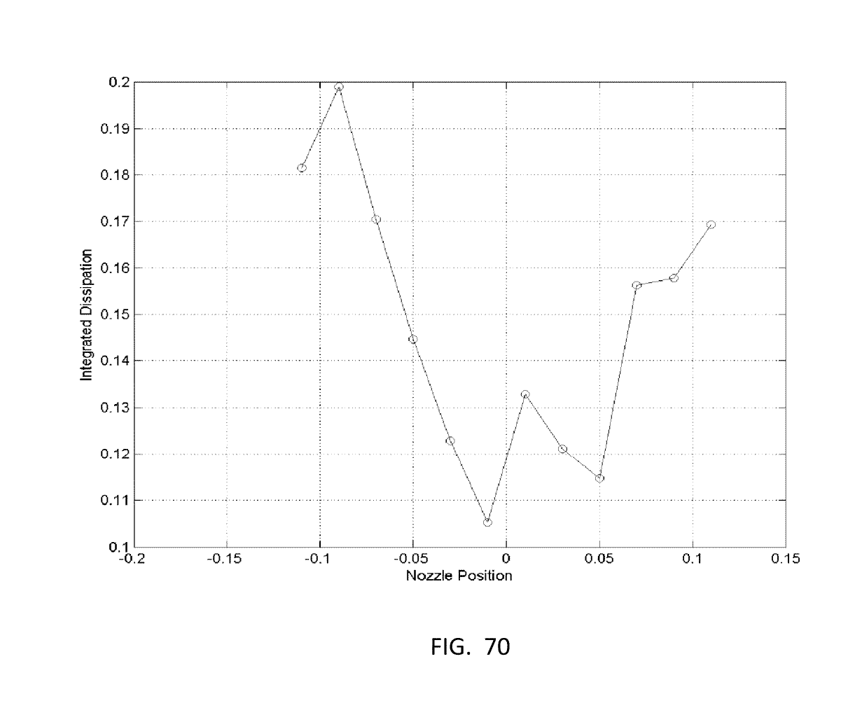

As noted, the geometrical arrangement of ejectors in FIGS. 55-66 is one of many possible arrangements in the accordance with the present invention, including arrangements such as those shown in FIGS. 8 and 11. Regardless of the particular arrangement of drop ejectors or of the particular type of airflow ejectors, we have found that the amount of airflow is preferably not uniformly distributed in the direction of receiver motion. In a preferred embodiment, the airflow from the airflow ejectors is varied by changing the airflow velocity of the ejectors in the direction of receiver motion or by changing the number or aperture size of the ejectors. In particular, we find that it is advantageous in accordance with the present invention to decrease the airflow from left to right (in the direction of receiver motion) in an approximately monotonic manner, as shown in FIGS. 67 and 68. In FIG. 67, the airflow ejectors are assumed to be located densely around each drop ejector in the manner of FIGS. 9 and 10, although the airflow ejectors could equally be of the coaxial drop and airflow type, the relevant concept parameter being the airflow volume in the local vicinity of each ejector should decrease in an approximately monotonic manner in the direction of receiver motion. This concept is represented in FIG. 65 by airflow ejectors 14 interspersed with drop ejectors 12, the airflow velocity of the airflow ejectors varying in the manner shown in FIG. 68. The reason for the preferred asymmetry of the airflow velocity is associated with the shear drag on the air near the moving receiver, which defines the direction of the asymmetry, and is associated with the fact that on the upstream side of the array (left side of FIGS. 67 and 68), the direction of shear induced airflow opposes the flow of air from the airflow ejectors, whereas on the downstream side of the array (right side of FIGS. 67 and 68), the direction of shear induced airflow adds to the flow of air from the airflow ejectors (confer FIG. 41). The path trajectories are shown in FIG. 69 for the leftmost, center and rightmost drops of the drop ejector array; the smaller transit times of the drops at the left (in the vicinity of higher airflow velocities) results in the printed drop positions lying more nearly in the pattern of the drop ejectors, as shown in FIG. 70. The drop energy dissipation is significantly reduced compared to the case of uniform airflow velocities, as shown in a comparison of FIG. 27 and FIG. 51. Thus, in this embodiment, by changing the airflow velocity across the array of the ejectors in the direction of receiver motion in a substantially monotonically decreasing way, the image quality is improved and the timing corrections for the launch of the drops needed to provide a pattern of printed drops similar to the pattern of drop ejectors in the plane of the drop ejector array top surface is greatly simplified (FIG. 70).

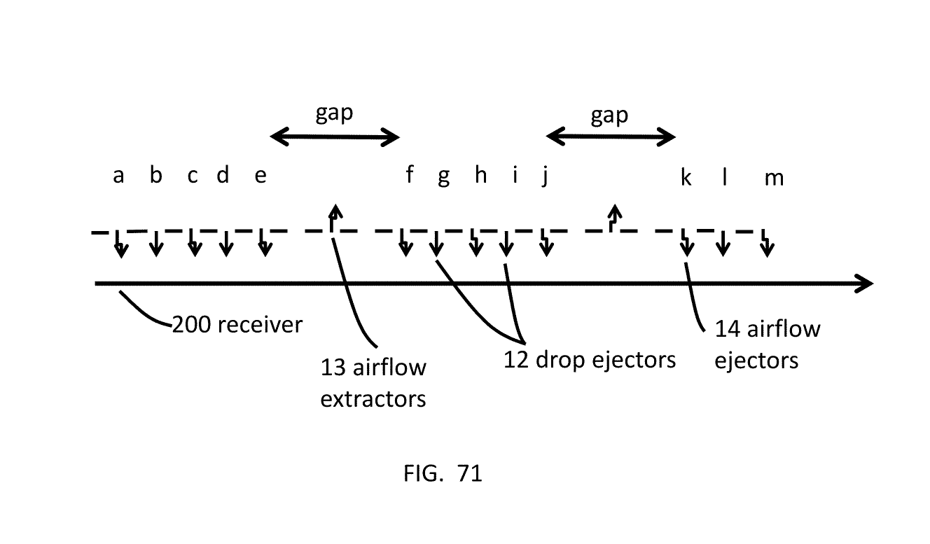

Also regardless of the particular arrangement of drop ejectors or of the particular type of airflow ejectors, we have found that the amount of airflow can be kept constant (which simplifies manufacture of the fluid connection layer 30) provided airflow ports are of two distinct types: those ejecting air downward toward the region between the printhead and the receiver, shown in FIG. 71 as downward compound arrows, and those extracting air away from the region between the printhead and the receiver shown in FIG. 71 as upward compound arrows. The latter type extracts air from the region between the printhead and the receiver and are referred to as airflow extractors 13. The airflow ejectors and airflow extractors 13 are organized into groups, with a gap indicated in FIG. 71 between the groups of airflow ejectors. In a preferred embodiment, the airflow from the airflow ejectors is approximately compensated in volume by the interspersed airflow extractors 13, thus avoiding undue buildup of ejected air noted in FIG. 41. The width (measured in the direction of receiver motion) of each group of airflow ejectors is thus constrained to a width consistent with high quality printing from a single group of ejectors of dimensions discussed in association with FIG. 43, i.e. the width is restricted to a value about that of the spacing between printhead and receiver (4 mm in the example of FIG. 43). the width of the gap indicated in FIG. 71 is similarly about that of the spacing between printhead and the receiver in order that the extracted air does not unduly perturb the injected airflow, which would result in little downward airflow to guide drops at the left and right of the groups of airflow ejectors, as can be understood by those skilled in fluid dynamics. Also, as can be understood by those skilled in fluid dynamics, the extracted air can be localized near the gap center rather than be spread out over the entire gap, since the extracted airflow streamlines below the plane of the ejector array are not collimated.

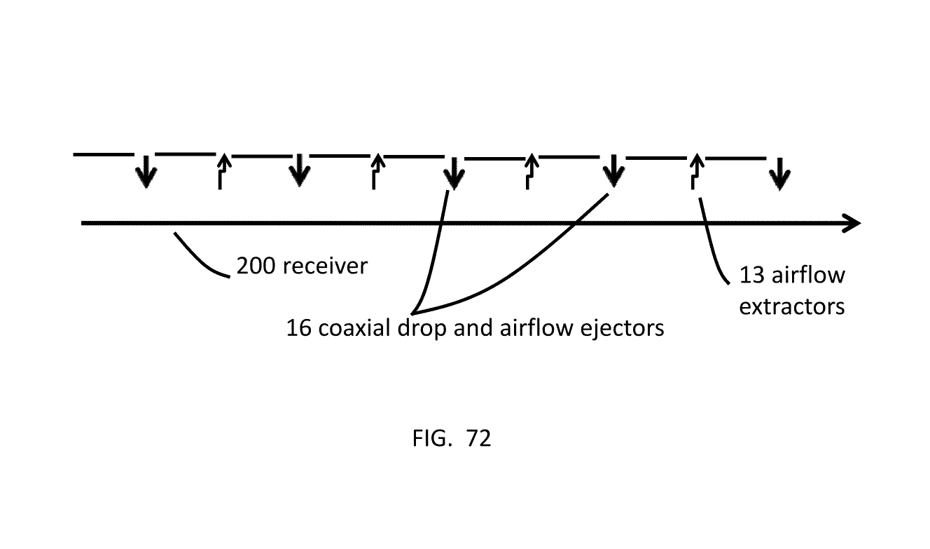

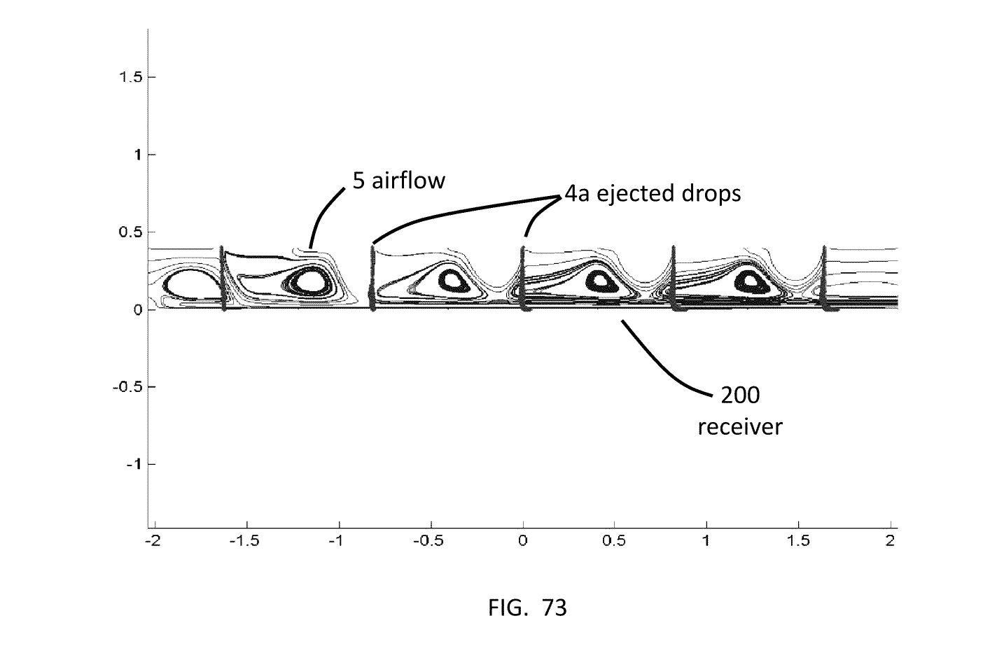

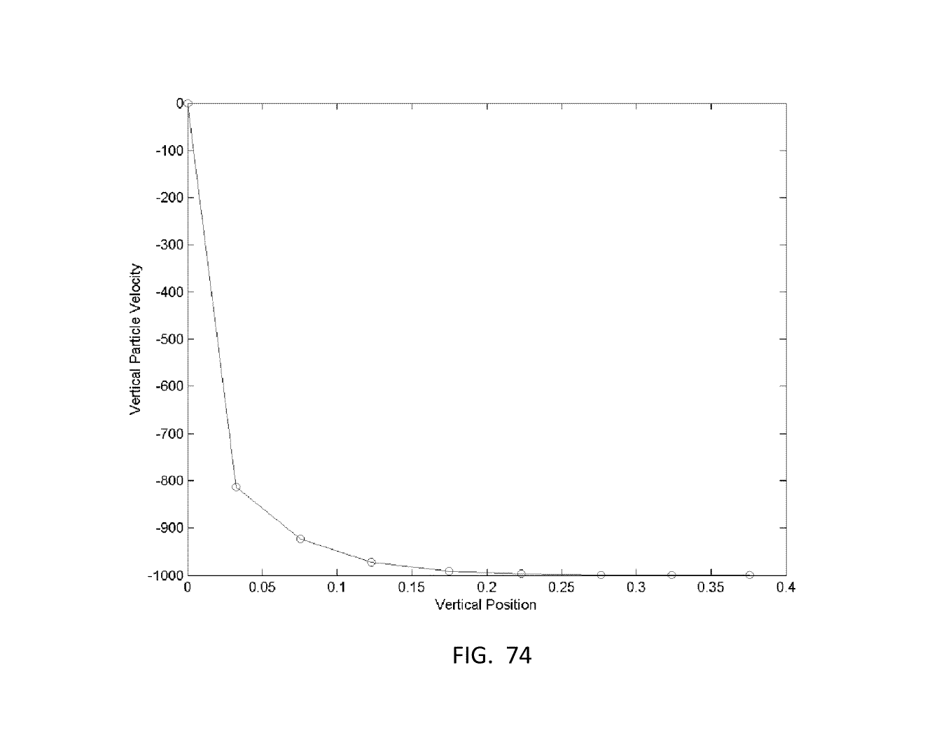

A final preferred embodiment related to the previous embodiments is shown in FIG. 72, for the case the drop and airflow ejectors are of the coaxial type (FIG. 56). Similar to the embodiment of FIG. 71, coaxial drop and airflow ejectors 16 (simple arrow) are interspersed with airflow extractors 13 (compound arrow) extracting air upward away from the region between the printhead and the receiver. Although in FIG. 72 only a single coaxial drop and airflow ejectors 16 is shown between airflow extractors 13, it is understood that at any location, for example location “a” in FIG. 72, the simple arrow could represent a plurality of coaxial drop and airflow ejectors 16. In this embodiment, the spacing between the rightmost member of a coaxial ejector and the leftmost member of the next (moving right in FIG. 72) coaxial ejector is a critical parameter, preferably lying in the range of 2 to 6 mm for a 4 mm distance between the printhead and the receiver, or more generally, between half and twice the distance between the printhead and the receiver, in order that the velocity profile directly below each coaxial ejector not be unduly perturbed from a vertical direction by air extraction. Preferably, the amount of air extracted is on average the same as the amount of air ejected in the region between the printhead and the receiver. FIG. 73 illustrates streamlines and drop trajectories for an embodiment meeting these criteria having a spacing of 8 mm between coaxial ejectors and airflow extractors 13. The drop trajectories are substantially vertical. FIG. 74 shows the corresponding particle velocities measured along the drop trajectory during drop transit with the print medium at vertical position zero. The velocity is initially −1000 as it exits the drop ejectors. The particles retain a substantial vertical velocity until within 0.5 mm of the receiver, resulting in a average dissipation of 0.08, even less than that of the other embodiments discussed. This is because the array of FIG. 72 advantageously minimizes the amount of air ejected by the use of coaxial drop and airflow ejectors. In this embodiment, the array of coaxial ejectors in top-view could comprise any of the many geometries discussed in relation to other embodiments of substantially two-dimensional drop ejector arrays.

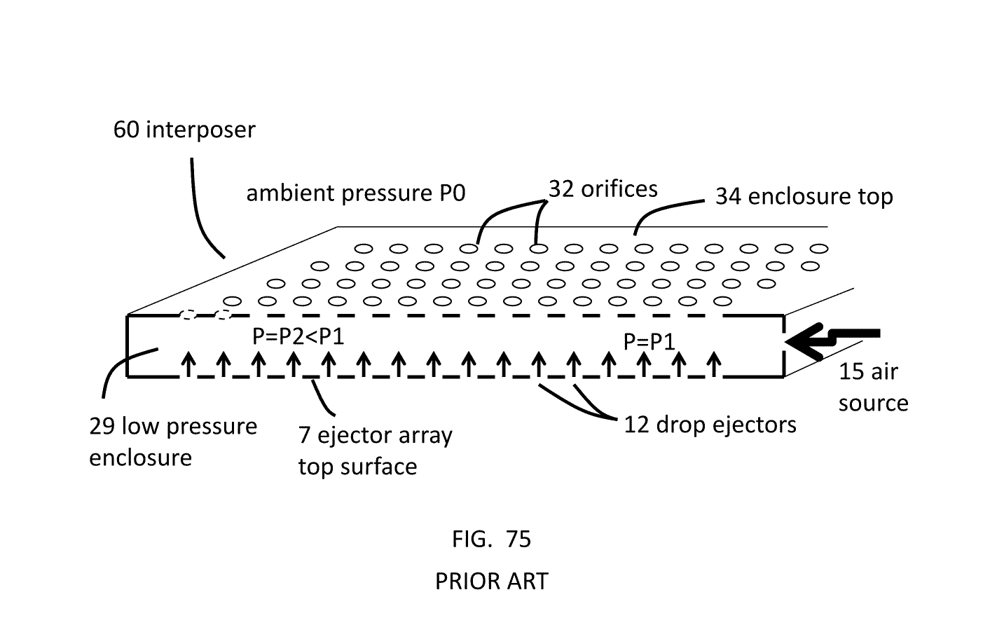

Related embodiments are now described which include specific types of interposer structures 60 positioned between the top drop ejector array layer 10 (FIG. 2) and receiver 200 for substantially two-dimensional arrays of interspersed airflow and drop ejectors. Although it is advantageous, for reasons of cost and complexity, to avoid adding hardware interposed between the drop ejectors and the receiver, there are cases for which these disadvantages can be outweighed by other advantages. Such advantages may include protecting the drop ejector array from mist and debris and from mechanical contact with the receiver, and providing means for controlling the trajectories of ejected drops. For example, FIG. 75 illustrates schematically a prior art interposer for a substantially two-dimensional drop ejector array of the DOD type which includes airflow and otherwise purposed interposer hardware occupying or partially occupying portions of the space between the top plane of the drop ejector array (that is the plane defined by the two-dimensional array of liquid drop ejectors 12) and the receiver. An interposer 60 (shown in relation to the drop ejector array, base, fluid connection layer, and receiver in FIG. 2) shown in prior art FIG. 75 comprises a low pressure enclosure 29, not usually present in commercial two-dimensional arrays of DOD ejectors used in desktop inkjet printing. However, low pressure enclosure 29 can play an important role in drop ejector arrays having very high areal densities of drop ejectors (i.e. very close ejector spacings) and/or very small ejected drop volumes, despite the fact that the interposer complicates the manufacturing process. The prior art hardware (low pressure enclosure 29) shown in FIG. 8 comprises a rectangular enclosure having an enclosure top with orifices through which ejected drops pass. The orifices are somewhat larger than the drop size and stand in a one to one relationship with the DOD drop ejectors. Low velocity airflow through the orifices is claimed to prevent debris from accumulating on the drop ejectors 12 as well as to protect the ejectors from mechanical contact with the receiver. In FIG. 75, low pressure enclosure 29 is pressurized with low pressure air from one side in order that the airflow out the array of orifices 32 ejects mist and prevents debris from accumulation near the drop ejectors 12, thereby increasing reliability. Liquid ink drops and air flow together out the orifices 32. The pressure in the interposer must be very low (typically less than a few psi) in order not to perturb the meniscus position of liquid in the DOD drop ejectors. Thus the velocity of air flowing out the orifices is necessarily low compared to the drop velocity so the drops are not much perturbed by the flowing air. Specifically, the interposer pressure P exceeds the ambient air pressure P0 (typically 15 psi) by no more than a few psi. Because the air flows out the array of orifices 32, the interposer pressure P decreases with distance away from the source of air, shown on the right of FIG. 75. Thus, at the left side of interposer, the pressure P2 is less than P1. The function of ejecting mist and rejecting debris is still served regardless of the difference between P1 and P2 because the drops are not much perturbed by the flowing air. (Alternatively, at least in principal, higher air pressures could be used to produce an exit velocity of the air out of the interposer orifices close to the drop ejection velocity. To avoid perturbing the meniscus of the DOD drop ejectors, the pressure of the liquid supplied to the drop ejectors would have to be maintained at all times relative to that of the air pressure within the interposer rather than to the atmospheric pressure on the exterior of the interposer, but any difference between P1 and P2 would be thus exaggerated, since more air is flowing out orifices 32, and the menisci at different locations may not be ideally positioned.)

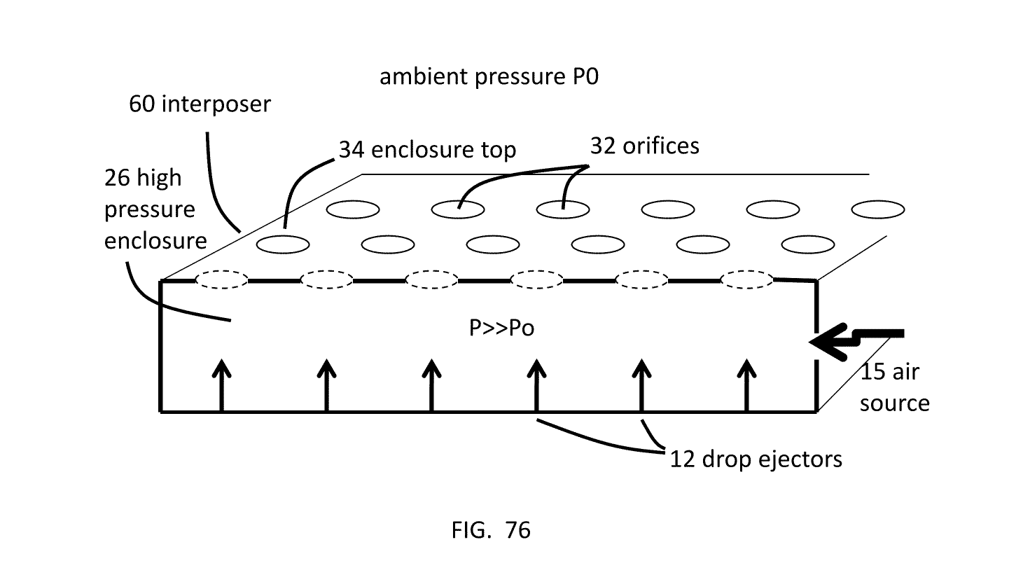

A related interposer 60, comprising a high pressure enclosure 34, in accordance with another embodiment of the present invention, is shown in FIG. 76 for the case of a substantially two-dimensional ejector array of the CIJ type. For CIJ drop ejectors, there is no requirement to maintain a low pressure inside the enclosure, since the ejected fluid is typically under very high positive pressure in (typically about 100 psi or more) and because variations in pressure are less critical than for the DOD case, where liquid pressures are typically small and negative. In operation, the pressure in the high pressure enclosure 34, in accordance with the present invention, is made sufficiently high (for example twice the atmospheric pressure P0 or about 30 psi) that the velocity of airflow exiting the orifices in the top plate can be comparable to the velocities of the ejected drops (about 20-30 m/s.) Thus device of FIG. 76 operates in a fundamentally different regime than the prior art device of FIG. 75. The airflow produced by high pressure enclosure 34 reduces the drag that jets and drops would otherwise experience and guides jets to be perpendicular to the drop ejector array, thereby projecting drops to be printed accurately onto their desired pixel locations on the receiver. It is not contemplated in the device of FIG. 75 that the airflow through the orifices of the low pressure enclosure would significantly reduce the drag on or guide ejected drops. Also the device of FIG. 76 differs in geometry from the prior art device contemplated in FIG. 75 in that the height (interposer 60 thickness) of the high pressure enclosure is larger (typically greater than 500 microns) than the heights contemplated for the device of FIG. 75 (about 100 microns), in order that the enclosure height of the high pressure enclosure is comparable to the break-off length of the CIJ jet (typically greater than 1000 microns). This ensures that any perturbation of the break off length of the jet due to passage through orifices 32 is minimized, as can be appreciated from the fluid dynamics of jet break off. Since the high pressure enclosure of the device of FIG. 76 is an order of magnitude larger than that the low pressure enclosure of the device of FIG. 75 and contains air pressurized at least an order of magnitude higher; hence its construction must needs be far more robust. In CIJ systems the array of drop ejectors form continuous jets and which break up to form an array of drops after break off that produce a moving boundary condition so that the airflow near the array approaches the jet velocity. Thus it is important for CIJ printers as well as DOD printers that airflow ejectors bring the speed of the air to nearly the jet velocity as close to the surface of the ejector array as possible.

Until the drop deflection system begins to separate print and catch drops, all drops encounter the same air drag so the effect of the air drag on the drops is not readily apparent. Once the print and catcher drop trajectories diverge, the print drops, which tend to be in the minority, move out from behind the preceding catch drops and they encounter increased air drag. The first print drops in a pattern such as the first drops in a stroke of a character encounter more air drag than subsequent print drops, even if the subsequent print drops are spaced out from the initial print drop by one or two intermediate catch drops. The first print drop seems to produce a wake that partially shields from air drag subsequent print drops for a distance of several drop-drop spacings downstream of the first print drop. Locating the interposer closer to the break off position than to bottom of the catcher, reduces air drag on the jet and on the drop stream and reduces some of the initial air drag on print drops. Locating the interposer near the bottom of the catcher helps to shield more of the drop path from external contamination. A single interposer located near the bottom of the catcher, however, will not reduce the magnitude of initial air drag on the print drops.

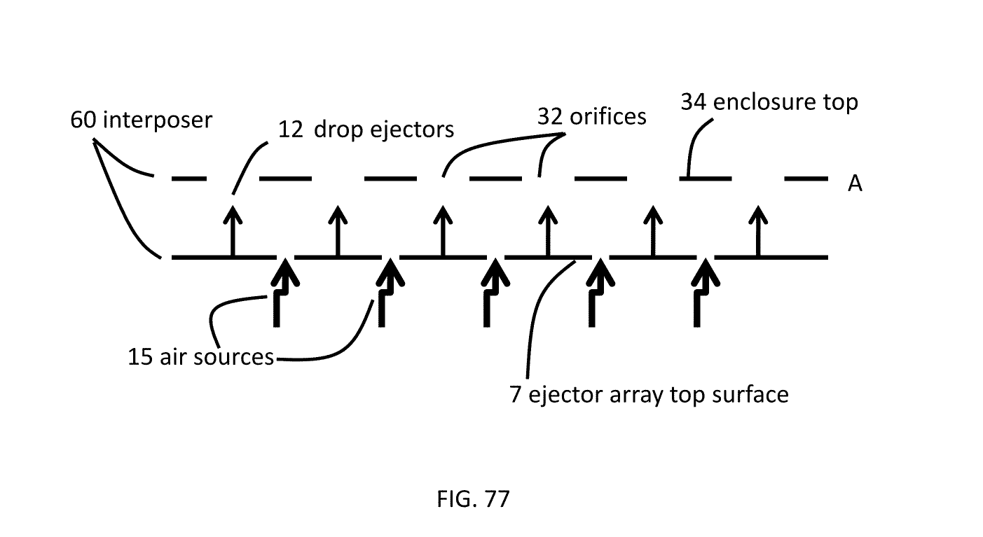

Other constructions for interposer 60 are now described in accordance with the present invention. In the schematic cross-section of a substantially two-dimensional drop ejector array and interposer, FIG. 77, air is injected by air sources 15 (compound arrows in FIG. 77), comprised, for example, of airflow ejectors (FIG. 15) of the diffuse type or airflow ejectors 18 (FIG. 16, 17) of the collimated type, so that the resulting airflow is collinear with the desired drop trajectories along those trajectories, preferably having little turbulence. For large orifices 32 in FIG. 77, the enclosure top 34 acts primarily to protect against impact between the printhead and the receiver, since the airflow in this case is not much altered by the enclosure top. The enclosure shown in cross-section in FIG. 77 is contemplated to be of a large height, for example at least 0.5 mm. The injection of airflow from a substantially two-dimensional array of ejectors (or air sources) interspersed amongst the drop ejectors is much preferable to the injection of air into one side of an interposer of the enclosure type in that turbulence is suppressed and the air pressure across the interposer is more uniform in comparison with the embodiment of FIG. 76. In particular, the uniformity of air pressure enabled by an array of air sources as opposed to airflow injected at the sides of the enclosure enables technologies such as DOD drop ejectors to be utilized which otherwise suffer performance reduction due to variations across the array in the meniscus position or suffer cost and complexity increases to compensate for pressure variations across the array, for example by pressurizing the drop ejectors differently depending on their location in the array by providing multiple pressure sources to multiple air channels 25 in fluid connection layer 30.

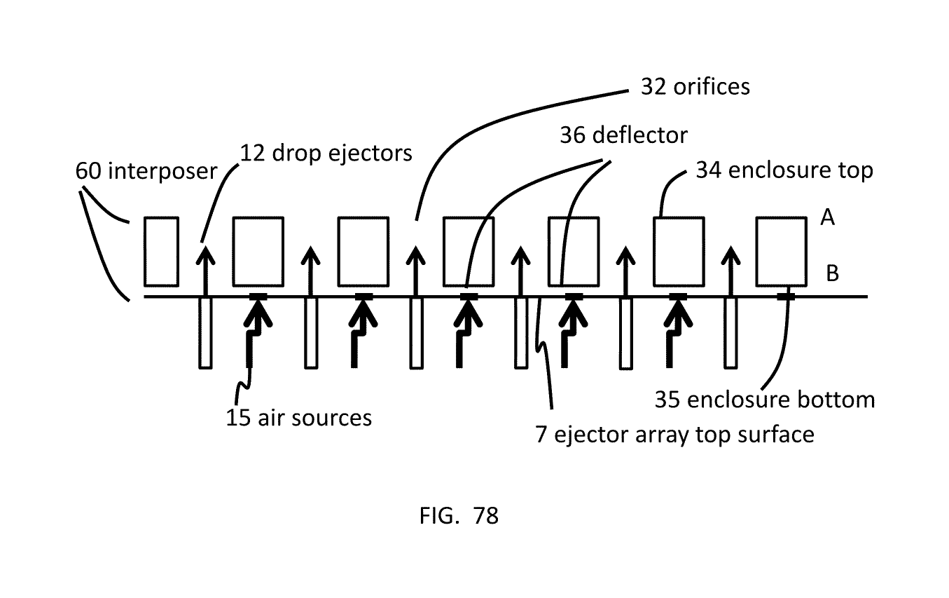

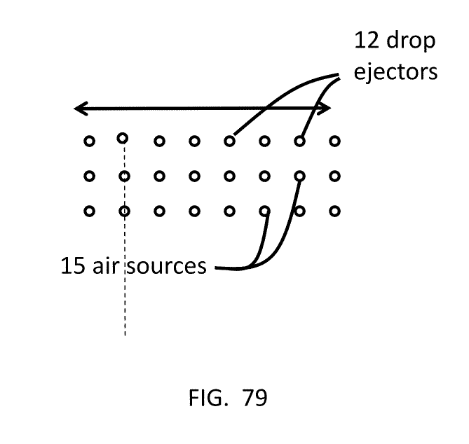

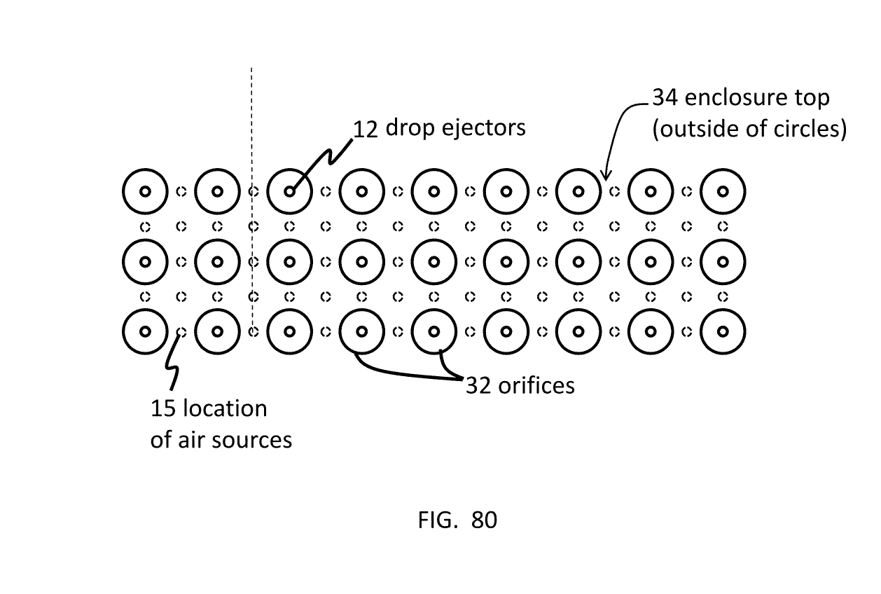

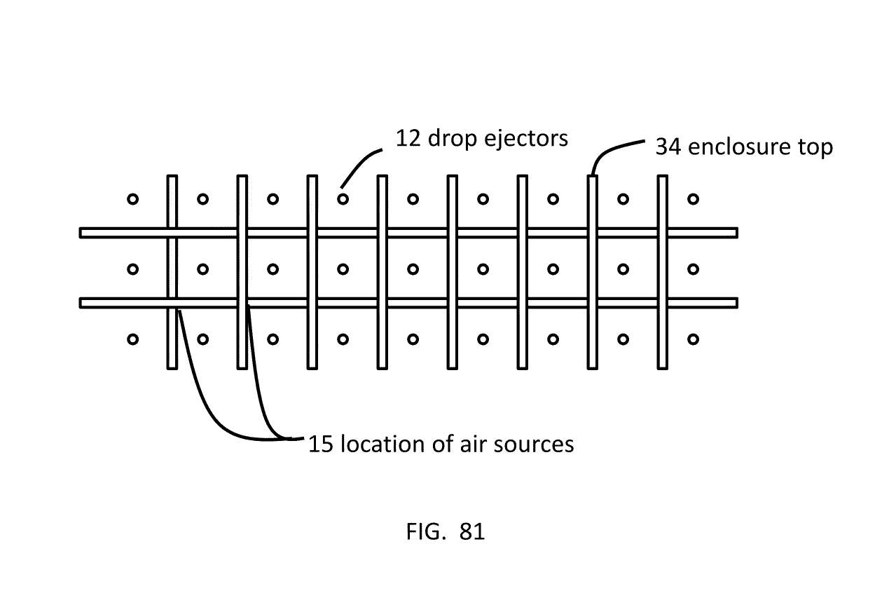

Interposers 60 typically rely on the top surface of drop ejector array 9 to define the bottom of the enclosure. Alternatively, an interposer 60 may include not only an enclosure top but also an enclosure bottom. In accordance with the present invention, an enclosure bottom can include deflectors 36, shown in cross-section in FIG. 78. In this case, the air sources 15 impinge on drops ejected from drop ejectors 12 with substantially greater horizontal velocity than for the case of FIG. 77. As shown in FIG. 78, orifices 32 in the enclosure top 34 and deflectors 36 are of similar horizontal dimensions. FIGS. 79 and 80 illustrate in top-view preferred configurations and relative positions of the components of interposer 60 of FIG. 78. FIG. 81 shows an alternative architecture in top-view in which the enclosure top has larger, square orifices in comparison with FIG. 80 but which is also within the spirit of the present invention. As can be appreciated by one skilled in microstructure design and fabrication, the geometry of the enclosure top may be varied over a wide range of shapes, including those described above, with little change in the manufacturing process.

The enclosure top 34 comprises straight, narrow beams. The underlying airflow sources 15 (not visible in FIG. 81) are disposed relative to the drop ejectors identically. Although this changes the symmetry of the openings through which the liquid jets or drops (and air) pass, the protective nature of enclosure 34 top, providing mechanical protection of the printhead from contact with the receiver, in a substantially two-dimensional array is unchanged. In the case, the width of the top enclosure beams is smaller than the diameter of the airflow injectors, the airflow pattern is nearly identical to that of the diffusive airflow ejectors previously described. In the case that the vertical thickness of the enclosure top beams of FIG. 81 is large compared to the distance between the top of the drop ejector array and the top of the beams, the airflow pattern along the jets will resemble “collimated” flow.

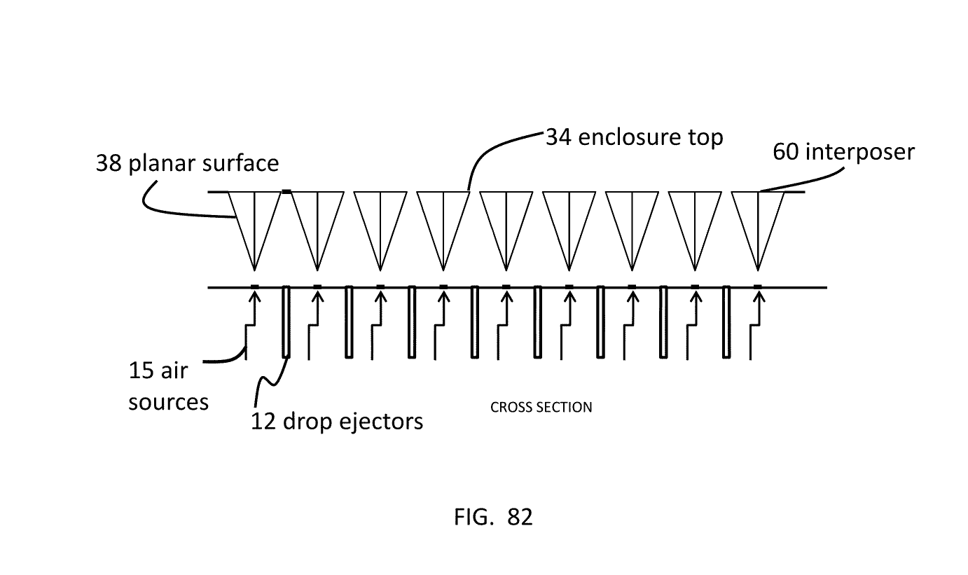

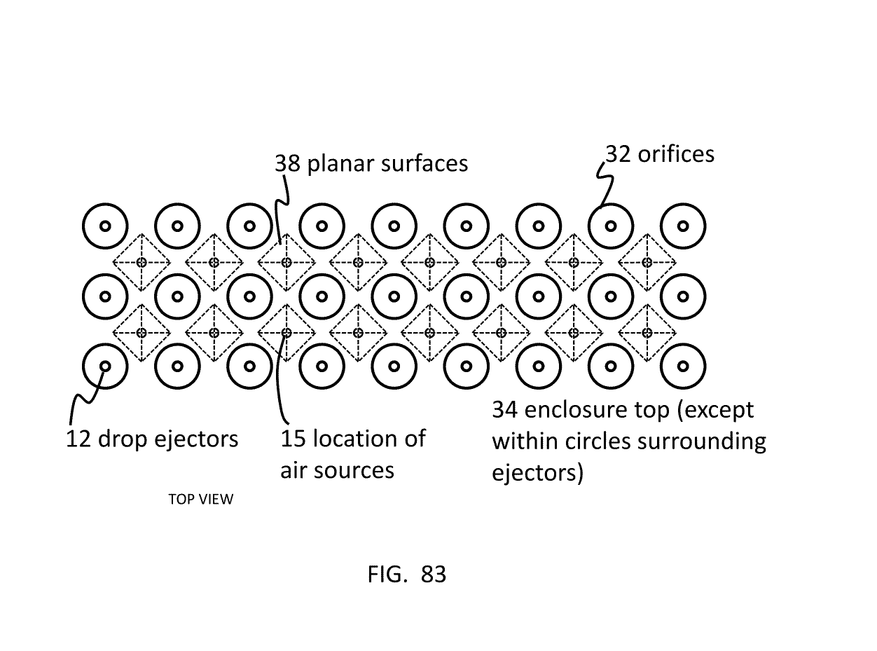

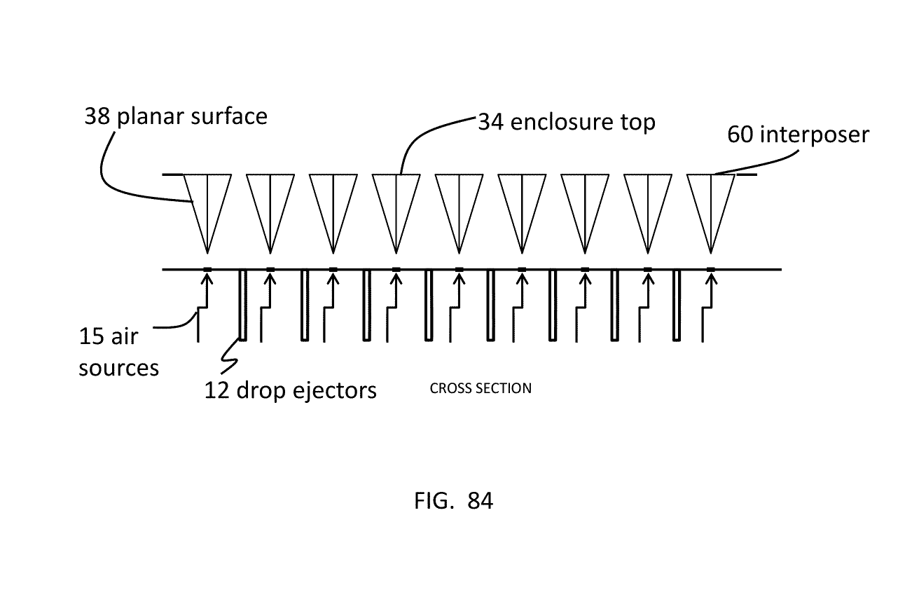

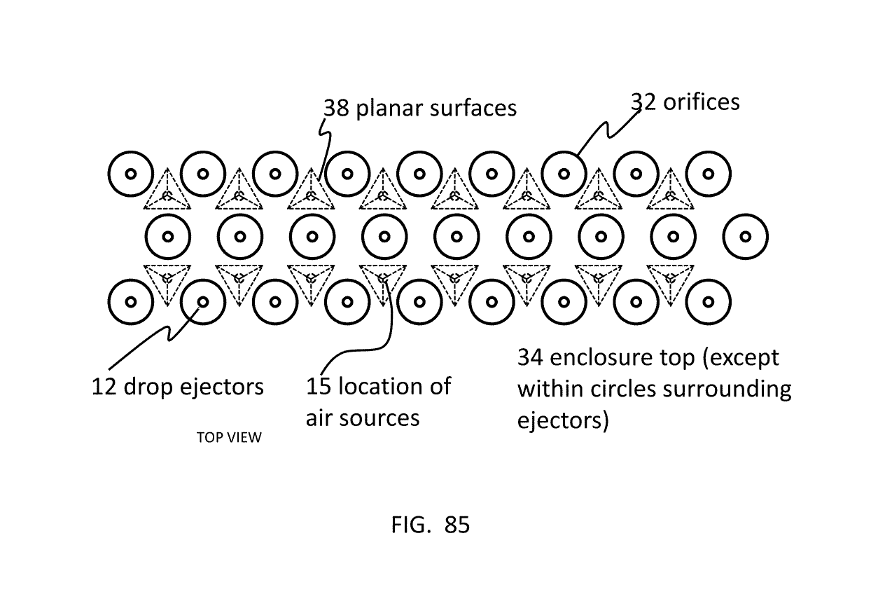

FIGS. 82 and 84 each show an interposer 60 having an enclosure top 34 related to the embodiment of FIG. 81 for a substantially two-dimensional array of drop ejectors interspersed with airflow ejectors, but with the enclosure top 34 comprised of a structure having planar surfaces 38 extending toward and located directly above air sources 15. A structure such as that shown in FIGS. 82 and 84, is generally effective in reducing airflow turbulence and increasing drop placement accuracy by focusing the airflow from air sources 15 through orifices to guide the drops toward the receiver. The enclosure top 34 may include beams such as those shown in FIG. 81 which support the planar surfaces, as shown in FIGS. 83 and 85. A top-view of two possible profiles of structures having planar surfaces 38 in the cross-section of FIGS. 82 and 84 is shown in FIGS. 83 and 85, respectively. Other geometries, such as cones, are within those structures having planar surfaces 38 contemplated in the current invention. In general, the airflow from air sources 15 is guided perpendicular to the planar surfaces outlined in dotted lines in FIGS. 83 and 85, so that the pyramidal structures at the left as well as conical structures (not shown) would provide four-fold symmetrical airflow toward each drop ejector 12. As shown in FIG. 85, preferably threefold symmetric tetrahedral air deflection surfaces are used when three drop ejectors are symmetrically placed around an air ejector. In general, the symmetry of the air deflection surfaces should correspond to the symmetry of the drop ejectors around an air ejector. If however tetrahedral air deflection surfaces were used when four drop ejectors are symmetrically placed around an air ejector, then the air deflection surfaces would not evenly distribute the airflow to each of the adjacent orifices. For enclosure tops 34 lacking symmetry in either the direction of receiver motion or in the direction perpendicular to receiver motion, airflow will not generally be collinear with the desired drop trajectories and such enclosure tops are not optimal structures in accordance with the current invention. Precision alignment of the structures having planar surfaces 38 aligned over air sources 15 is critical due to the sharp tip at the bottom of the triangles (pyramids or tetrahedrons in 3 dimensions). On the other hand, if the air sources are of the steering type discussed previously, steering will be amplified for small angles and the steering mechanism can be more economically made.

FIG. 86 shows an interposer 60 having an enclosure top 34 related to the embodiments for a substantially two-dimensional array of drop ejectors interspersed with airflow ejectors, but with the enclosure top 34 comprised of a structure having curved air deflection surfaces 39 rather than planar surfaces 38. A curved surface, such as that shown in FIG. 86, is generally more effective in reducing airflow turbulence and increasing drop placement accuracy than is a planar surface, such as is shown in 34, it is also more tolerant of alignment shifts relative to the air ejectors than are the planar air deflection surfaces of FIG. 38. The enclosure top 34 may include beams such as those shown in FIG. 81 which support the curved surfaces 39, as for the case of FIGS. 82-85. The curved surfaces help to produce a converging airflow to help guide the ink drops as described in U.S. Pat. No. 6,554,389. Although a particularly simple two-dimensional pattern of airflow ejectors appropriate to the cross-sections of FIGS. 82, 84, and 86 is shown in FIGS. 83 and 85, many other such patterns, for example those shown in FIGS. 31-33 are contemplated in accordance with the present invention. Preferably the airflow ejectors and liquid ejectors are symmetrically disposed both in the direction of receiver motion and in the direction perpendicular to receiver motion, as in the embodiments previously disclosed.

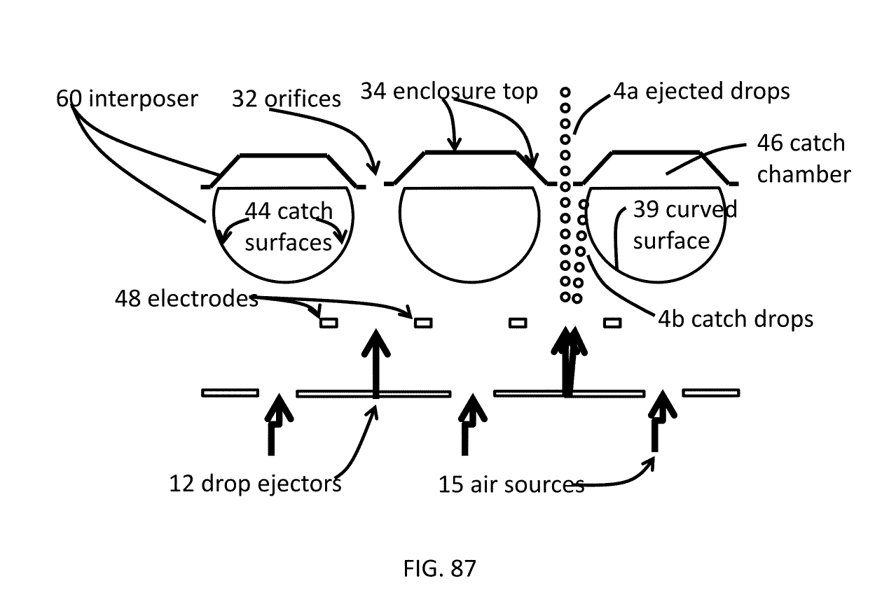

FIG. 87 shows a more complex interposer structure appropriate for drop ejectors of the continuous inkjet type (CIJ type). This structure builds on that of FIG. 86 by having deflection electrodes 48 for altering the trajectory of drops ejected from drop ejectors 12 so that drops not to be printed, catch drops 4b, land on catch surfaces 44 rather than traveling as ejected drops 4a through orifices 32 and onto the receiver (not shown). Such electrostatic deflection is well known in the art of continuous inkjet printing and generally only the drops that have broken off from the jet are deflected rather than the continuous liquid column of the jet itself. However, as shown for the drop ejector on the right in FIG. 87, also know are methods of deflecting the liquid column itself, for example by thermally stimulated deflection, either alone or in supplementation with electrostatic deflection. The deposited liquid of catch drops 4b landing on the curved surface 39 of catch surface 44 moves toward and into catch chamber 46, for example under the influence of a partial vacuum applied to catch chambers 46, and is ultimately recycled through channels not shown, as is well known in the art of continuous inkjet printing. Catch chambers 46 are formed in part by the enclosure top 34 which additionally protects the drop ejectors, air sources, catch surfaces and electrodes from accidental mechanical contact with the receiver. Air from air sources 15 located below the drop ejector plane 62 travels upward through orifices 32 to guide ejected drops 4a toward the receiver (not shown). FIG. 87 shows an embodiment in which interposer 60 is capable of catching drops. The interposer 60 is closely related to the interposer 60 in the embodiment of FIG. 86 in that the enclosure top 34 is comprised of a structure having a curved bottom surfaces and the enclosure top contains additional structures such as catch surfaces 44 and catch chambers 46 whose function will be described. Catch chamber 46 may be configured (by fluid channels not shown) to allow return of captured liquid drops to the printer ink supply, as is widely practiced for CIJ printing systems.

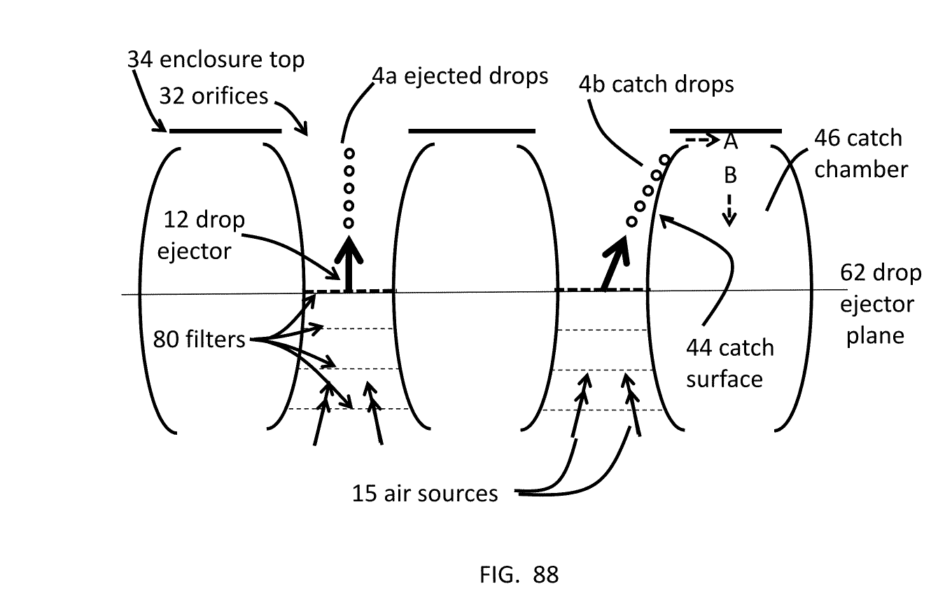

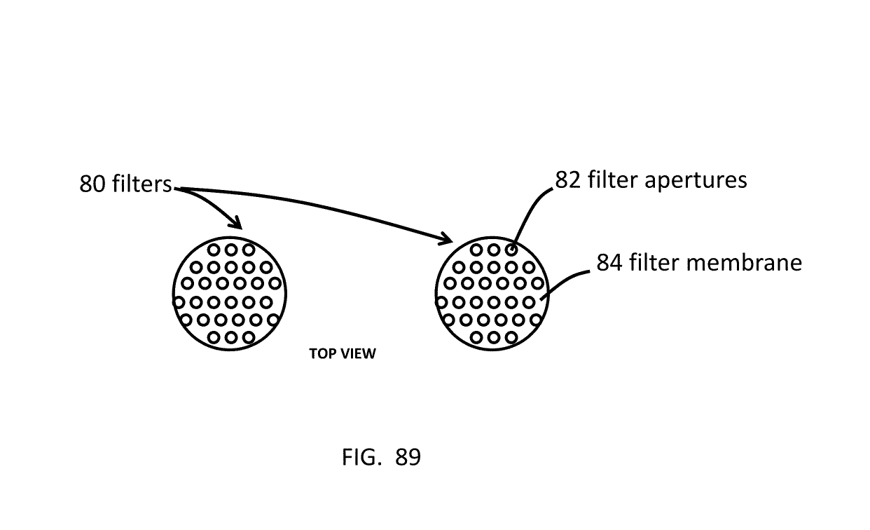

FIGS. 88 and 89 show a variant of FIG. 87 in which the catch surfaces 44 extend downward to and below the plane of drop ejectors 12, which facilitates manufacture. In this case air from air sources 15 located below the drop ejector plane 62 travels upward through orifices 32 to guide ejected drops 4a toward the receiver (not shown). In FIG. 88, the air is filtered by filters 80, shown in detail in FIG. 89, made by providing filter pores 82 in filter membranes 84. The series of such filters shown in FIG. 88 reduces airflow turbulence and can improve the uniformity of the airflow across the entire array of air ejectors as well as filters air from any possible debris. Drops which are deflected, for example by thermally asymmetric heating or other means such as electrodes (not shown), land on catch surfaces 44 and are drawn into catch chambers 46, typically by application of a vacuum to the catch chambers, along the paths marked A, for recycling, as is well known in the art of continuous inkjet printing. When viewed from above, it is contemplated that the catch surfaces 44 on the left and right of a given drop ejector in cross-section FIG. 88 are rotationally symmetric about a vertical line extending from drop ejector 12 (along the path of ejected drops 4a), and thus each rotationally symmetric catch surface forms an independent tunnel about its associated drop ejector through which air and drops may pass upwards through circular orifices 32. The drop ejectors 12 viewed from the top can be located in any of the many geometrical patterns discussed, for example those of FIG. 31, 32, or 33. However, it is also contemplated that a different symmetry in a top-view of FIG. 88 is possible, namely that the catch chambers 46 are of rotational symmetry about a line perpendicular to drop ejector plane 62, for example the arrow under B in FIG. 88. In this case, it is the rotationally symmetric catch chambers that form independent tunnels.

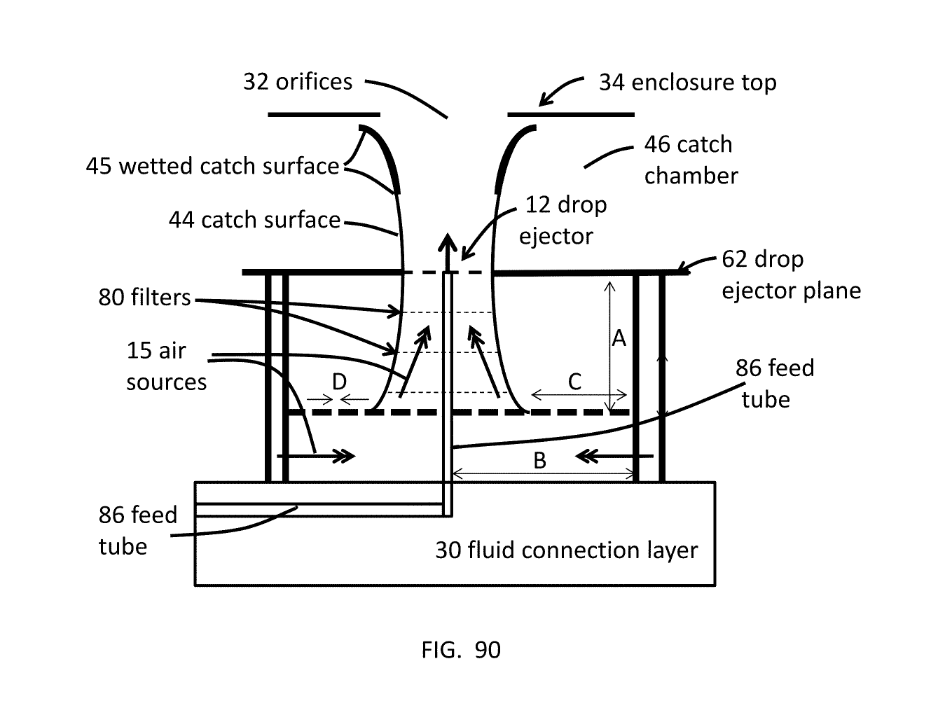

The drop ejectors of FIG. 88 require a connection to fluid connection layer 30. One such possible means of connection is shown in FIG. 90, through provision of a feed tube 86. Filters 80 may be used to provide additional mechanical support for tube 86. FIG. 90 also shows one arrangement for providing air sources 15 to enable airflow through filters 80 out orifices 32. Many other possible geometries for support of the drop ejectors located in filters 80 are within the scope of the present invention. Air sources 15 comprise a source of pressurized air (fine arrows show airflow through filters 80 in FIG. 15), for example provided by a fan or pump (not shown), which causes airflow through a plurality of filters 80, each made of a plurality of pores 82 in solid membranes 84, shown in top-view in FIG. 89. The topmost filter 80 is located very near the base of the liquid drop ejectors 12 (thick arrows), so that the filtered airflow surrounds the drop ejector and thereby flows collinearly with the drop trajectory of the print drops 4a (typically perpendicular to the plane of the drop ejector array). Preferably, the pattern of pores 82 shown in FIG. 89 is symmetrical in both the direction of receiver motion and in the direction perpendicular to receiver motion. It is not required that the pores in the filters are located in a one to one correspondence from filter to filter, as long as the number of pores in each filter is large, for example between 5 and 100. However, it is important that the pores surround each drop ejector 12 symmetrically. Preferably, the symmetry is the same for all filters but that is not a requirement of the present invention. Because of their momentum, catch drops 4b travel along catch surfaces 44. The airflow ejectors surrounding each liquid drop ejector 12 help to propel, by viscous airflow friction, the catch drops 4b along catch surfaces 44 and along path A to B. An important difference between the embodiments of FIG. 87 and FIGS. 88 and 89 is that the enclosure top 34 in FIG. 41 comprises a structure having a curved bottom surface lying below the drop ejector plane but above the air sources, allowing air to be compressed as it flows, reducing turbulence.

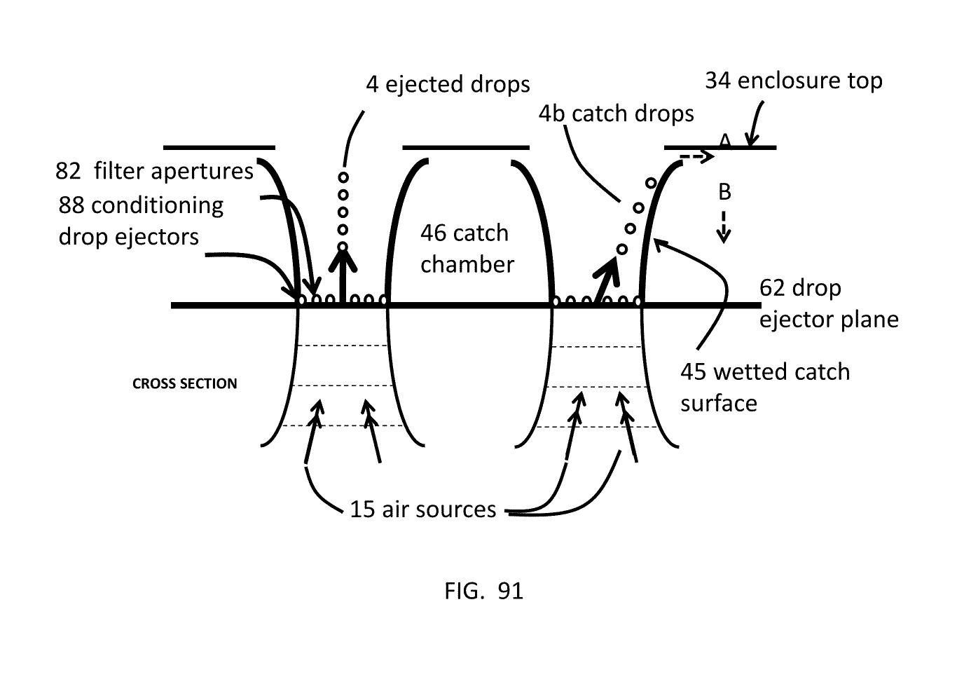

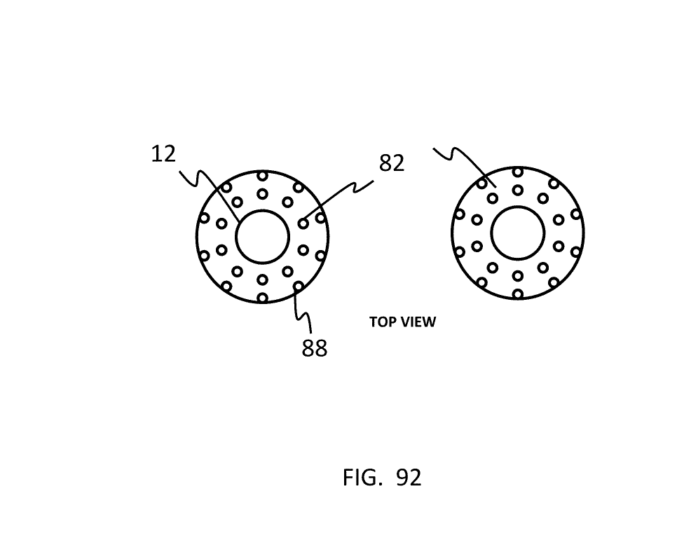

FIG. 43 shows a related embodiment in which in addition to air filter pores 82 conditioning drop ejectors 88 are provided to continuously wet the catch surfaces 44 shown in FIG. 91 as wetted catch surfaces 45. Airflow from air sources 15 not only guides drops after passing through filters 80 but additionally assists the flow of the liquid ejected by the conditioning drop ejectors upward along the wetted catch surfaces 44 in FIG. 91 toward catch chambers 46. The liquid ejected by the conditioning drop ejectors can include the printing liquid also ejected by drop ejectors 12. A top-view of the conditioning drop ejectors and air filter pores is shown in FIG. 92. The wetted catch surfaces 45 provides a surface to which catch drops 4b readily adhere, as is well known in the art of fluid solid interactions, as well as providing a means to clean the catch surfaces. Wetted catch surfaces 45 serve to very efficiently capture catch drops due to the matching fluid-fluid surface energies, as is well known in the art of fluid dynamics such as is disclosed in US Publication Nos. 2012/0026251; US 2012/0026252; and U.S. Pat. No. 8,382,258, the disclosures of which are incorporated by reference herein in their entirety. The wetted catcher surfaces are covered with a moving film of liquid, ejected by conditioning drop ejectors 88, because the airflow through the pores 82 surrounding each liquid drop ejector 12 helps to propel, by viscous friction, any liquid on wetted catch surfaces 45 towards path A. In this embodiment, portions of the catch surfaces 44 are always wetted, even if all ejected drops are printed. Typically, conditioning drop ejectors 88 eject liquids identical to those ejected by drop ejectors 12, so that the catch chamber collects similar liquids; however this is not required by the present invention.

The invention has been described in detail with particular reference to certain preferred embodiments thereof, but it will be understood that variations and modifications can be effected within the scope of the invention.

1. A printhead comprising:
a substrate including an enclosure having an aperture through which liquid drops and gas flow are emitted;
an array of liquid drop ejectors included in the enclosure that eject the liquid drops emitted through the aperture toward a receiver in response to image data; and
an array of gas flow ejectors included in the enclosure that emits the gas flow emitted through the aperture toward the receiver.

2. The printhead of claim 1, wherein the gas flow ejectors are symmetrically positioned about the liquid drop ejectors, and the enclosure is symmetrically positioned about the liquid drop ejectors.

3. The printhead of claim 1, wherein the enclosure is common to the array of liquid drop ejectors.

4. The printhead of claim 1, the enclosure including a plurality of enclosures, each enclosure of the plurality of enclosures including a corresponding liquid drop ejector and two gas flow ejectors.

5. The printhead of claim 1, the aperture including a plurality of apertures, each aperture of the plurality of apertures including a corresponding liquid drop ejector that ejects liquid drops through the corresponding aperture.

6. The printhead of claim 1, wherein the aperture is one of a plurality of apertures, and the gas flow emitted from a given gas flow ejector is emitted through the plurality of apertures.

7. The printhead of claim 1, wherein the aperture is defined by portions of a wall of the enclosure, a portion of the wall of the enclosure further comprising a surface shaped to divert the gas flow toward the aperture.

8. The printhead of claim 7, wherein the surface shaped to divert the gas flow toward the aperture is planar.

9. The printhead of claim 7, wherein the surface shaped to divert the gas flow toward the aperture is contoured.

10. The printhead of claim 7, wherein a portion of the wall of the enclosure further comprises a surface shaped to catch liquid drops.

11. The printhead of claim 10, wherein a portion of the surface shaped to catch liquid drops is at all times covered by a liquid film produced by one or more liquid ejectors.
